(19) United States
(12) Patent Application Publication
(10) Pub. No.: US 2010/0057586 A1
(43) Pub. Date: Mar. 4, 2010

(54) Offer Reporting Apparatus and Method

(75) Inventor: Edmond Kwok-Keung Chow, Hong Kong (HK)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: China Software Venture, Causeway Bay (HK)

(21) Appl. No.: 12/549,321

(22) Filed: Aug. 27, 2009

Related U.S. Application Data
(60) Provisional application No. 61/094,067, filed on Sep. 4, 2008.
(60) Provisional application No. 61/143,408, filed on Jan. 8, 2009.
(60) Provisional application No. 61/143,159, filed on Jan. 8, 2009.
(60) Provisional application No. 61/145,983, filed on Jan. 21, 2009.

(51) Int. Cl. G06Q 30/00; G06F 15/16; G06Q 10/00; G01S 1/00; G06F 17/30; G06F 17/40

(52) U.S. Cl. 705/26; 709/206; 705/30; 342/357.06; 707/3; 707/104.1; 707/E17.018; 707/E17.014; 707/E17.044

(57) ABSTRACT

A computerized method for storing purchase information for a product in a price database to generate a purchase history includes receiving in a price database a set of sales information for a product, wherein the set of sales information includes a product identifier for a product and a price for the product; and storing in the price database a price entry, which include the set of sales information, wherein the price entry is editable to generate a purchase history.

### CROSS-REFERENCES TO RELATED APPLICATIONS

This application claims priority and benefit of the following U.S. Provisional Patent Applications:
U.S. Provisional Patent Application No. 61/094,067, filed Sep. 4, 2008, titled “GPS-Ready Code Image, Market Efficiency Optimization through Hierarchically Constructed and Arithmetically Generated Pages for Matching and Indexing, Mobile Offer Reporter, Online Negotiation, Remote Control for Offer Advertising and Transaction, Context-Priority Publication and Matching Scheme for Online Offers, Peer-to-Peer Per-Offer Advertising for Goods and Services, and Software Entity Naming Scheme”, of Edmond Kwok-Keung Chow;
U.S. Provisional Patent Application No. 61/143,408, filed Jan. 8, 2009, titled “Efficiency in Commerce and Association via Item Identity”, of Edmond Kwok-Keung Chow;
U.S. Provisional Patent Application No. 61/143,159, filed Jan. 8, 2009, titled “Offer Collection System”, of Edmond Kwok-Keung Chow; and
U.S. Provisional Patent Application No. 61/145,983, filed Jan. 21, 2009, titled “Offer Reporting System”, of Edmond Kwok-Keung Chow;
each of which is incorporated by reference herein in its entirety for all purposes.

### COPYRIGHT NOTIFICATION

A portion of the disclosure of this patent document contains material which is subject to copyright protection. The copyright owners have no objection to the facsimile reproduction, by anyone, of the patent document or the patent disclosure, as it appears in the patent and trademark office patent file or records, but otherwise reserve all copyright rights whatsoever.

### BACKGROUND OF THE INVENTION

The present invention generally relates to an apparatus and a method for an offer reporting system. More particularly, the present invention relates to an apparatus and a method for populating the offer database of an offer reporting system with offers for products.

Paul Anthony Samuelson, born in 1915, and an American economist stated “The Penn effect is an important phenomenon of actual history, but not an inevitable fact of life.” The Penn effect that Samuelson was referring to is, in brief, the economic finding that the same product in different countries may have different prices in real money terms (i.e., when exchange rates of different currencies have been taken into account at the time of the comparison). A similar phenomenon may also be observed more locally, such as in a city. For example, in a city two retail stores that are in the vicinity of each other may sell the same item at different price even though the same currency is used. This illustrates the magnitude of market inefficiency despite all the advances in telecommunications and information technologies achieved to date.

In view of this market inefficiency, a need exists for apparatuses and methods that provide market transparency and efficiency to create an informed market, whereby a consumer paying more for a product or service may be a conscious decision, but not necessarily an uninformed decision (i.e., “paying more in the dark”). That is, “paying more in the dark” is an important phenomenon of actual history, but not an inevitable fact of life as provided by embodiments of the present invention.

### BRIEF SUMMARY OF THE INVENTION

The present invention generally relates to an apparatus and a method for an offer reporting system. More particularly, the present invention relates to an apparatus and a method for populating an offer database system of an offer reporting system with offers for products.

One embodiment of the present invention includes a computerized method for storing an offer for a product in an offer database system. The specific embodiment of the computerized method includes receiving in an offer database system offer information for a first offer of a product. The offer information includes a set of invariant offer information and a set of variant offer information. The set of invariant offer information includes a seller identifier and a product identifier, and the set of variant offer information includes a price for the product. The method further includes determining by the offer database system if a second offer for the product is stored in the offer database system. If a second offer is stored in the offer database system, the offer database system determines if another set of invariant offer information and another set of variant offer information in the second offer respectively matches the set of invariant offer information and the set of variant offer information. If the set of invariant offer information and the set of variant offer information respectively matches the other set of invariant offer information and the other set of variant offer information, the offer database system maintains the second offer unchanged. If the set of invariant offer information and the other set of invariant offer information match, and if the set of variant offer information and the other set of variant offer information do not match, the offer database system modifies the second offer to include the set of variant offer information. If the set of invariant offer information and the other set of invariant offer information do not match, the offer database system stores the first offer, wherein the first offer is a new entry in the offer database system and includes the offer information. If a second offer for the product is not stored in the offer database system, the offer database system stores the first offer, where the first offer is a new entry in the offer database system and includes the offer information.

According to a specific embodiment of the method, the set of variant offer information includes a price for the product, and the other set of variant offer information includes a price of the product. The receiving of the offer in the offer database system includes receiving the offer from a device. The device may be portable, such as a seller portable device. The seller portable device may be a cellular telephone or a dedicated offer generator device. The offer database system includes a database server. The product is a physical product or a service product.

According to one embodiment of the present invention, a computer readable storage medium contains program instructions that, when executed by a controller within a computer, cause the controller to execute the method for storing an offer for a product in an offer database system. These method steps for storing an offer for a product in an offer database system are outlined above.

According to one embodiment of the present invention, a computer program product on a computer readable medium is provided for storing an offer for a product in an offer database system. The computer readable medium includes code for executing the method outlined above. These method steps for storing an offer for a product in an offer database system are outlined above.

Another embodiment of the present invention provides a computerized method for storing purchase information for a product in a price database to generate a purchase history. The computerized method includes receiving in a price database a set of sales information for a product, wherein the set of sales information includes a product identifier for a product and a price for the product; and storing in the price database a price entry, which includes the set of sales information, wherein the price entry is editable to generate a purchase history. To generate the purchase history, sales information may be accumulated over time in edits by human users via user portable device, desktop computer, etc., or by the price database accumulating edits to the set of sales information.

According to a specific embodiment of the method, the set of sales information includes seller information. The seller information may include a seller identity. The seller identity may be a business name and/or location information of a seller. The location information may include a set of location coordinates for a seller. The set of location coordinates may be determined from a GPS locator or a digital map in a user portable device. The location information may include a physical address or an online address such as a uniform resource locator (URL). The method may further include, receiving in the price database a second set of sales information for the product, wherein the second set of sales information for the product includes a second price for the product, and a second seller information for the seller or another seller.

The set of sales information may also include a name or description of the product. The set of sales information may also include a date on which the price database received the set of sales information. The product identifier may be an electronic identity code, such as a universal product code (UPC), which may be obtained optically or electronically, such as via RF identification (RFID). The second set of sales information may include similar information as the information described above.

According to one embodiment of the present invention, a computer readable storage medium contains program instructions that, when executed by a controller within a computer, cause the controller to execute the method for storing purchase information for a product in a price database to generate a purchase history. These method steps for storing purchase information for a product in a price database to generate a purchase history are outline above.

According to one embodiment of the present invention, a computer program product on a computer readable medium is provided for storing purchase information for a product in a price database to generate a purchase history. The computer readable medium includes code for executing the method for storing purchase information for a product in a price database to generate a purchase history. These method steps for storing purchase information for a product in a price database to generate a purchase history are outline above.

Another embodiment of the present invention provides a computerized method for storing an offer for a product in an offer database system. The computerized method includes receiving in a user device, such as a user portable device, a product identifier for a product and a price for the product; wherein the user portable device is associated with a unique seller identifier, which identifies a seller of the product; and combining to generate an offer the product identifier, the price, and the seller identifier for storage of the offer in an offer database system.

According to a specific embodiment the computerized method includes storing the offer in an offer database system. If a quantity for the product is not received by the offer database system, in the offer database system a default quantity for the product of one is generated. The step of combining to generate the offer includes combining the quantity, default or otherwise, with the product identifier, the price, and the seller identifier.

According to a specific embodiment the computerized method includes receiving in the offer database system a quantity for the product; and combining to generate the offer includes combining the quantity, with the product identifier, the price, and the seller identifier. The step of combining to generate the offer may be performed at the offer database system. The offer database system includes an offer database system server. The seller identifier may be an online location, such as a URL, or may be some contact information, such as a street address, a seller name, a name of a business and/or a business address. The seller identifier includes data configured for use by a contact database for locating contact information or address information for the seller and for extracting the contact information or the address information. For example, the seller identifier may be an international mobile equipment identity (IMEI) or a pre-registered seller ID with or without a password, or some unique seller ID with one or more address identifiers, each being associated with some specific contact information. For instance, upon receiving offer information for a new product including a seller identifier, the offer database system may decide to create a new offer entry including the offer information. The database system may consult with a contact database to retrieve contact information associated with the seller identifier. The retrieved contact information may then become the actual contact information of an offer entry available for query and retrieval. The original seller identity is instead used for matching seller identities of other offer information received by the offer database system and for retrieving or otherwise identifying contact information about a seller or provider of a product. The product may be a physical product or a service product. The offer database system may be configured to store offer entries for a plurality of sellers and/or a plurality of products.

According to a specific embodiment the computerized method includes determining by the offer database system if a second offer for the product is stored in the offer database system;
if a second offer is stored in the offer database system, determining by the offer database system:
   if a second product identifier for the second offer matches the first mentioned product identifier for the first mentioned offer,
   if a second quantity for a second price for the second offer matches the first mentioned quantity for the first mentioned offer,
   if a second unique seller identifier of the second offer matches the unique seller identifier of the first mentioned offer, and
   if a second price for the second offer matches the first mentioned price for the first offer, then maintaining in the offer database system the second offer unchanged;
if a second offer is stored in the offer database system, determining by the offer database system:
   if the second unique seller identifier matches the first unique seller identifier,
   if the second product identifier for the second offer matches the first mentioned product identifier for the first mentioned offer,
   if the second quantity matches the first mentioned quantity, and
   if the second price does not match the first price,
   then modifying in the offer database system the second offer to include the first price;
if a second offer is stored in the offer database system, determining by the offer database system:
   if the second quantity does not match the first mentioned quantity,
   then storing the first offer in the offer database system; wherein the first offer is a new entry in the offer database system; and
if a second offer is stored in the offer database system, determining by the offer database system:
   if the second unique seller identifier does not match the first unique seller identifier,
   then storing the first offer in the offer database system; wherein the first offer is a new entry in the offer database system; and
if a second offer for the product is not stored in the offer database system,
   storing the first offer in the offer database system; wherein the first offer is a new entry in the offer database system.

According to one embodiment of the present invention, a computer readable storage medium contains program instructions that, when executed by a controller within a computer, cause the controller to execute the method for storing an offer for a product in an offer database system. These method steps for storing an offer for a product in an offer database system are outline above.

According to one embodiment of the present invention, a computer program product on a computer readable medium is provided for storing an offer for a product in an offer database system. The computer readable medium includes code for executing the method for storing an offer for a product in an offer database system. These method steps for storing an offer for a product in an offer database system are outline above.

According to another embodiment of the present invention, a computer system including a processor is provided and is configured to execute one or more of the method steps described above.

These and other embodiments of the present invention are described in more detail in conjunction with the text below and the attached figures.

### BRIEF DESCRIPTION OF THE DRAWINGS

FIG. 1 is a simplified schematic of an offer reporting system according to one embodiment of the present invention;

FIG. 2 is a simplified schematic for an “Offer Identity”;

FIG. 3 is a high-level flow diagram for a computerized method for offer comparison;

FIG. 4 shows a collection of software modules for, and operable on, a user portable device 110 according to one embodiment of the present invention;

FIG. 5 shows a collection of software modules for, and operable on, the offer database system according to one embodiment of the present invention;

FIG. 6 is a high-level flow diagram for an operation method of a user portable device for entering offer information in a submission to the user portable device;

FIG. 7A shows an example “Search Result A”;

FIG. 7B shows an example “Search Result B”;

FIG. 8A shows an example “Offer Page A” offer page that may correspond to the offer entry shown in FIG. 7A;

FIG. 8B shows an example “Offer Page B” that may correspond to the offer entry shown in FIG. 7B;

FIG. 9, labeled “Example System Components” shows an example set of components of a user portable device embodying or otherwise employing various embodiments of the present invention;

FIG. 10A is a high-level flow diagram for a computerized method for entering price entries in a price database and for retrieving price entries from the price database;

FIG. 10B is a high-level flow diagram for a computerized method for entering price entries in a price database and for retrieving price entries from the price database;

FIG. 11 is a simplified schematic of a mobile offer reporting system according to one embodiment of the present invention;

FIG. 12 is a high-level flow diagram for an operation method for a Mobile Offer Reporter according to one embodiment of the present invention; and

FIG. 13 is a high-level flow diagram that illustrates a method for accepting one or more pieces of partial offer information, along with a seller identifier, and generating individual offers, where each offer includes one or more pieces of partial offer information and an actual seller name and address corresponding to a seller identifier.

FIG. 14 shows a computer system for how one embodiment of the present invention may be realized;

FIG. 15 lists the advantages of the present invention over systems and methods of the status quo;

FIG. 16 shows an example query page of the sample embodiment for the present invention;

FIG. 17 introduces the use of GSIN (Goods and Services Identification Number), a scheme introduced for this present invention;

FIG. 18 shows an example result page corresponding to the example query page of FIG. 16;

FIG. 19 shows the same result page as FIG. 18, except the GSIN-specific features as shown in FIG. 17, and the query input is a UPC code instead of typographical keywords;

FIG. 20 shows an example result page for a GSIN code (a manufacturer's model number) for which no offer is available for the query;

FIG. 21 shows an example offer summary display page that would result upon clicking on the “Info” button on an offer excerpt;

FIG. 22A shows Part 1 of an example entry form filled for an offer of a speaker for a MP3 player;

FIG. 22B shows Part 2 of the example entry form filled for the same offer;

FIG. 22C shows Part 3 of the example entry form filled for the same offer;

FIG. 22D shows Part 4 of the example entry form filled for the same offer;

FIG. 22E shows Part 5 of the example entry form filled for the same offer;

FIG. 22F shows Part 6 of the example entry form filled for the same offer;

FIG. 22G shows Part 7 of the example entry form filled for the same offer;

FIG. 22H shows Part 8 of the example entry form filled for the same offer;

FIG. 22I shows Part 9 of the example entry form filled for the same offer;

In FIG. 23, an item bundle comprises a plurality of item packs, each of which comprises a plurality of item specifications, with each specification identifying the same specific item or representative item or its equivalent;

FIG. 24 shows an offer template;

FIG. 25 shows another offer template on which an offer submission or repository may be based;

FIG. 26 illustrates an example offer using a grammar or template;

FIG. 27 illustrates an offer to sell an 86' Corvette by Jane Ray;

FIG. 28 shows a set of example functional components that may be implemented or otherwise arranged to support the steps or operations described herein;

FIG. 29 shows the functionality of an example front-end server in its interaction with an end user;

FIG. 30 is a simplified schematic of an example embodiment comprising an electronic receipt generator and an electronic receipt receiver;

FIG. 31 shows an entry page where a seller can specify all relevant shipping charges for an offer;

FIG. 32 is a flow diagram illustrating how such negotiation may be handled or otherwise executed according to one embodiment of the invention;

FIG. 33 shows an example negotiation embodiment of the present invention;

FIG. 34 is a flow diagram showing how a system or application equipped with the present invention may handle a request to save a file comprising a variant and invariant part to a destination (e.g., a folder on a computer filesystem);

FIG. 35 shows an example QR code and its corresponding message embedded in the code;

FIG. 36 “Illustrative Overall Process Flow” shows how a location-ready barcode such as the QR code shown in FIG. 35 may be generated and consumed;

FIG. 37 shows an example system architecture according to one embodiment of the present invention; and

FIG. 38 shows two function blocks, namely GenerateGroup and CheckConnect, including example code for discovering or generating “taste groups” (i.e., entities with group identities) that a person or user may share or belong to based on his chosen favorite or self-characterizing items, and checking if two persons or users share or belong to a same “taste group”, respectively.

### DETAILED DESCRIPTION OF THE INVENTION

The present invention provides an apparatus and a method for an offer reporting system. More particularly, the present invention provides an apparatus and a method for populating the offer database system of an offer reporting system with offers for products.

Embodiments of the present invention overcome problems associated with “paying in the dark” via an apparatus and a method that provide for an offer template configured to support offers of heterogeneous types of products and services and provide for the evaluation of identity relationships for offers free from the need of centrally generated or managed metadata for the purpose of distinguishing an offer from other offers that may have come before or after the offer. As such, their identity relationships are determined using data contained in, or that is otherwise part of the offers, and not necessarily determined from a piece of homogeneous metadata that is created or managed centrally, such as a common identification number relating all offers for a product from the same seller.

For example, one embodiment of the present invention provides an apparatus and a computerized method for tracking and advertising a price of an item (e.g., a product or a service) charged or otherwise requested by a seller or provider. The method may include:
i) identifying an item (e.g., its name, description, and/or Universal Product Code), for example via a seller portable device;
ii) identifying the provider (e.g., the provider's name, postal address, Uniform Resource Locator, and/or phone number), for example via the seller portable device, or an offer database system (which may include an offer server configured to manage a software-based database, and a machine-readable memory configured to store the software-based database);
iii) specifying a price for a given quantity of the item, where a default quantity may be one item, for example via the seller portable device or the offer database system;
iv) sending or otherwise reporting via a communication network, channel, or link a submission specifying the item, the price for the quantity of the item, and provider information, which identifies a provider or includes information from which a provider or the contact information of a provider may be “looked up” and identified; for example the sending or reporting may be from the seller portable device to the offer database system;
v) receiving or otherwise accepting the submission so sent or reported, for example in the offer database system;
vi) creating, updating, and looking up individual entries in the offer database system (sometimes referred to herein as a repository) in response to said submission so received or accepted;
vii) determining if there is an existing entry in the repository for the item, the price for the item, the quantity for the price, and the provider;
viii) updating the existing entry with the price provided in the submission if the entry exists in the repository, and
ix) creating a new entry in the repository that includes the information in the submission if it is determined that an existing entry for the item is not present in the repository; and
x) providing for publishing and retrieving entries in the repository, after provider information for each of these entries is replaced with contact information of the provider identified by the provider information.
   It will be understood by those of skill in the art the order of execution of the foregoing steps may be rearranged without departing from the spirit and purview of the embodiment. Further, various steps may be combined and/or steps may be added (e.g., to include further technical details) without departing from the spirit and purview of the embodiment. The steps are not limiting on the claims.

An entry in the offer database system, such as that described above, may represent an offer for an item of interest, where the offer identifies, for instance, the item, a price for a given number of the items being offered, a provider intending to sell the item or items, and the price (more generally some form of compensation). According to one embodiment, identifying the item is based on an electronically identifiable code, such as a universal product code (UPC). An entry in the offer database system may be a database object, such as a relational database object.

While any change to an offer may constitute a new offer, for the purpose of tracking an offer and providing a history for the offer, distinction is made between the specifics that are included in the offer, such as the offer's invariant information (e.g., a seller identifier, a product identifier, and a quantity) and the offer's variant information (e.g., information that may change over time). Price of a product offered in general belongs to the latter variant information. For example, a supermarket selling a case of bottled soft drink may increase the price by ten percent. The new price for the case of bottled soft drink represents a new offer that renders the previous offer obsolete. The obsolete offer may be regarded as a historical offer making up an offer history. This association of offers via offer history results from the practical effect of one offer replacing another offer while both offers refer to the same item (or item bundle) from the same provider. For example, an offer database system that is configured to store current prices for a list of items offered by a particular supermarket may simply update the one offer that has been changed while leaving other offers unchanged. Old prices may then be made available as a reference history against current prices. Thereby, the number of available prices remains the same in relation to the list of items whose prices are being tracked. Each such available price is included in the variant information portion of an offer, whereas the invariant information includes the item being offered, the quantity of the item, and the supermarket that offers the item for sale. The prices set forth in predecessor offers become the history of the offer in terms of pricing.

According to one embodiment, an electronic offer may be created and submitted by a consumer, a seller, or the like via a user portable device (describe below in detail). Offers or those entities submitting offers might be subject to verification as in authorized offers and authorized entities via various technologies that provide password-protected credentials, digital signatures, and the like to that only authorized entities may submit or publish offers. For example, an official offer should come from the provider of the offer for consideration, and hence an electronic offer allegedly submitted by the provider should be authenticated as such.

Similarly, an actual cost to purchase items available online may vary due to differences in shipping and handling charges, and applicable taxes. An advertised price may simply be a nominal amount where a consumer may pursue further information to find out the exact cost of purchase. For example, a potential purchaser might contact the item provider or discover the exact cost by initiating an inquiry or a tentative transaction (e.g., through a URL). Offers with full price disclosure are generally more desirable than those that require further discovery beyond what is available and retrievable in an offer. As such, an offer may contain more information than the item for sale and the price, such as whether there is an extra cost for handling and shipping if the offer is a mail order offer.

A typical offer might include information that identifies the item, the provider of the item, the quantity of the item (e.g., default of one), and the price. While other conditions and criteria for an offer may be included in the offer (e.g., whether implicitly stated or otherwise implied (e.g., by laws of the applicable jurisdiction)), these four individual pieces of information typically constitute an offer for the purpose of sale, purchase, and comparison in day-to-day shopping and trading. According to one embodiment, a different item identity, provider identity or item quantity indicates a different offer. That is, an item identity, provider identity and item quantity together constitute an offer identity.

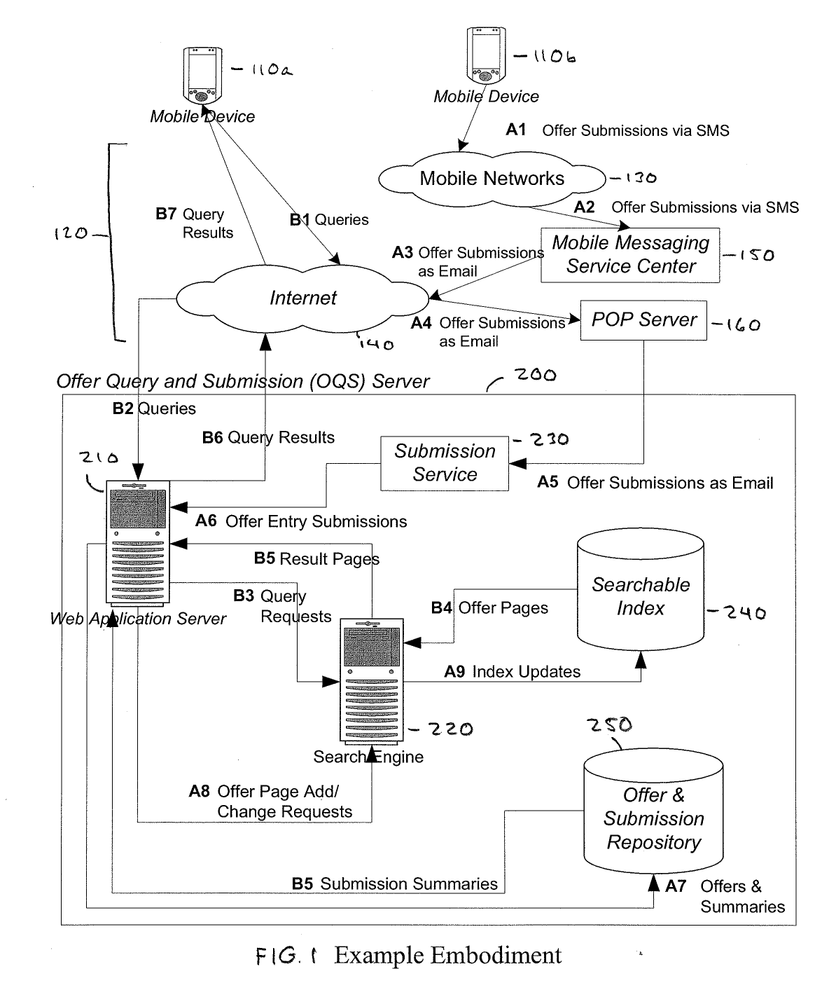

FIG. 1 is a simplified schematic of an offer reporting system according to one embodiment of the present invention. The offer reporting system includes a set of user portable devices 110. A set as referred to herein includes one or more elements. The set of user portable devices might include dedicated function portable devices, mobile telephones, personal digital assistants (PDAs), computers (e.g., laptop computers), and the like. Offer reporting system 100 further includes a communication network 120, which may include one or more of a mobile telephony and data network 130, a wireless local area network (LAN), a wireless wide area network (WAN), the Internet 140, a dedicated network, or the like. Communication network 120 may include one or more servers to facilitate communications. For example, the communication network may include a mobile messaging service center 150, which may include one or more server computers and memories for the server computers. The communication network may also include a set of POP servers 160.

Offer reporting system 100 may also include an offer database system 200, which is sometimes referred to herein as an offer query and submission (OQS) server. Offer database system 200 may includes a web application server 210, a search engine server 220, a submission service 230, a searchable index database 240, and an offer and submission database or repository 250. A server as referred to herein includes a server computer running a server operating system. Each server includes a machine-readable memory (not shown) which is configured to store computer programs, which are configured to operate on the servers and embody the various embodiments of the present invention. The computer programs may be stored on the machine-readable medium as compiled or un-compiled computer code. Un-complied computer code may be compiled locally on the server computers for use thereon or on other computers.

According to one embodiment, each user portable device 110 is configured to communicate with offer database system 200 via network 120. A user portable device may be configured to collect offer information from a user of the user portable device. The offer information may be for an offer. The offer information may be combined with seller information to generate an offer. The offer information and the seller information may be combined locally within a user portable device to generate an offer, or the offer information and the seller information may be transmitted from the user portable device to the offer database system where the offer information and the seller information are combined to generate an offer.

The offer information may include an item identifier for a product or service being offered, and a price for the item. The price may be for one item, which is a default assumption of the user portable device or the offer database system. Alternatively, the offer information may expressly include a quantity, which the user portable device may be configured to receive as input from a user.

According to one specific embodiment of the present invention, offer information and/or offers are packaged into a plurality of SMS (Simple Message System) messages and sent (see A1) to a pre-determined or otherwise assigned phone number (i.e., the mobile messaging service center, which is configured to receive and route the message per phone number). That is, the SMS messages (see A2) may be delivered to mobile messaging service center 150. Mobile messaging service center 150 may be configured to retrieve the packaged offer information from the SMS messages and send an e-mail (i.e., via SMTP—Simple Mail Transport Protocol) to an e-mail address as part of pre-arranged configuration (see A3) with the offer information to POP server 160. POP server 160 may be configured to receive the e-mail on behalf of the e-mail recipient as addressed by the e-mail address (see A4).

Submission service 230 may be a software module configured to operate on a server, such as web application server 210 or other server computer. According to one embodiment, submission service 230 may be configured to retrieve the e-mail from POP server 160 (see A5), and identify the offer information and extract the offer information from the packaged information. Submission service 230 may be configured to submit the offer information to web application server 210 (see A6). Web application server 210 may be configured to thereafter analyze the offer information and determine whether the offer information should result in a new offer being entered in offer and submission database 250 and/or whether updates should be made to other offers stored in the offer and submission database. The resultant summary, the new offer, and/or the additions and changes to the other offers may be sent to the offer and submission database (see A7) for storage therein. The resultant summary, the new offers, and/or the additions to the other offers may be accessible or otherwise retrievable by users through requests to a search engine that maintains the searchable index 240, which may contain the new offers and/or updated offers as individual entries (see A8 and A9).

FIG. 1 further illustrates how user-generated queries (see B1) for offers are submitted by user portable devices or personal computers to the offer database system, and how the offer database processes the user-generated queries according to one embodiment of the present invention. A user-generated query at a personal computer may be transmitted from the personal computer via the Internet (for example) to web application server 210, which is configured to process the user-generated query (see B1 and B2). Web application server 210 may be configured to generate a query request based on the user-generated query and send the query request to search engine 220 (see B3). Search engine 220 may be configured to make available a set of offer pages (with each page representing or otherwise referencing an offer) via a plurality of result pages. Each result page includes a list of summaries for a subset of the offer pages, matched and ranked in accordance to the query request (see B4 and B5). Each summary in the list of summaries may be linked (e.g., hyperlinked) to the actual offer page. Web application server 210 may thereafter reply to the user-generated query by transmitting a set of query results to the personal computer that generated the user-generated query. The set of query results may be based on the result pages, also matched and ranked accordingly (see B6 and B7).

One or more submission services, search engines, web application servers, searchable indices, and offer and submission repositories, or their functional equivalents, may constitute offer database system 200. As discussed briefly above, the offer database system is configured to accept electronic offer submissions, track offer life cycles, and respond to queries for offers. According to some embodiments, mobile messaging service center 150 and POP server 160 may form a portion of the offer database system.

According to one embodiment, an offer's lifecycle includes creation, animation, suspension, and extinction. The creation of an offer may occur if a new set of items (products and/or services), herein sometimes referred to as an item bundle, or a new item provider is first reported, discovered, or otherwise made. An item bundle may be a set of homogeneous items or heterogeneous items. Different business locations for same commercial enterprise may offer the same item bundles at different prices and the different business locations may be considered as different individual providers, whereas the different business locations that are expected to sell the same item bundles for the same price may be considered as a single provider. Features that are used herein to define different business locations as an individual provider may be application specific, embodiment specific or case specific.

After an offer is created, the offer is said to enter an “animation stage”. During the animation stage new prices and/or pricing schemes may be updated. The relevancy of these prices and pricing schemes may further be distinguished between snapshot prices and live prices. An offer with a snapshot price per a given pricing scheme (i.e., a snapshot offer) as referred to herein means that the snapshot price per the pricing scheme (so advertised or otherwise reported) does not guarantee or otherwise become indicative of the current price. An offer with a live price per a given pricing scheme (i.e., a live offer), in contrast, does guarantee or otherwise become indicative of the current price.

An example of a snapshot price includes offer intelligence submitted by a consumer for the purchase of an item the she has just made. An example of a live price includes an offer whose submissions are in the control of the provider or the provider's proxy that intends the submissions as actual changes to the current prices of the item bundles that they provide. If there is no more update to a snapshot offer for a pre-defined period of time, or the provider is no longer offering the item bundle, the offer goes into suspension (i.e., the suspension stage). Should new updates arrive, or the provider resumes carrying the item bundle, the offer returns to the animation stage. If the provider is neither operative, nor in existence any longer, then the offers of the provider become extinct (i.e., the extinction state). Extinct offers may still be available from the offer database system for reference purposes, such as for the historical review of prices for an item bundle.

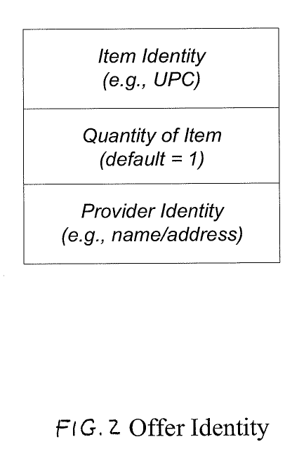

FIG. 2 is a simplified schematic for an “Offer Identity.” As referred to herein, an offer identity includes an item identity, a quantity for the item, and a provider identity for the item. A change in price for the item does not change the identity of an offer employing such an offer identity. A price change alone may obsolete the offer with the old price, and result in an offer with the new price, while both shall share the same offer identity. Offer identity provides for the creation and tracking of the life cycle of an offer (described below in detail).

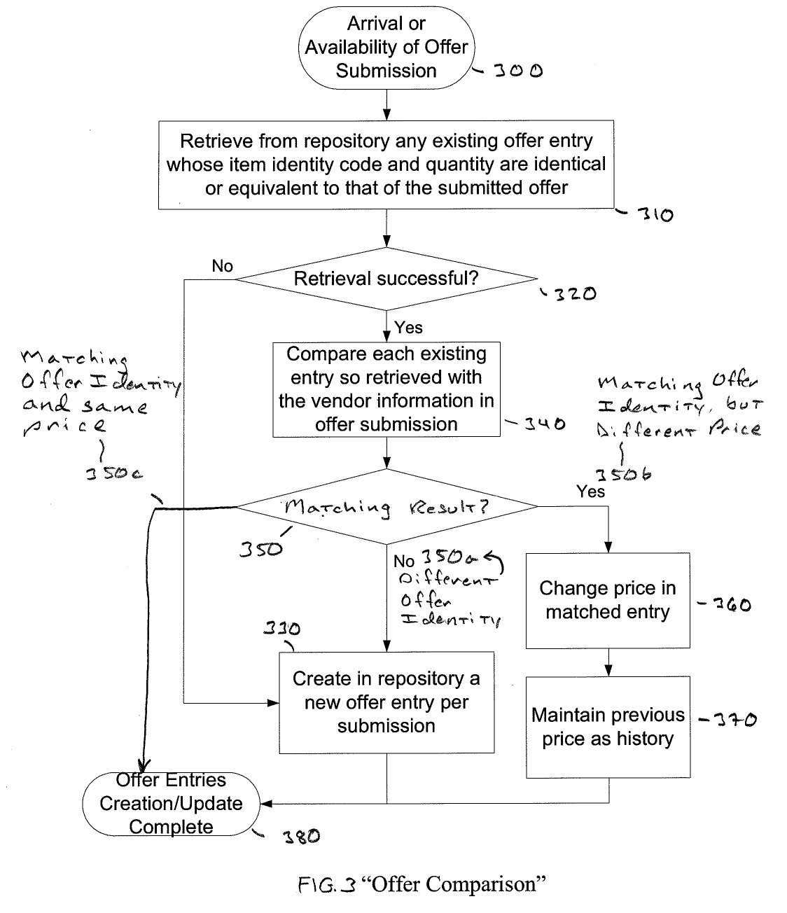

FIG. 3 is a high-level flow diagram for a computerized method for offer comparison. Those of skill in the art will understand that various steps in the method may be added or combined without deviating from the spirit and purview of the embodiment. The high-level flow diagram is not limiting on the claims. The computerized method provides for the comparison between a first offer that is submitted to an offer database system (described below) with a second offer that might be stored in the offer database system, and provides for the determination of i) whether the first offer will be stored in the offer database system or ii) whether the second offer will be modified in the offer database system.

According to one embodiment, an offer arrives (received offer) or is otherwise made available at the offer database system, step 300. While one specific embodiment of the offer database system is described above and shown in FIG. 1, according to alternative embodiments the offer database system may include a portable device (e.g., a user portable device) or a user computer that is configured to perform offer comparison (identity) analysis as described herein. That is, such a portable device or user computer is said to embody the invention, and should be regarded as one embodiment of an offer database system. According to one specific embodiment, the received offer may be received from a user computer at the offer database system. The received offer may include a set of offer information. The offer information may include an item identifier for an item. The item identifier may be an identity code, such as a UPC. The offer information may also include a quantity of the item or set of items that is offered in the offer. The default quantity may be one. The offer information may also include a seller identifier that identifies the seller or may be used for retrieving information to identify the seller. The offer information may also include a price for the item or a price for a set of items.

The offer database system may be configured to search the offer and submission database for offers stored therein that match the received offer (step 310). According to one embodiment, the search may be based on i) the item identifier and ii) the quantity of the item, their being two pieces of invariant offer information. The elements that the search is based on may be referred to as search parameters. For instance, offers of matching item identity or item identifier and item quantity but of different seller identity or identifier may be regarded as competing offers. If an offer in offer and submission database 250 includes the search parameters issued in the search, then that stored offer is retrieved form the offer and submission database (step 320). The search may be administrated by search engine 220.

If the search of the offer and submission database does not return any offers that match the search parameters of the search, e.g., with search parameters being the item identity or item identifier and the item quantity (step 320), then a new offer may be created in the offer and submission database (step 330). The new offer includes the offer information in the received offer received by the offer database system in step 300. The new offer and the received offer may be thought of as a single offer, where the received offer is that offer, which is stored in the offer and submission database.

If at step 320, the search returns a stored offer, various pieces of invariant offer information in the stored offer, such as the seller identifier, are further compared with corresponding pieces of invariant offer information in the received offer (step 340).

In one specific embodiment, if not all the invariant offer information in the stored offer matches the invariant offer information in the received offer (for instance, (i) if the seller identifier in the stored offer does not match the seller identifier in the received offer, (ii) if the product identifier in the stored offer does not match the product identifier in the received offer, or (iii) the quantity in the stored offer does not match the quantity in the received offer) then a new offer may be created in the offer and submission database (steps 350, 350a, and 330). If the invariant offer information of the stored offer and the received offer do not match, these offers may be referred to as having “different offer identity.” The new offer includes the offer information in the received offer, which was received by the offer database system in step 300.

If the seller identifier, the item identifier, and the item quantity (implicit or otherwise) in the offer information for the stored offer respectively match the seller identifier, the item identifier, and the item quantity in the offer information for the received offer, but the prices for these offers do not match (step 350 and 350b), then a price for the stored offer may be updated to include the price in the received offer (step 360). If the seller identifier, the item identifier, and the item quantity (implicit or otherwise) in the offer information for the stored offer respectively match the seller identifier, the item identifier, and the item quantity in the offer information for the received offer, but the prices for these offers do not match, these offers may be referred to as having “matching offer identity”, but having different prices. The price that was in the stored offer at the time the stored offer was retrieved and the time at which the price was first reported or became effective may be maintained as a price history in relation to the stored offer (step 370).

If all of the offer information in the stored offer matches all of the offer information in the received offer (steps 350 and 350c), then the stored offer is maintained in the offer and submission database unchanged (step 380). If all of the invariant offer information in the stored offer matches all of the invariant offer information in the received offer (steps 350 and 350c) and the prices of these offers match, then these offers are said to have “matching offer identity” and the same price.

One variation of the method shown in FIG. 3 includes, for example, that retrieval may take into consideration the vendor information when the offer database system first examines offer entries with matching item identity code and quantity. Furthermore, the offer comparison method shown in FIG. 3 may be performed after a received offer has been deposited into the offer and submission database repository. For example, two offers in different languages may often be regarded as two unrelated offers unless there is already a translation mechanism in place that is capable of relating one to the other upon the arrival of the later submission. Alternatively, both offers may contain linguistically neutral identification data such as a local fax number that (may with an acceptable degree of certainty) indicate a relationship between the offers. Then later, on availability of a bilingual business directory for the location in question (or simply just using a user or staff's input), the offers in the offer and submission database may be re-visited, their relationship may be discovered and established, and entries updated or modified as required (as discussed above with respect to FIG. 3).

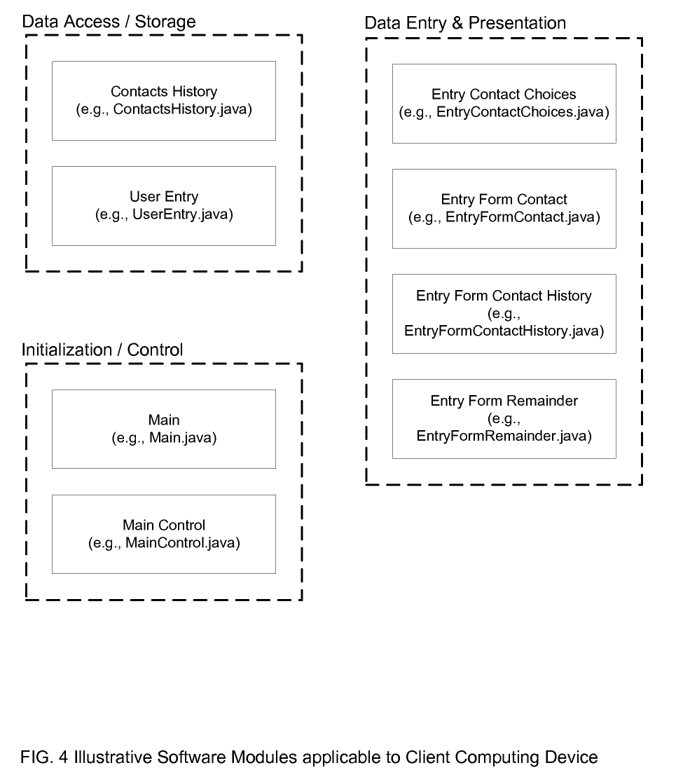

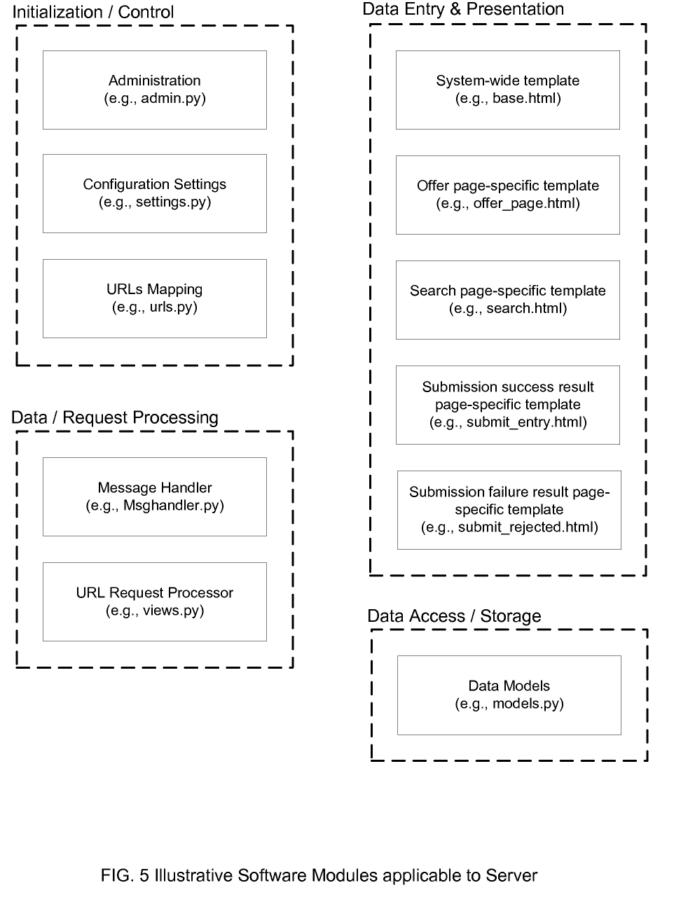

FIG. 4 and FIG. 5 respectively show example software modules for, and operable on, a user portable device 110 (also referred to sometimes herein as a mobile device) and offer database system 200 (also referred to sometimes herein as an OQS server). Example source code for these software modules are provided in an appendix attached hereto. The software modules may be grouped into different categories of responsibilities. Software modules in the data access and storage category are responsible for providing data access and storage functionality to other software modules. Software modules in the initialization and control category are responsible for the initiation, setup, and control of the application, service, or system in question. Software modules in the data entry and presentation category are responsible for accepting input and presenting output for the application, service or system. Software modules in the data and request processing category are responsible for handling and transforming data and requests, especially those received and presented through modules in the data entry and presentation category. Note that the functionality of a particular software module category may be distributed among modules of other categories. For example, an application, service, or system that collects data and package them for transmission may have software modules in data access and storage as well as data entry and presentation categories to collectively provide for data handling functionality. In addition, software module categorization schemes other than the one discussed above may be used. Such schemes aid in software design and comprehension. The actual functionality of an individual software module may differ from the declared functionality of a category that a categorization scheme may have assigned the software module to.

### Software Modules and Components of the User Portable Device

References below to various user activities include activities that a user may perform on the user portable device, for example in response to information presented to the user on the user portable device. The information presented to the user on the user portable device might be on a display of the user portable device or might be via a speaker on the user portable device. References to user entering various information have a corresponding action of receipt by the user portable device of the entry regardless of whether such activity is expressly stated below. Furthermore, a complete application, service, or system for, or on the user device, would normally require operating systems, frameworks, modules, and components in addition to those referenced below. One of skill in the art would be able to identify these frameworks, modules, and components to make and use a user device embodying the present invention.

1. Contacts History module: of category “data access and storage”, provides services and storage for creating, maintaining and retrieving contact information of item providers. An example implementation in the appendix called ContactsHistory.java is a definition of an object oriented class (in JME—Java Micro Edition). The class uses third-party and platform-provided modules and extensions such as those of JSON (JavaScript Object Notation) and RMS (Record Management Store).

2. Entry Contact Choices module: Of category “data entry and presentation”, it provides the structure and functionality of an on-screen form that may capture and confirm item information from user as well as solicit his choice of entry for specifying item provider. The possible choices are: as that of the offer last submitted, from the history of past saved providers, or as a new provider. The module also lets the user perform some other operations such as contact history removal using her user portable device. An example implementation in the appendix called EntryContactChoices.java is a definition of an object oriented class that uses platform-provided modules and extensions such as the Form and CommandListener classes.

3. Entry Form Contact module: Of category “data entry and presentation”, it provides the structure and functionality of an on-screen form that may capture and confirm an item provider's contact information from a user through a user portable device. The module also lets the user perform some other operations such as saving the contact information as contact history. An example implementation in the appendix called EntryFormContact.java is a definition of an object oriented class that uses platform provided modules and extensions such as the Form and CommandListener classes.

4. Entry Form Contact History module: Of category “data entry and presentation”, it provides the structure and functionality of an on-screen form that may present a list of contact information excerpts from contact history and let a user to choose from it a provider whose contact information may be reused for the in-progress offer submission preparation. An example implementation in the appendix called EntryFormContactHistory.java is a definition of an object-oriented class that uses platform-provided modules and extensions such as the Form and CommandListener classes.

5. Entry Form Remainder module: Of category “data entry and presentation”, it provides the structure and functionality of an on-screen form that may capture and confirm the quantity of the item and the price per such quantity for the offer, as well as the effective and expiry dates of the offer. The module also lets a user enter other information such as his remark about the offer or submission. An example implementation in the appendix called EntryFormRemainder.java is a definition of an object oriented class that uses platform-provided modules and extensions such as the Date, Form and CommandListener classes.

6. Main module: Of category “initialization and control”, it provides the entry point of an offer submission client application running on a compatible user portable device. The user portable device may use this entry point to activate and deactivate the client application. According to one embodiment, this client application transforms or otherwise enables the mobile phone to perform electronic offer submissions. An example implementation in the appendix called Main.java is a definition of an object-oriented class. For example, if a user chooses to start the client application, the user portable device may invoke the startApp method shown in the class or instance of the class. Likewise, the destroyApp method may be called if the user exits the application. The class uses platform-provided modules and extensions such as the MIDlet and CommandListener classes.

7. Main Control module: Of category “initialization and control”, it provides the underlying control of the offer submission process within the client application. For example, the module directs the workflow of the application from screen to screen based on user input and the stage of the offer submission preparation. An example implementation in the appendix called MainControl.java is a definition of an object-oriented class that uses third-party and platform-provided modules and extensions such as the MessageConnection class for sending SMS messages and the BarcodeMain class for capturing numerical UPC code from a barcode label. An example BarcodeMain class for use is one from the free barcode recognition software kit made available by Robert Adelmann who is a professor at Swiss Federal Institute of Technology Zurich. The free barcode recognition software kit may be retrieved from the following website: http://people.inf.ethz.ch/adelmanr/batoo/index.php/Download/Clients. Those of skill in the art will know how to access software kit, which is incorporated by reference herein for all purposes.

8. User Entry module: Of category “data access and storage”, it provides services and storage for maintaining and retrieving user input during the offer submission preparation. The module also provides other related services such as keeping the contact information of the item provider in the last submission and packaging the submission entry into a single sequence of characters suitable as payload via SMS. An example implementation in the appendix called UserEntry.java is a definition of an object-oriented class that uses third-party and platform-provided modules and extensions such as those of JSON and Calendar.

### Software Modules and Components of the Offer Database System

Note that a complete offer database system would normally require operating systems, frameworks, modules, and components in addition to those software modules referenced below. One of skill in the art would be able to identify these frameworks, modules and components to realize an offer database system embodying the present invention.

1. Message Handler module: Of category “data and request processing”, it provides a function similar to or the same as that of a submission service shown in FIG. 1. An example implementation in the appendix called Msghandler.py is a software program that runs substantially continually (with configurable frequency and automatic termination) on a compatible computing platform to retrieve e-mail messages from a designated POP server and attempt to extract offer submissions from the e-mail messages along with other metadata. If successful, the program may submit each submission to a designated Web application server for further processing. The program is written in the Python programming language, as indicated by the “.py” file extension.

2. Administration module: Of category “initialization and control”, it sets up the administrative interface at a compatible Web application server for managing a database of product names, product codes, vendor names, vendor addresses, offers, and so on (similar to those that may be maintained in an offer and submission repository as shown in FIG. 1). An example implementation in the appendix called admin.py is a script that performs such setup or configuration at a compatible Web application server.

3. Data Models module: Of category “data access and storage”, it specifies the structure and parameters of a database which is an example of an offer and submission repository as shown in FIG. 1. An example implementation in the appendix called models.py is a script of definition that results in such specification at a compatible database.

4. Configuration Settings module: Of category “initialization and control”, it sets up a compatible Web application server for the script's connection to a database as well as other specificity such as the script's default language and time zone. This Web application server and database are respectively an example of a Web application server and an offer submission repository as shown in FIG. 1. An example implementation in the appendix called settings.py is a script that performs such setup or configuration at a compatible Web application server.

5. URLs Mapping module: Of category “initialization and control”, it maps various URLs (Uniform Resource Locators) to specific software modules for processing if a compatible Web application server receives these URLs as requests. Offer queries and submissions at the Web application server are made through these URLs. An example implementation in the appendix called urls.py is a script that performs such setup or configuration at a compatible Web application server.

6. URL Request Processor module: Of category “data access and storage”, it processes URL-based requests, such as requests to search for, retrieve and submit an offer. An example implementation in the appendix called views.py is a script comprising individual software routines that perform such processing. Some of these routines use other modules or routines that provide internal functions such as converting time of local time zone to that of UTC (Universal Time Coordinated). A compatible Web application server equipped with this script and other related entities such as the example implementation “urls.py” discussed above may be able to function as a Web application server of an OQS server as shown in FIG. 1. For example, the software modules responsible for offer submission and search may be configured to use a search engine system or appliance capable of performing the combined function of the search engine and searchable index of an OQS server as shown in FIG. 1.

7. System-Wide Template module: Of category “data entry and presentation”, it specifies the page layout and content common to all individual HTML (Hyper-Text Markup Language) page presentations by a compatible Web application server. An example implementation in the appendix called base.html is a template that performs such specification at a compatible Web application server.

8. Offer Page-Specific Template module: Of category “data entry and presentation”, it specifies the layout and content of an HTML page containing an offer presentation, using the a system-wide template module (e.g., base.html) for common layout and content. An example implementation in the appendix called offer_page.html is a template that performs such specification at a compatible Web application server.

9. Search Page-Specific Template module: Of category “data entry and presentation”, it specifies the page layout and content of an HTML page containing a query interface for offers and, if applicable, a resultant list of offer summaries. An example implementation in the appendix called search.html is a template that performs such specification at a compatible Web application server.

10. Submission Success Result Page-Specific Template module: Of category “data entry and presentation”, it specifies the layout and content of an HTML page indicating a successful submission of an offer. An example implementation in the appendix called submit_entry.html is a template that performs such specification at a compatible Web application server.

11. Submission Failure Result Page-Specific Template module: Of category “data entry and presentation”, it specifies the layout and content of an HTML page indicating a failure in an offer submission. An example implementation in the appendix called submit_rejected.html is a template that performs such specification at a compatible Web application server.

The user portable device and OQS server software modules described above are extracted or otherwise based on a functional system that provides an end-to-end support for offer submission and query, and whose architecture of deployment and operation is identical or otherwise similar to that shown in FIG. 1. One skilled in the art may be able to recreate the system or build a similar one based on the source code so disclosed. He may also be able to implement other embodiments of the present invention in accordance to the description presented herein. For example, the example implementation of the database models also supports the capture and maintenance of other salient information about an offer, such as past prices.

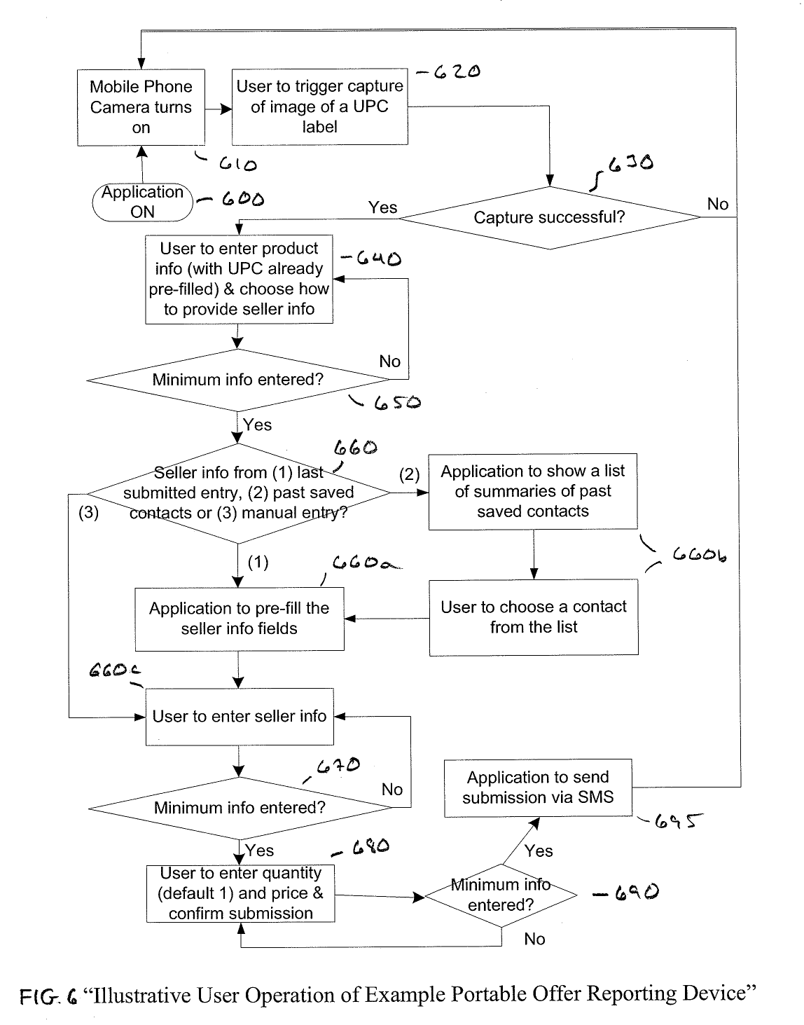

FIG. 6 is a high-level flow diagram for an operation method of a user portable device 110a or 110b according to one embodiment of the present invention. Those of skill in the art will understand that various steps in the method may be added or combined without deviating from the spirit and purview of the embodiment. The high-level flow diagram is not limiting on the claims. More specifically, FIG. 6 provides a high-level overview of a method for how a user portable device may interact with a user and prepare an offer submission for the offer database system. In the particular example of FIG. 6, the user portable device may be a mobile phone, which includes a camera. The mobile phone may be configured to perform each of the functions and methods described herein for the user portable device, and configured to store and execute enabling software modules such as those shown in FIG. 4.

At an initial step 600, the mobile phone (e.g., via a user action) starts the software application equipped with the present invention, such as one that is equipped with the software modules outlined above in FIG. 4. The software application running on a processor of the mobile phone turns on the camera (step 610) and prompts the user (e.g., via a display on the mobile phone) to enter a product identity code (e.g., via a keypad) or capture a digital image of a UPC label (or other label) for a product (e.g., via the on-device camera).

The mobile phone is configured to accept a user input (e.g., a button push) to capture an image of the UPC label via the camera (step 620). If the image capture fails (step 630), the mobile phone may be configure to prompt the user (e.g., via the display) to try again to capture an image of the UPC label. Alternatively, no user trigger may be needed if, for example, the camera is on a continuous scanning mode, in which it attempts to identify and capture a UPC label without user intervention. If the image capture is successful (step 630), the mobile phone may be configured to display a form via which the user may interact with the mobile phone to enter product information for the product (step 640). According to one embodiment, a UPC data field in the form may already be pre-filled with the numerical code that was captured in step 620. According to one embodiment, an RF id tag may be captured or otherwise used in addition to or in lieu of a UPC label. If the user selects to proceed to a next screen, the software application may check if “minimum information” has been entered into the form. Minimal information according to one embodiment of the present invention includes a product identifier, which may be the UPC code, and a price for the product. The software application may be configured to assume that a quantity for the product is one. According to one embodiment, the UPC code alone may suffice as the minimum information if, for example, a price is associated with the UPC code. According to one embodiment, the software application is configured not to allow the process to advance until the minimum information has been provided to the mobile phone.

Also at step 640, the software module is configured to present one or more user selectable options for how a user would like to specify a seller's contact information. The software module is also configured to receive the user's selection for the method of specifying the seller contact information. If sufficient information has not been received in step 640, the mobile phone may be configured to not allow a user to direct the mobile phone to proceed to a subsequent screen (step 650).

If sufficient information has been received in step 640, step 660 is executed in which seller contact information is selectable by a user or otherwise received by the mobile phone from a user entry. At a step 660A, the software application pre-fills a form displayed on the display with the seller contact information from a last submitted entry. At a step 660B, the mobile phone may be configured display of list of saved seller contact information and permit the user to select the seller contact information from the list. Alternatively, the mobile phone may be configured to present a “blank” form via which the user may interact with the mobile phone to enter new seller contact information (step 660C). The first two options 660A and 660B may result in a contact form “pre-filled” with the appropriate and available data, with the second option further introducing an intermediate step of choosing a contact from a list of summaries of past saved contacts. The user is expected by the software module to provide sufficient information to identify the seller. For example, an embodiment may allow the name of a “mall” (a shopping location having a plurality of businesses, such as retail shops) in lieu of the actual street number and name. At a step 670, the mobile phone is again configured to determine whether sufficient information has been selected or otherwise entered and allow or disallow additional information entry if sufficient information has or has not been entered.

At a step 680, the mobile phone is configured to receive input from the user specifying the quantity of the product. According to one embodiment, the data field in the form is pre-filled with the default value of one. Also at step 680, the price per such quantity is received by the mobile phone via user entry. At a step 690, the mobile phone is again configured to determine whether sufficient information has been selected or otherwise entered and allow or disallow additional information entry if sufficient information has or has not been entered.

Thereafter, at a step 695, the mobile telephone may be configured to accept a user entry to initiate and confirm the submission to the offer database system. The submission may be sent out from the mobile telephone via SMS messages, or via any other electronic communication device available to the mobile phone and the software application. The steps shown in FIG. 6 may be repeated for additional submissions for additional products, prices, quantities, seller location, or the like.

It is noted that the software application may be configured to permit a user to direct the software application to exit the software application or move back and forth between on-screen forms whenever user input is requested. In addition, the software application may be configured to permit the user to direct the mobile phone to save a seller's contact information as history at various times in method outlined by FIG. 6. Further, the software application may be location-specific in that each installation may already specify a delivery location, e.g., Hong Kong, and applicable currency, e.g., the Hong Kong dollar. These steps are not shown in FIG. 6 so to simplify the high-level flow diagram.

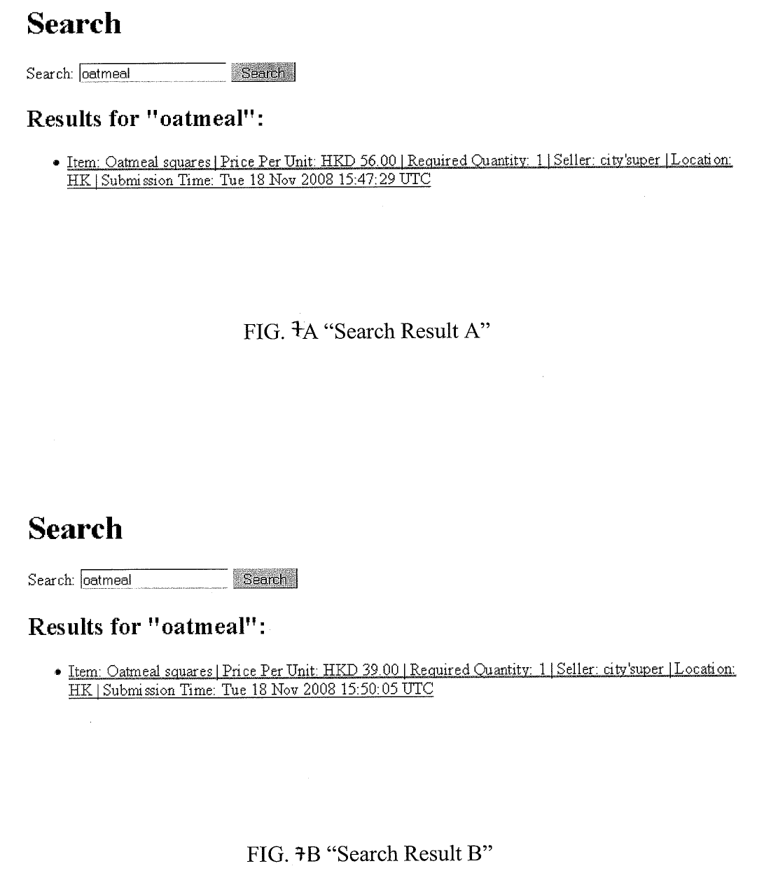

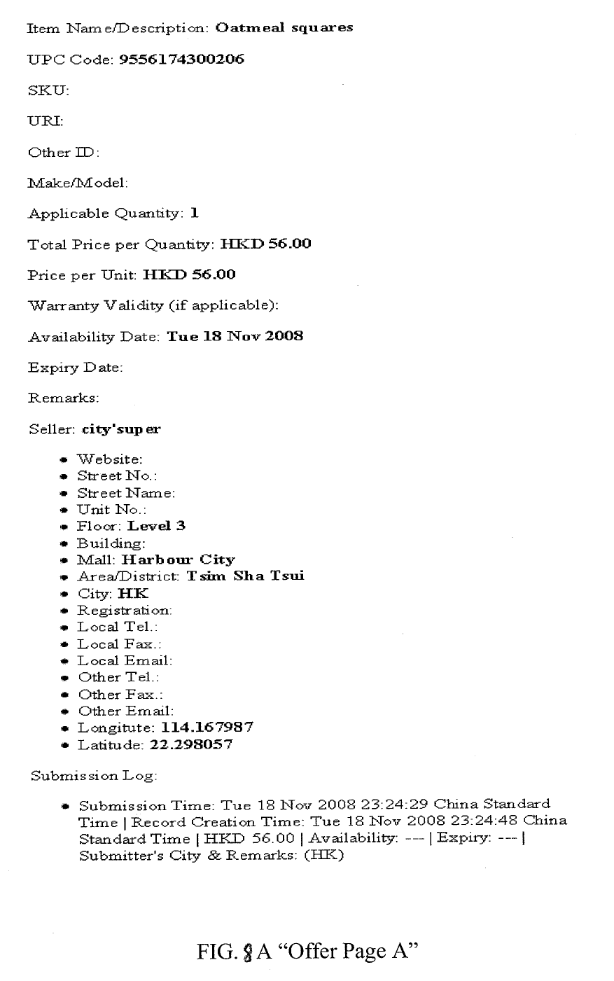

FIG. 7A shows an example “Search Result A” and FIG. 7B shows an example “Search Result B”. Search result A and search result B are example before and after scenario for an offer after a submission has updated the offer. Specifically, FIG. 7A shows a search result page with one offer entry in response to a query. FIG. 7B shows an equivalent page in response to the same query, but after the submission with a lower price (i.e., HKD 39.00 vs. HKD 56.00) has modified the offer entry. Note also the difference in the submission time.

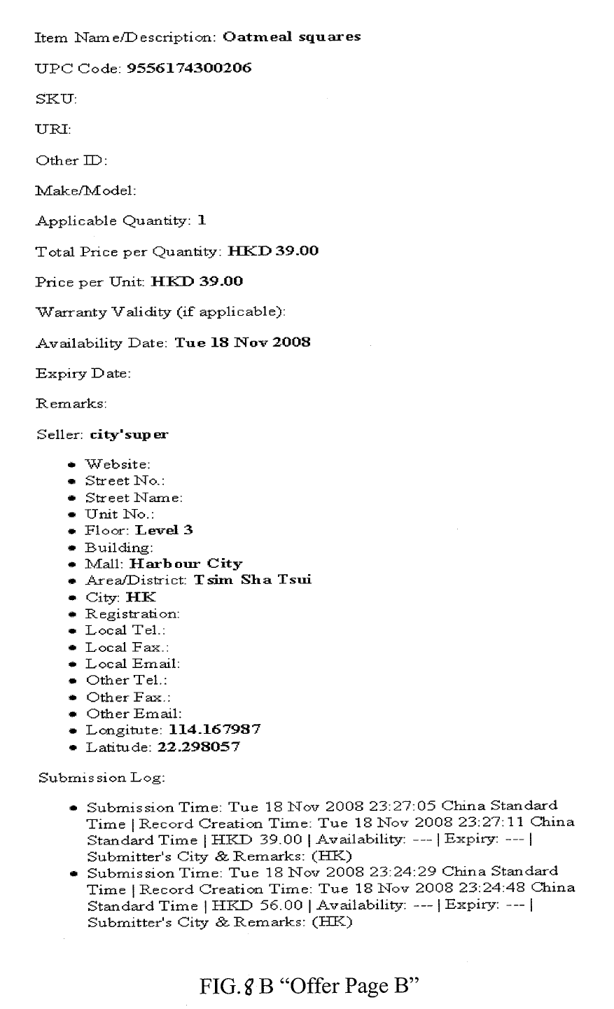

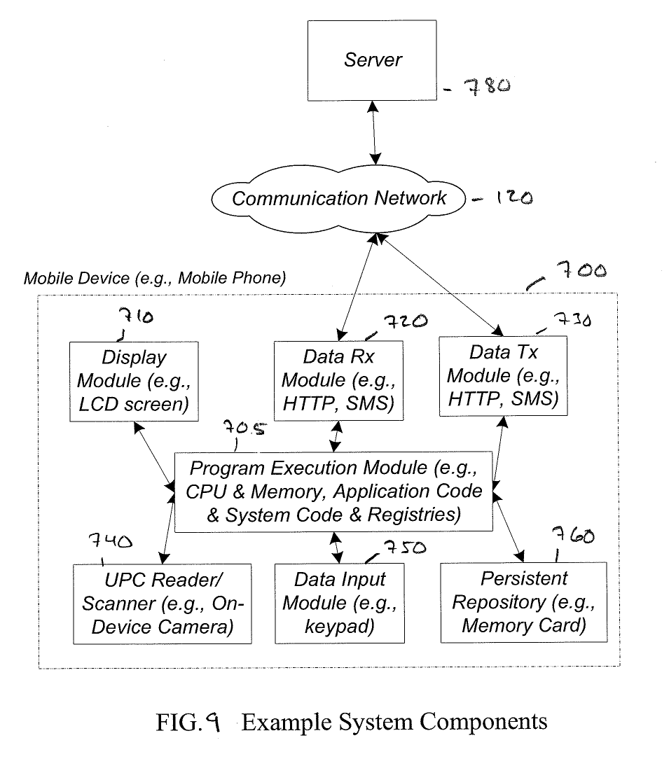

FIG. 8A shows an example “Offer Page A” offer page that may correspond to the offer entry shown in FIG. 7A. FIG. 8B shows an example “Offer Page B” that may correspond to the offer entry shown in FIG. 7B. The offer entry in either FIG. 7A or FIG. 7B is also a hypertext which may link to, or otherwise refer to, the respective offer pages associated with shown in FIG. 8A and FIG. 8B. While offer page shown in FIG. 8B may replace offer page shown in FIG. 8A, the former has in its submission log one more entry that captures the salient information of the latter as history. Note also that despite the lack of availability date in the offer submission, the offer page does contain an availability date. According to one embodiment, an offer database system may decide that the default availability date may be the date of receipt of the offer submission. As such, a user querying offers from the offer database system may then rely on the availability date for filtering and sorting offer entries. The offer database system whose partial modules and source code are shown respectively in FIG. 5 and the appendix may be configured to produce result pages identical to, or otherwise similar to, what are shown in FIG. 7A and FIG. 7B as well as in FIGS. 8A and 8B.

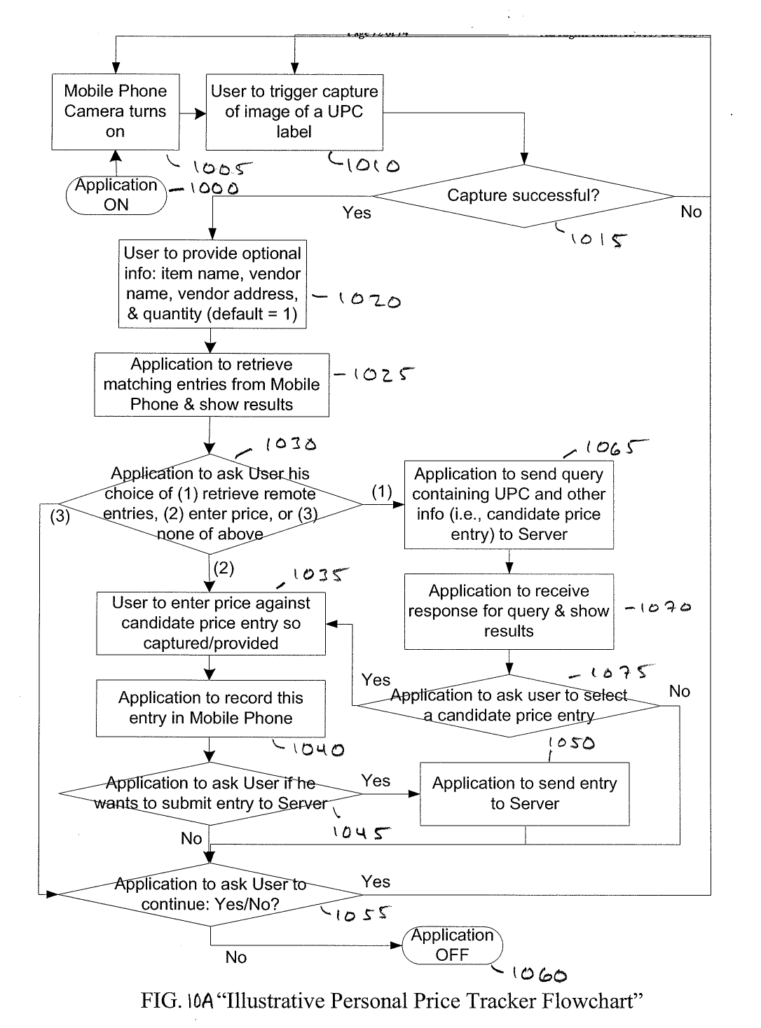

FIG. 9, labeled “Example System Components” shows an example set of components of a user portable device 700 embodying or otherwise employing various embodiments of the present invention. The user portable device is sometimes referred herein as a personal price tracker. The user portable device embodies or otherwise employs a method for tracking prices of an item for a consumer who may be faced with the difficulty in remembering how much they have paid for items they buy or use on a recurrent basis.

According to one embodiment of the present invention, a user portable device includes a program execution module 705. The program execution module may include a processor, a memory, a system library, program code, and registries, which are used for program code execution, as well as the application code that effects the various operations of the user portable device to achieve the functionality defined or otherwise expressed in the application code. The user portable device may also include a display 710, which is coupled to the program execution module. The display may be an LCD screen or the like. The display is configured to provide visual messages, indications, and feedback (e.g., view-finding for the UPC label of a product of interest).

The user portable device also includes a data receiver module 720 coupled to the program execution module. Data receiver module 720 is configured to provide for the receipt of messages and information (e.g., a price entry comprising an item identity code and a price, along with optional information) from a remote server over communication network 120. The user portable device also includes a data transmission module 730, which is coupled to the program execution module. Data transmission module 730 is configured to send messages and information (e.g., a price entry or a query for price entries) to a remote server, such as one or more of the servers in the offer database system. The user portable device also includes a UPC reader 740, which is coupled to the program execution module. UPC reader 740 is configured to digitally capture an image of a UPC label and retrieving the code embedded in the UPC label.

The user portable device also includes a data input module 750, which is coupled to the program execution module. The data input module may be an on-device keypad that is configured to accept data entry from a user. The user portable device also includes a persistent repository 760 (e.g., a memory card), which is coupled to the program execution module. The persistent repository is configured to store and maintain price entries and other salient information such as a user password even if the user portable device is turned off or out of battery power.

The user portable device may include other auxiliary or supplemental components or subsystems to provide price tracking (discussed below in detail). For example, the user portable device may include a battery, a communication bus for subsystem enabling communications and data transfer among the components shown in FIG. 9.

According to one embodiment, the user portable device shown in FIG. 9 is configured for identifying an item (e.g., a product or a server) using an electronic item identity code (e.g., UPC). The user portable device is further configured for accepting an entry of, or otherwise recording, a price for the item identified by the electronic item identity code. The user portable device is further configured to optionally record an item name for the item, a quantity of the item purchased or offered for sale at the price. The user portable device is further configured to accept for entry a seller identifier for a seller of the item (e.g., a seller name), and seller location information (e.g., an address, a location identified by GPS information). The user portable device is also configured to accept for entry a date with a default (e.g., the date on which the price for the item was entered) in the user portable device.

The user portable device is configured to store the price, the electronic item identity code, the optional item name, the optional quantity, the optional seller name, the optional seller address, and the date of entry of the price. The user portable device is further configured to retrieve the price entry in response to a query, which contains the item identity code and other information for an item. The user portable is configured to present the price entry on display module 710 for review by the user. The user portable device is further configured to change the price and the date in the price entry or add a new price entry with a new price, new date, and new quantity for the item. The user portable device may further be configured to retain or store the changed price entry or the new price entry.

The user portable device is further configured to send the price entry or the new price entry over wireless communication network 120, a channel, or a link to a server computer 780. Server computer 780 may be configured to store the changed price entry or the new price entry. The user portable device may also be configured to generate and send a query to server computer 780 for retrieving price entries stored by server computer 780. The user portable device may also be configured to receive as responses one or more price entries from the server computer. The user portable device may be configured to display the received price entries on display module 710 for user review. The price entries may represent a price history for a product that the user wishes to buy or has purchased in the past so that the user is aware of the price history.

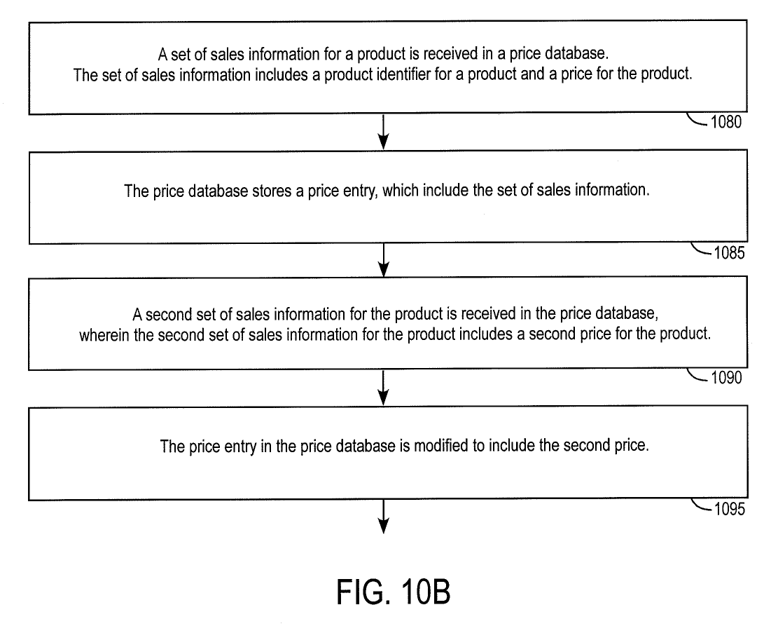

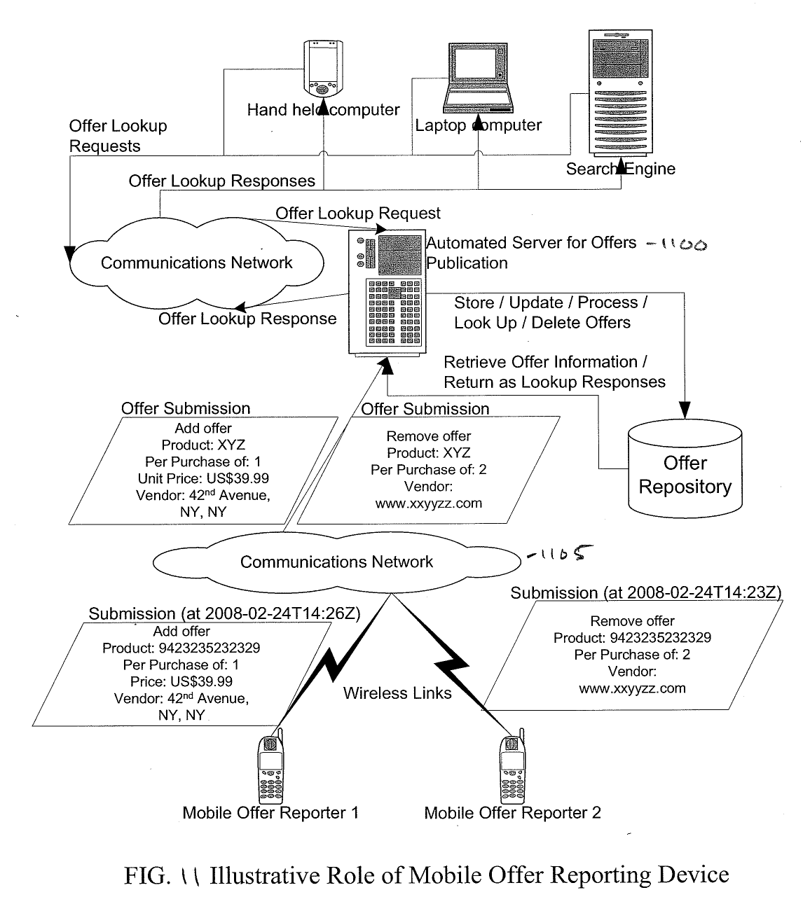

FIG. 10A is a high-level flow diagram for a computerized method for entering price entries in a price database and for retrieving price entries from the price database. According to some embodiment, the price entry method may also provide for retrieval of price entries for user review. Those of skill in the art will understand that various steps in the method may be added or combined without deviating from the spirit and purview of the embodiment. The high-level flow diagram is not limiting on the claims. The high-level flow diagram represents steps that may be executed by application software (e.g., computer code) on program execution module 705 in user portable device 700. The method in general provides a price storage and price retrieval method for users to track prices using their user portable device.

In overview, the price entry method provides an apparatus and method by which a user using a user device may create a price entry for an item (or item bundle) in a price database. The price database might be the offer and submission database 250, might be included in, or controlled, by server system 780, might be persistent memory 760, or might be a different database, database system, repository, or memory. A price entry includes a set of prices for an item. The set of prices may include one or more prices for the item. Each price in a price entry may have a set of price attributes associated with the price. A price attribute is a qualifier (or descriptor) for a price. A price attribute may include a date on which a price is placed in the price entry. For example, a price entry might include three prices for an item identified by an item identifier. The three prices (price 1, price 2, and price 3) may be respectively associated with three dates of entry. For example, price 1 may be associated with the date Jun. 1, 2008, price 2 may be associated with the date May 5, 2009, and the third price entry may be associated with the date Jul. 21, 2009. These dates may represent the dates on which the prices were entered into the price database. As the prices are for different dates, the price entry represents a price history for the item. In one embodiment, each price in a price history may constitute an individual price entry of an item in relation to a price entry representing a price history for the same item. In another embodiment, a price entry whose price information is obsolete may be grouped or otherwise related to the price entry having the latest price information for the same item, thereby creating a price history. These related price entries may be regarded as a single price entry having their constituent entries as subentries, or as independent price entries making up a price entry set. If the related price entries share the same offer identity, then they also create an offer history for the item of interest.

As briefly discussed above, a user using her user device may retrieve one or more price entries to review the price history. She might user her user device to retrieve the price entry for the item before she purchases the item again. In this way the user is informed about the price for the item over time. That is, the price entry provides a price history for the item. According to one embodiment, other users might be given access to this user's price entries via the price database. In one embodiment, a private price history accessible only to the user may be maintained outside the device, e.g., at server 780.

Other attributes for a price entry may include a seller identifier for a seller. As discussed above a seller identifier may include a seller name. A seller identifier might also include, or alternatively include, a seller location (e.g., URL, a street address, GPS coordinates. etc.), etc.

For example, a price entry or a price entry set might include the three prices and the three dates for the item discussed above. Price 1 for the item might be associated with the first date and a first seller identifier for a first seller. The first seller identifier might include the first seller name and a first store location. Price 2 for the item might be associated the second date and the first seller identifier.

The third price for the item might be associated the third date and a second seller identifier. The second seller identifier might include the first seller name, but might include a URL for the first seller's online store. Alternatively, a price entry might include prices, which are associated with different sellers. For example, the third price for the item might instead be associated with the third date and a third seller identifier. The third seller identifier might include a second seller name, and/or an address of the second seller.

Price attributes may include a variety of other information. For example, a price attribute might include a seller identifier that include a seller name, but does not include information for a seller location. Alternatively, a price attribute might include information for a seller location, but might not include a seller name.

Thereby a user via use of her user device may be able to create a price history for prices at one or more stores (brick-and-mortar stores, online stores, etc.) that the user might shop at. It is particularly noted that prices in a price entry or price entry set are not limited to purchases that a user has made. The user via her user device may generate, update, or retrieve a price entry when browsing, but not purchasing.

In respect of seller identity, the GPS coordinates discussed above may be particularly useful for a user if the GPS coordinates identify a particular store. On the other hand, if the GPS coordinates identify a shopping mall, the GPS coordinates might be relatively less useful for a user who might have to investigate the shopping mall to find a particular seller of the item among so many stores in the mall. Even if the user locates a particular store selling the item, the user might not be sure that the particular store located is the store for which the price was entered in the price entry.

Other price attributes for the price for an item may include a quantity of the item for the price. For example, a price in a price entry might include a price attribute for a quantity of two of the items for the price. Those of skill in the art will recognize additional price attributes that might be associated with a price for an item. These other price attributes are to be considered included in the scope and purview of the embodiments of the present invention.

According to an initial step 1000, if the application software described above is activated, user portable device 700, camera 740 on the user portable device is turned on (step 1010). LCD screen 710 is configured to serve as a viewfinder for the camera. The user may aim the camera at a UPC label for a product and then trigger (press a button) the capture of the UPC label via the camera (step 1020). If the capture is not successful (step 1015), the user portable device may be configured to direct the user to try again to capture an image of the UPC label. Alternatively, no user trigger may be needed if, for example, the camera is on a continuous scanning mode, in which it attempts to identify and capture a UPC label without user intervention. If the capture is successful, the user may be prompted in a step 1020 to provide optional information, such as an item name for the product, vendor name of a vendor offering the product for sale, a vendor address for the vendor, and a quantity of the product offered for sale for the price. According to one embodiment, the default value is one. The user portable device may be configured to accept a user entry for proceeding whether or not all of the foregoing described information is received by the user portable device from the user. Upon confirmation, the application software operating on the program execution module may treat all the information entered along with the UPC code as a price entry.

According to one embodiment, at a step 1025, the user portable device may be configured to search its local persistent repository 760 for price entries matching (or otherwise relevant to) the price entry entered in step 1010 and 1020. The user portable device may be configured to present the price entries retrieved from the persistent repository on the LCD screen.

At a step 1030, the user portable device may be configured to present a series of question on the LCD screen to ask the user if she wants (1) to retrieve entries from remote server 780 (where extra charges might be incurred), (2) to enter a price for the price entry, or (3) to do nothing. A selection of the third choice may end the current session associated with the price entry entered at steps 1010 and 1020. A selection of the second choice may configure the user portable device to ask the user (e.g., via the LCD screen) to enter a price for the price entry (step 1035). The currency by default may be pre-assigned with the user portable device, pre-selected by the user at the time of device initialization, or pre-determined with the location of the device or the user's subscriber account. For example, the location may be determined from a phone number associated with a mobile phone if the user portable device is mobile phone. Alternatively, the user portable device may be configured to allow a user to choose a currency. The price entry now having a price may then be stored in the persistent repository 760, under control of the program execution module, for example (step 1040).

According to one embodiment of the present invention, the user portable device is configured to ask the user whether the user would like the price entry stored by remote server 780 (step 1045). If the user portable device receives confirmation that the user would like the price entry stored by server 780, then user portable device may be configured to submit the price entry to the server via data transmission module 730 (step 1050). Otherwise if the user portable device does not receive a request to store the price entry by the server, the user portable device may be configured to terminate the process or ask the user whether the user would like to perform another task such as entering another price entry or retrieving a price entry (step 1055). If the user portable device receives a request to end the method, the execution of the software application may be terminated by the program execution module (step 1060).

If the user selects the first choice at step 1030, the user portable device may be configured to send a query through the data transmission module to server 780 (step 1065). Such a query may contain the price entry entered in steps 1010 and 1020. The query provides the search criteria for the remote server to search for price entries matching (or otherwise deemed relevant) to these criteria. If the server transmits a set of price entries from the search to the user portable device, the user portable device may be configured to display the result on the LCD screen for the user to view to thereby receive a price history for the product (step 1070). According to one embodiment, the user portable device is configured to select a price entry (whether the one used in the query or one from the result). A selection of a price entry may continue the current session in a similar manner as the selection of the second choice described above (step 1075). Otherwise, the current session associated with the price entry may end.

There are many possible variations of application code in addition to the one whose functionality is presented in FIG. 10A. For example, the user device may be configured to allow a user to have a price entry submitted to remote server 780 without maintaining a local copy of the price entry on the user portable device.

FIG. 10B is another high-level flow diagram for a computerized method for entering price entries in a price database and for retrieving price entries from the price database where the price entries represent price histories for item or item bundles. Those of skill in the art will understand that various steps in the method may be added or combined without deviating from the spirit and purview of the embodiment. The high-level flow diagram is not limiting on the claims. The high-level flow diagram represents steps that may be executed by application software (e.g., computer code) on program execution module 705 in user portable device 700.

At a step 1080, a set of sales information for a product is received in a price database. The set of sales information includes a product identifier for a product and a price for the product. While the information for the product is referred to as sales information, it should be understood that the information may or may not be associated with an actual sale of the item. At a step 1085, the price database stores the price entry, which includes the set of sales information. According to one embodiment, the price entry is editable to generate a purchase history. The price and the item identifier might be a “minimal” amount of information for a price entry. The price entry might include a variety of other information to qualify the price, such a seller identifier, a quantity, a date for a price, or the like. According to one embodiment, the method further includes receiving in the price database a second set of sales information for the product, wherein the second set of sales information for the product includes a second price for the product, step 1090. The price entry in the price database is modified to include the second price, step 1095. The dates for which the first price and the second price were entered in the price database may be included in the price entry. Using the user device a user may enter additional price entries that include prices for other items, which have other item identifiers. The price entries may be generated, edited, and retrieved via the user device to generate, edit, and retrieve a price history that the price entries in the price database represent. Via the price history users may inform themselves about prices for items over time, for a variety of vendors, vendor locations, and the like. That is, the user is not subject to the Penn effect discussed in the background section. Specifically, the user is provided with apparatuses and methods for tracking and sharing price information locally, globally, and the like, with specificity ranging from a general price point in time to a particular offer from a specific seller. That is, a price history so generated may create not only a purchase history for a consumer, but also an offer history for a product from a particular seller. As such, a consumer does not need to be subjected to “paying more in the dark”. That is, “paying more in the dark” was an important phenomenon of actual history, but not an inevitable in view of the apparatuses and methods of one of the embodiments of the current invention described herein.

Other specific implementations for embodiments of the present invention are contemplated. For example, an authenticated submission (e.g., the mobile phone number that sends it) might omit the provider information (name and/or address) if the provider information is already properly associated with the sending mobile phone number at the offer database system. This may further reduce the amount of data to be entered by a device operator.

For example, many professional sellers and merchants know about popular online auctions and shopping sites but many of them do not use the services. The user interfaces of these websites pose a challenge to these professional sellers despite their educational or professional background. This is similar to the challenge many have with programming their clock radios or setting a timer recording on a VCR. For example, the need to turn on a general-purpose computer and run a Web browser so to enter a web address may already pose a barrier substantial enough that such action are not performed by sellers. These obstacles create a barrier for sellers and the like who may otherwise take advantage of the online information space (e.g., the Internet) to become more efficient and competitive in their operations and businesses. To aid these sellers become more efficient and competitive in their operations and businesses, one embodiment of the present invention provides a method for advertising individual offers. The method may include:
i) associating a vendor identification code (e.g., a phone number) with a vendor name and street address;
ii) associating an item identification code (e.g., a UPC) with a product, a service, or a name or description of the product or the service;
iii) specifying the vendor identification code and the item identification code as part of an electronic request;
iv) specifying an optional quantity in the electronic request where the quantity has a default of one;
v) specifying or otherwise implying in the electronic request an intent for offer removal if applicable;
vi) specifying a price if the intent for offer removal does not exist;
vii) sending the electronic request so specified over a communication network, channel, or link to the offer database system, which may be configured to cause any existent entry matching, or otherwise including, the vendor identification code, the item identification code, and the quantity to be removed from storage and, if the electronic request contains no intent for offer removal, to cause a new entry comprising the vendor identification code, the item identification code, the price, and the quantity to be created in the storage; and
viii) advertising entries in the storage as individual offers, wherein each individual offer includes a vendor name, a street address, an item identification code, and/or a name or description of the product or the service, a price and a quantity corresponding to each said entry so advertised, so as to be retrievable, searchable, or otherwise accessible through a communication network, channel or link.

Specifically, the embodiment includes a device configured for accepting information and directives about offers of item for sales and use from a user (e.g., a vendor), and a server configured for receiving electronic submissions of these offers and publishing or otherwise making the offers available for retrieval. Such a device includes a network communication module configure for sending and receiving (preferably wirelessly) messages or data to and from a pre-determined server specifically for online publication of offers, a user interface module capable of displaying or otherwise communicating information to and receiving input and instruction from a user, a control and processing module capable of interacting with a user through the user interface module, an item identity capture model (e.g., scanning, reading or receiving GTIN codes or RFIDs), and a memory module capable of supporting the operation of the aforementioned functional modules, as well as other complementary modules, such as an intra-device communication subsystem and a persistent repository for maintaining data (e.g., on-device user password) even if the device is out of power.

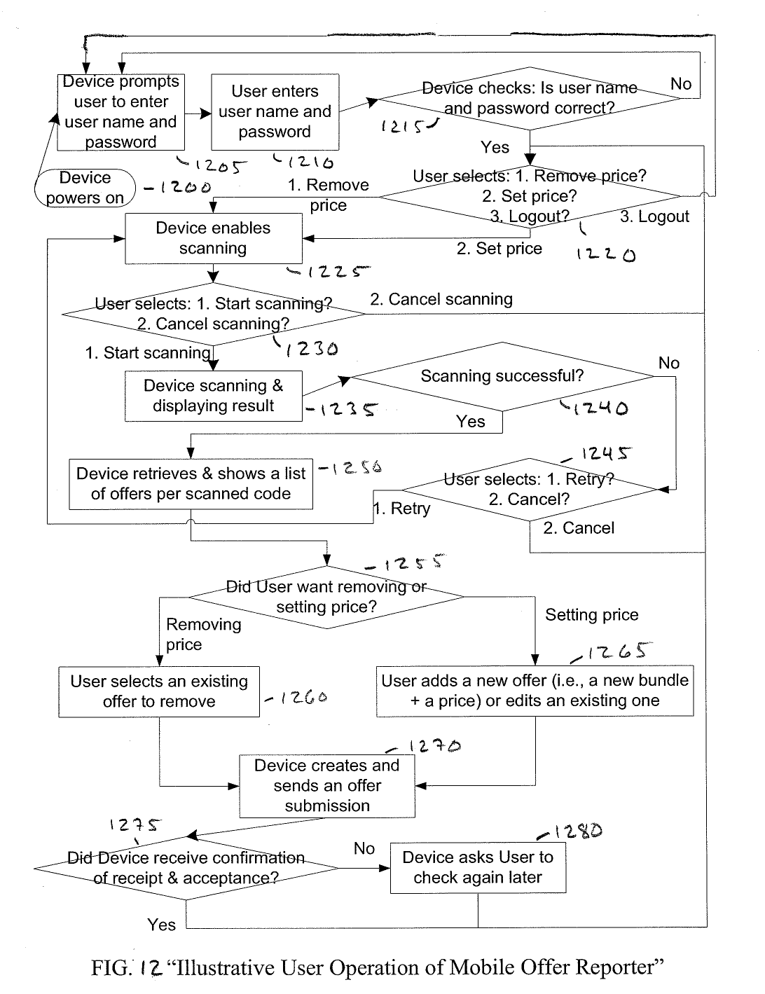

FIG. 11 is a simplified schematic of a mobile offer reporting system according to one embodiment of the present invention. The offer reporting system includes a Mobile Offer Reporter 1 and a Mobile Offer Reporter 2. The offer reporting system also includes a server 1100 (e.g., Automated Server for Offers Publication, an example offer database system). According to one embodiment, Mobile Offer Reporter 1 is configured to send an electronic submission wirelessly over a communication network 1105 to the server to add an offer comprising a product identity (i.e., a UPC whose code is 9423235232329), applicable purchase quantity, price per quantity, and a vendor name, address or an equivalent (e.g., a Web address). Alternatively, Mobile Offer Reporter 2 is configured to send an electronic submission to server 1100 to remove an offer, which includes the same product identity, but includes a different applicable purchase quantity and vendor address.

On receipt of these submissions from Mobile Offer Reporters 1 and 2, the server 1100 may be configured to store, update, delete, and process the offers. In addition, server 1100 may be configured to receive requests for offer lookups from user devices and proxy services (e.g., hand-held computer, laptop computer and search engine), and retrieve matching (or otherwise relevant) offer entries or information, and return the results to these requesting devices and proxy services. The example system components shown in FIG. 9 as described and discussed above are also applicable or otherwise relevant to an implementation of a mobile price reporter whose functionality may also be realized as application code on a user portable device such as a camera-equipped mobile phone.

According to one embodiment of the present invention, a Mobile Offer Reporter includes (1) a wireless communications interface module (e.g., Wi-Fi, mobile phone networks or some other device for wireless communication) capable of communicating with a pre-determined server for online publication of offers. The Mobile Offer Reporter may also include (2) a user interface module with a visual display capable of displaying information for a user. The Mobile Offer Reporter may also include (3) a data receiver module (e.g., a barcode scanner or the like, an optical scanner, an image capture device, a wireless receiver, etc.) configured to identify a specific product or service, and optionally identifying the price, and the ordering information for the product or the service. The Mobile Offer Reporter may also include (4) a processing module capable of preparing an offer submission using the information contributed by (a) the user interface module, (b) the data receiver module and (c) the pre-determined server, and of sending the offer submission so prepared to the pre-determined server via the wireless communications interface module. The Mobile Offer Reporter may also include (5) a memory module capable of supporting the functions of other individual modules as described, as well as other complementary modules, such as an intra-device communication subsystem and a persistent repository for maintaining data even if the device is out of power.

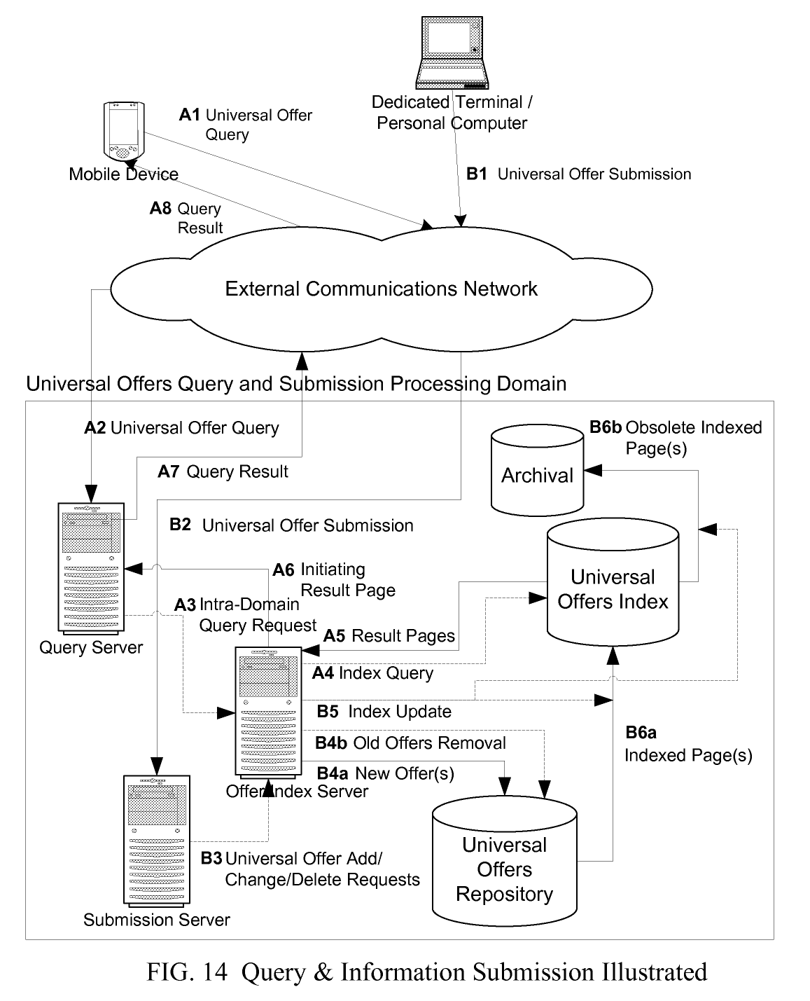

A Mobile Offer Reporter assigned to a particular seller may have preprogrammed into the Mobile Offer Reporter a street address or online address for ordering for the seller so that offers submitted through the Mobile Offer Reporter may include the preprogrammed address as its ordering address. The Mobile Offer Reporter may be dedicated to a given seller. According to one embodiment, the Mobile Offer Reporter may be configured to accept multiple addresses if the device is used for multiple seller business location. It is also possible that for authentication purposes a seller might not be allowed by the seller's Mobile Offer Reporter to change the preprogrammed ordering addresses on the device. Given a user name and password with which to operate the Mobile Offer Reporter, a user may be required to log on to the seller's Mobile Offer Reporter before being allowed to submit an offer through the Mobile Offer Reporter. This generally limits use of the Mobile Offer Reporter to authenticated users. According to one embodiment, a mobile offer reporter may send a seller identifier (e.g., a logon ID and password) in lieu of a vendor name and/or address. The offer database system may then retrieve via the seller identifier the actual vendor name and address that may be pre-registered with the system against the seller identifier. The vendor name and address so retrieved, not the original seller identifier (e.g., logon ID and password), becomes part of the offer information that may be available for query and retrieval. According to yet another embodiment, prices for different products may be submitted with a single seller identifier, which may then be separated from one another and combined individually with seller contact information corresponding to the seller identifier, thereby creating individual offers each capable of being evaluated and compared independently. FIG. 13 is a high-level flow diagram that illustrates an example method 1300 that accepts one or more pieces of partial offer information 1310, along with a seller identifier 1340, and generates individual offers 1370 each including one of the one or more pieces of partial offer information and an actual seller name and address corresponding to seller identifier 1340. Those of skill in the art will understand that various steps in the method may be added or combined without deviating from the spirit and purview of the embodiment. The high-level flow diagram is not limiting on the claims. For instance, a partial piece of offer information 1320 includes only product identity A1 and price X1 per applicable quantity Y1, and a partial piece of offer information 1330 includes only product identity A2 and price X2 per applicable quantity Y2. Partial piece 1320 and partial piece 1330 may be submitted (e.g., by a mobile offer reporter) along with a seller identifier 1340 to a system or server 1360 (e.g., an offer database system) capable of individual offers generation through combining the received partial offer information with an actual seller name and address per seller identifier 1350, which may be maintained by or otherwise accessible to system or server 1360. The resulting individual offers 1380 and 1390 would respectively include product identity A1, price X1 per applicable quantity Y1, seller name and address Z, as well as product identity A2, price X2 per applicable quantity Y2, seller name and address Z. Each of these resulting offers is capable of being evaluated and compared independently.

A Mobile Offer Reporter may also be equipped with the current state of the art technologies to facilitate the capture of information usually required via manual user input. For example, a Mobile Offer Reporter may include a GPS (Global Positioning System) receiver to provide location information of the Mobile Offer Reporter. A Mobile Offer Reporter equipped with a camera or scanner capable of character recognition may be able to recognize the UTIN (Universal Trade Item Number) printed, the price labeled and the description depicted on the product or its packaging (or displayed on a computer screen or some other means). Alternatively, the Mobile Offer Reporter may be configured to capture the images of needed information and transmit them to a server for processing so to extract the needed information from the images. According to one embodiment of the present invention, a Mobile Offer Reporter may be a PDA (Personal Digital Assistant), or a mobile phone having programming code for operating the methods described herein above.

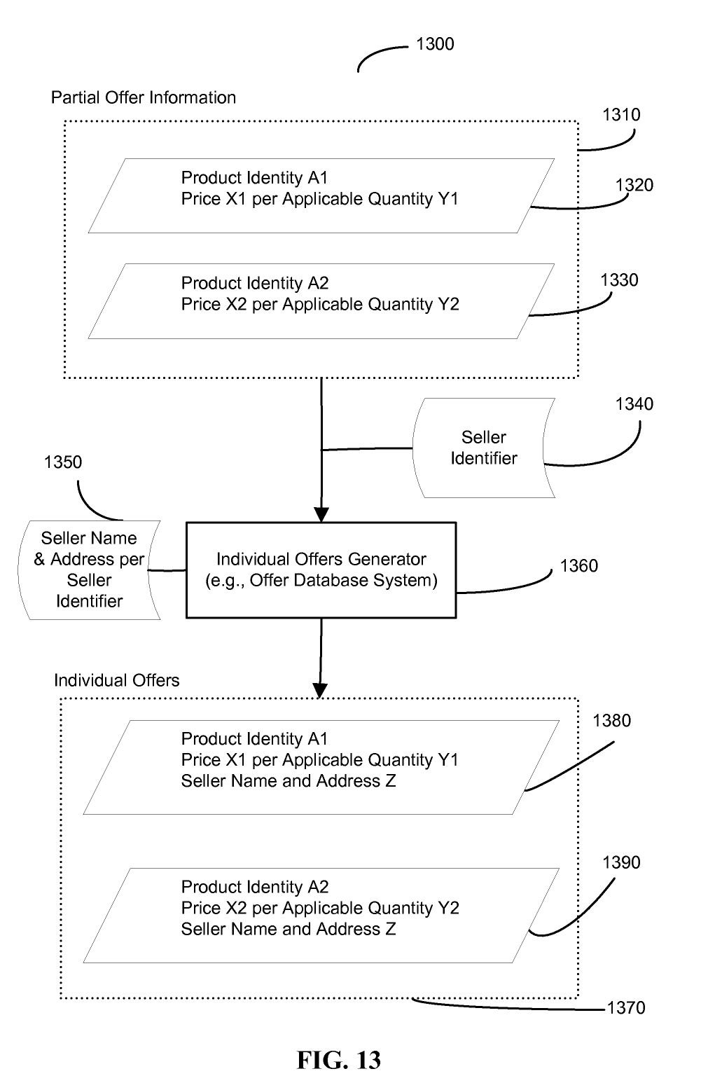

FIG. 12 is a high-level flow diagram for an operation method for a Mobile Offer Reporter according to one embodiment of the present invention. Those of skill in the art will understand that various steps in the method may be added or combined without deviating from the spirit and purview of the embodiment. The high-level flow diagram is not limiting on the claims. More specifically, the high-level flow diagram shows a method of operation of a Mobile Offer Reporter pre-programmed with an ordering address or its equivalent, and/or the currency in use, implicitly or otherwise explicitly specified. For instance, an offer database system may store or otherwise maintain the actual ordering address (and the seller name) with respect to some seller identifier known to, associated with, or otherwise available at the Mobile Offer Reporter. Example seller identifiers include user name (with or without password) or the device ID of the Mobile Offer Reporter. The method of operation may be implemented in a software application, a firmware application, or the like operating on the Mobile Offer reporter.

At a step 1200 the Mobile Offer Reporter is powered on or the software application is activated, for example via receipt of a user selection (button press or the like) requesting that the software application be launched. At a step 1205, the Mobile Offer Reporter is configured to prompt the user to enter a user name and password. At a step 1210, the Mobile Offer Reporter may be configured to refuse to continue operations until the user enters a valid user name and the correct password for the valid user name. Receipt by the Mobile Offer Reporter of valid user name and a valid password for the valid user name is generally referred to a logging onto to the software application or onto the Mobile Offer Reporter. After successfully logging onto the Mobile Offer Reporter (step 1215), the Mobile Offer Reporter is configured to present a question to the user for selecting a desired operation to perform. The options for the desired operations include: 1) remove the price of a product or service for a price entry, 2) set the price of a product or service for a price entry, or 3 log out (step 1220). If operation 3 is selected, then the Mobile Offer Reporter may go back to the power up state at step 1200, and may ask the user to enter a username and password again.

If either operation 1 or 2 is chosen, the selection of one of the operations may enable the scanning module on the Mobile Offer Reporter (step 1225). The Mobile Offer Reporter may then be configured to prompt the user to direct the capturing sensor of the scanning module towards a code (e.g., QR Code, UPC, and SKU) for the product or service to start scanning, and/or directs the user to select an option to cancel the scanning mode (step 1230). If the Mobile Offer Reporter receives a request to cancel the scanning mode, the Mobile Offer Reporter may be configured to restart the selection process of step 1220 (i.e., remove price, set a price, or logout).

If the Mobile Office Reporter receives a request from the user to start scanning, the Mobile Offer Reporter may then start scanning the code (step 1235). If the scan is successfully completed (step 1240), the Mobile Offer Reporter may display the results of the scan on the LCD screen. If the scanning operation is not successful, the Mobile Office Reporter may be configured to ask the user if the user wants to retry scanning the code or cancel the scanning operation (step 1245). Retrying scanning may bring the Mobile Offer Reporter back to having the scanning module enabled and waiting for the user's cue to start scanning. Canceling the scan mode may bring the Mobile Offer Reporter back to asking the user what operation to perform (i.e., remove price, set price, or logout).

As discussed briefly above, a successful scanning operation may result in the Mobile Offer Reporter presenting the scanned code on the LCD screen. A successful scanning may also configured the Mobile Offer Reporter to display a list of bundles or offers (i.e., different qualifying purchase quantities per scanned code) and their prices (either available locally in the Mobile Offer Reporter and/or through a remote server) if there are such bundles/offers matching the scanned code (step 1250). That is, if the user has not previously entered any pricing information for the product or the service represented by the code, then there may be no such list.

If the user chose earlier at step 1220 to remove a price, then the Mobile Offer Reporter may be configured to ask the user to select an existing bundle/offer from the displayed list (step 1255) to remove the existing bundle/offer (step 1260).

Alternatively, if the user chose to edit the price for an existing bundle/offer or add a new one bundle/offer (i.e., a new bundle/offer comprising a UPC code and a quantity), the user may enter the new offer or edit the prices of existing bundles/offers. Specifically, the Mobile Offer Reporter may be configured to present the list of existing bundles with their prices, which may be changed via a user input (step 1265). To add new bundles/offers and prices, the Mobile Offer Reporter may present a blank entry field for a qualifying quantity and one for the corresponding price (whose currency might be explicitly selected or defined). The user may specify as many such entry pairs as desired (step 1265). If the user confirms with the Mobile Offer Reporter that his entries are completed, then the Mobile Offer Reporter may check if there are existing bundles/offers in conflict with the newly added ones, and confirm with the user if there is such a conflict.

If completed (either removing a price or setting a price), the Mobile Offer Reporter may be configured to create the corresponding submission(s) and send the submissions through the communications module to a pre-determined server (step 1270). If the Mobile Offer Reporter fails to receive a success confirmation from the server within a preprogrammed period of time (step 1275), then the Mobile Offer Reporter may stop waiting for the confirmation and it may ask the user to check later (step 1280). The Mobile Offer Reporter is then configured to execute another operation, for example, remove price, set price, or logout.

According to one embodiment, a user or a provider of a Mobile Offer Reporter may want to switch to a different pre-determined server for processing and publication of price entries. The change may be effected programmatically on the Mobile Offer Reporter or via the existing pre-determined server. Or similar to the GSM mobile phone network, a change of a removable chip (such as the SIM card for GSM mobile phones) on the Mobile Offer Reporter may effect the change. According to another embodiment, a seller identifier may be made available to a mobile offer reporter dynamically. For example, a server may send contact information for a plurality of sellers as well as their identifiers to the device based on a location the user chooses on the device or the location of the device. The user may then be prompted by the device to select one of these sellers. The device may use the seller identifier of the chosen seller as part of the offer identity when sending the offer information to the server. For security, many current state of the art technologies and methods may be employed to secure the Mobile Offer Report and the communications of the Mobile Offer Reporter, such as inactivity timeout on the Mobile Offer Reporter after a predetermined period of time, request an additional authentication token (e.g., a time-specific pass code sent to the user's mobile phone via SMS), and encrypted communications between the Mobile Offer Reporter and the pre-determined server.

Furthermore, additional services or features may be introduced to complement the use of a Mobile Offer Reporter, such as a lookup that provides a translation between UPCs and product/service descriptions. Further, instead of a fixed-price offer, a product or a service may be priced through an auction. An auction may require more than one piece of pricing information, such as the price increment and the reserved price, if any.

One who is skilled in the art may also be able to provide an implementation of a pre-determined server suitable for a particular application or system equipped with a Mobile Offer Reporter. For example, a laptop computer having Internet access capability, and having a mobile phone network communication module (such as that of a GSM Network) may be programmed to process the SMS messages received through that communication module (which is associated with an operational mobile phone number pre-programmed in the GSM SIM card inside the module). Each processed SMS message may provide the required information for adding, changing, or deleting an offer. A search engine service running on the laptop computer may incorporate this offer request into its offer index and make the update available for lookup via the Internet access. Hence a Mobile Offer Reporter equipped with a mobile phone network communication module and a processing module for formulating an offer submission into a SMS message may be configured to send the offer submission as SMS to the laptop computer using a mobile phone number known to reach the pre-determined server, i.e., the laptop computer so described.

In respect of an item bundle, an offer may also involve multiple heterogeneous items, e.g., one mobile phone plus one Bluetooth headset. (Note that multiple UPCs may exist for the same item. Hence despite its uniqueness in identifying an item, UPC may not be relied on completely to determine heterogeneity among a group of items. That is, a group of the same items may have different UPCs.) A consumer originally interested only in such a Bluetooth headset may consider this bundle offer if the mobile phone is practically a giveaway or he finds his perceived incremental cost for getting the mobile phone in the bundle is attractive. In fact, if a consumer is actually looking for both the mobile phone and Bluetooth headset, bundle offers as such as well as offers of the individual mobile phone and Bluetooth headset are all relevant to his consideration. And the consumer may still likely choose a combination of offers of individual items over bundle offers if the total cost of ownership for the former is less than the latter. Hence an embodiment of the present invention may allow a user to provide identity codes for multiple items in his query for relevant offers. In addition, it may retrieve or otherwise reveal bundle offers in response to queries for single items. The ranking of available offers (such as for display priority) may take into consideration the locations of the offer providers and the prices of the items and quantities of interest, as well as other criteria such as ratings of the providers and their affiliations and certifications.

With the ubiquity of camera-equipped mobile phones and advances in microprocessors and image processing, many consumers and users alike may often carry a mobile phone capable of taking a photo and performing processing on the image of the photo. As such a mobile phone is a good candidate platform for a user portable device enabled by a software application installed on the mobile phone. The software application (such as the one whose partial modules are shown in FIG. 4) may enable a user of the mobile phone to read in the numerical value of a UPC code label on a product package or other visual displays. Among product identification, vendor contact address and prices, the vendor contact address may usually be the most labor-intensive data entry process. To make it easier, the application may keep history of the past addresses or make use the existing ones in the mobile phone's own contact application. To assist in the first-time entry, it may also use the on-phone camera to take a photo of an address on newspaper, on screen or from other some exhibits to perform optical character recognition to initialize the text fields to be entered for the address.

In addition, the use of GPS coordinates as address information for a vendor enables navigation to the location of the address if a user carries a GPS-equipped device (e.g., a GPS-capable mobile phone or user portable device). In fact, for a person not familiar with the neighborhood or the language the address is given in, the use of GPS coordinates may work better than having street addresses if he is equipped with an electronic GPS coordinates-aware map (even one without an active GPS receiver or the like). A GPS-coordinates capable electronic map or a device equipped with such a map may present the exact location with orientations and directions as well as in a language of the user's choice.

The location information shown in FIGS. 8A and 9B includes a pair of longitude and latitude (i.e., GPS coordinates). A user portable device may also support the entry of GPS coordinates (e.g., as given by the on-device GPS module, manually entered by the user, or captured from a GPS coordinates-embedded address code—graphical or otherwise). This GPS information may enable a user portable device or a server (e.g., an OQS server) to pinpoint a spot on an electronic map as the location of an offer provider of interest. In addition, a device, system, method or process equipped with the present invention may also employ non-wireless or non-portable devices or terminals for accepting data entry for electronic submissions.

### A1. Embodiment for Peer-to-Peer Per-Offer Advertising for Goods and Services

Another embodiment of the present invention for solving the Penn effect is described below. One embodiment of the present invention provides an advertising and query system and method where consumers, vendors, and volunteers could provide and query offers (of goods and services) with specific regard to delivery locations and disregard of category constraints on their goods and services of interest. That is, the availability and pricing information may specifically be tailored to the location of delivery or consumption of the goods and services so that a consumer or his proxy (whether a person, a machine, or a device) at a particular location (e.g., in a city or at a street intersection) would be able to obtain accurate and relevant information for his product or service of interest and to perform comparison among offers that are available to him for that location. (The user needs not be at the location of delivery or consumption; he could be ordering the product or service for someone else at that location.)

In addition, the advertising and query system and method would entertain offers from both online vendors and offline vendors (i.e., those traditional stores and shops that accept in-person and telephone ordering but no online ordering). Online offers and offline offers need no longer be advertised or considered as if they were inherently incompatible for comparison.

Furthermore, competing offers from different vendors would be presented based on their own merits in relation to a consumer or buyer's criteria. A consumer would be able to optimize his buying power and time efficiency by choosing a combination of offers that satisfy his criteria in prices, delivery timeliness and location convenience, just to name a few. He would no longer be inclined to believe that a retailer simply selling one item cheaper than other retailers would likely sell other items also cheaper, or that a large retail chain store would always sell his popular items cheaper than a small “Ma and Pa's shop”. In fact, the advertising and query system and method made possible by the present invention would encourage entrepreneurs to focus their business on what they know and can sell best, thereby competing effectively with large vendors that may lack such specificity. The large advertising budget that is not really related to an offer of interest but rather for image building may no longer afford large enterprises as much strategic advantage over their smaller counterparts as in the present when without the present invention.

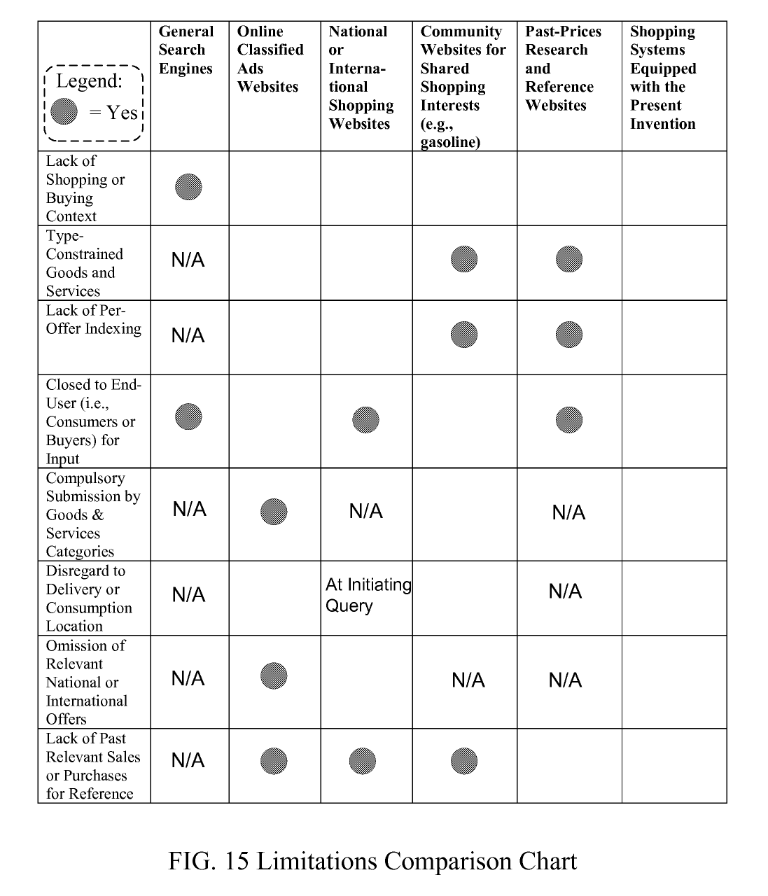

FIG. 14 “Query & Information Submission Illustrated” shows how the present invention in this regard may be realized. With a sending device such as a dedicated terminal, a personal computer or some other means, a user (e.g., a vendor, consumer or volunteer) would submit an individual piece of information on past location-specific sales or on a location-sensitive present or future offer (B1 in FIG. 14), whether or not specified in a product category or service category-specific format. The submission data would be delivered via a communications network external to a Universal Offers Query and Submission Processing Domain. All such submissions (whether of past sales, present offers or future offers) are herein collectively referred to as universal offers. The Processing Domain comprises a plurality of query servers, submission servers, Offer Index Servers, universal offers repositories, universal offer indexes, and optional archival, all of which are connected via a communications means which facilitates data transfer and control handling among these entities and, if applicable, of these entities with external communications networks.

Note that although these servers and repositories represent functional entities capable of being individually deployed, they are not necessarily confined to such physical installations or components, since many implementations of such functional entities could result in one or many different network, hardware and software configurations. In addition, for the sake of clarity, the illustration only shows one instance per a plurality of the same server or repository possible in a typical operational configuration. Furthermore, other functional entities and data repositories in a typical commercial deployment, such as those for connection and message setup and routing, performance reliability and load balancing, network security and user authentication, are not illustrated because they are readily available and understood as commodity components and methods in the current state of the art. Those skilled in the art would readily understand the design so illustrated in the interest of the specification of the present invention.

A Submission Server would receive the universal offer submission (B2 in FIG. 14) entering into the Universal Offers Query and Submission Processing Domain. While client software or some other means on the sending device may have already provided some error checking on the piece of information before its submission, the Submission Server is still responsible for ensuring the received piece of information is adequate as a submission in relation to the criteria of a receiving Offer Index Server. For example, an Offer Index Server would treat each of its input entry as a page in the typical context of indexing and searching. Such a page may contain named fields whose data can be grouped, indexed, and searched separately in comparison to other pages having the same, equivalent, or related fields. The Submission Server would then prepare a request based on the input entry and send the request to a receiving Offer Index Server accordingly.

In addition to the information pertaining to the submitted universal offer, the request (B3 in FIG. 14) sent by the Submission Server to a receiving Offer Index Server would also carry, if applicable, the indication to the Offer Index Server whether the request is to add a new offer, change an existing offer, or delete one. To change or delete an existing offer, the indication would also provide matching criteria or identity information that refers to one or more offers in the repository.

Moreover, the Submission Server may also generate a plurality of pages based on a single entry page using various techniques for the purpose of indexing and matching per-page offers, such as the one described in the “Hierarchically Constructed and Arithmetically Generated Pages for Matching and Indexing” below.

The receiving Offer Index Server would update the Universal Offers Repository under its jurisdiction with the submitted universal offer page(s). New and replacing offers (B4a in FIG. 14) would be stored into the Universal Offers Repository, while the ones to be replaced are requested (B4b in FIG. 14) for removal. The Offer Index Server may initiate the updating of the index right afterwards, or schedule a periodical update while allowing for system administrators to request the updating on demand. Such an index update (B5 in FIG. 14) would cause either an incremental indexing (i.e., only for offers not yet indexed) or a more comprehensive one (i.e., include also offers that have already been indexed to optimize storage, distribution and retrieval performance). New indexed pages (B6a in FIG. 14) would then be made available to a Universal Offers Index which serves Offer Index Servers in their responses to a Query Server handling a user's query. Obsolete indexed pages (i.e., those that are corrected by their replacing pages) might then be stored away into an optional archival (B6b in FIG. 14) for record or separate access. (If present or future offers were not to be considered as past sales for a given embodiment of the present invention, then these offers may also be archived away once they have expired.)

Contemporaneously, with a sending device such as a mobile device, a personal computer or some other means, a user (e.g., a vendor, consumer, or advertiser) would submit a location-sensitive query (A1 in FIG. 14) for universal offers, whether or not specified in a product category or service category-specific format, to a Universal Offers Query and Submission Processing Domain via a communications network. A Query Server would receive the universal offer query (A2 in FIG. 14) entering into the Universal Offers Query and Submission Processing Domain. The Query Server would generate an Intra-Domain Query Request (A3 in FIG. 14) and send it to an Offer Index Server which is assigned to serve the Query Server. (This Offer Index Server need not be the same Offer Index Server that accepted and indexed the universal offers matching to the query.) The receiving Offer Index Server would perform an index query (A4 in FIG. 14) against a Universal Offers Index assigned to serve the Offer Index Server. The result of this query (A5 in FIG. 14) may result in zero or more result pages, or the references to these result pages. The Offer Index Server would construct an initiating result page (A6 in FIG. 14) which lists the headings along with excerpt information for the first set of the result pages, along with the references to other sets. All these headings, excerpt information and references on the initiating result page would embed a hyperlink for the user to retrieve further details about the offers on the result pages and to list the other offers in subsequent result page sets not yet presented but available as part of the response to the user's original query.

Upon the receipt of the initiating result page, the Query Server would send it as a query result via an external communications network (A7 and A8 in FIG. 14) to the client device for presentation to the user.

A person or a team who is skilled in the art of the search engine development for enterprise and public use as well as the Web user interface design would be able to realize the present invention into various embodiments that provide the advantages described herein.

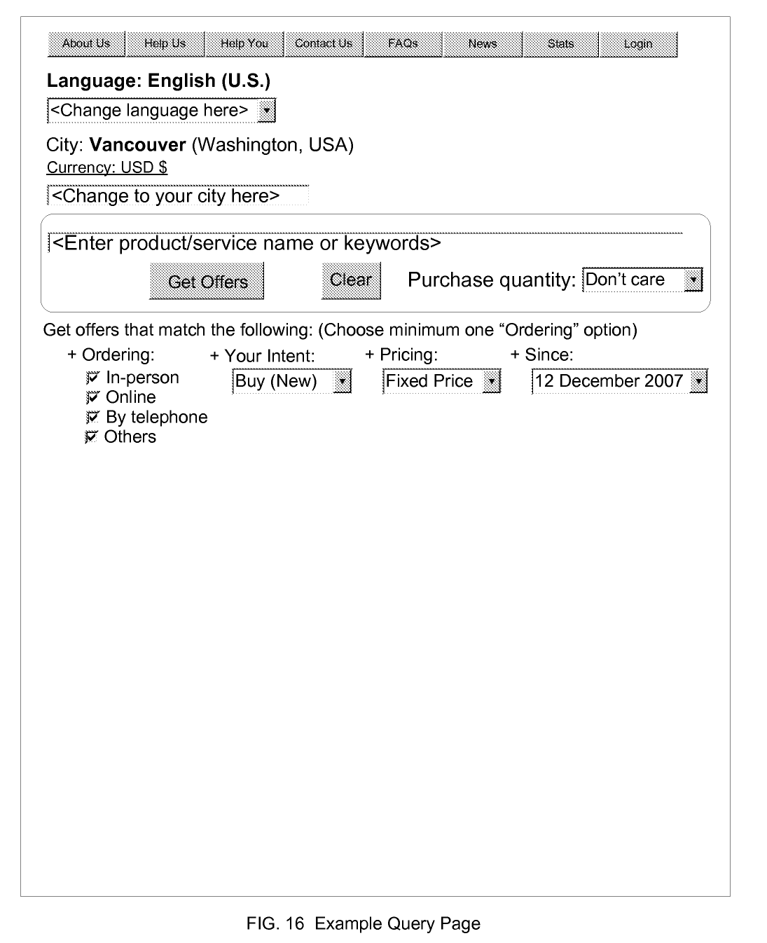

FIG. 15 lists the advantages of the present invention over systems and methods of the status quo.

For instance, a general search engine certainly lacks the shopping or buying context where many results returned by a search engine are not even about sales of goods and services for a given query for offers in goods and services.

An online classified ads website, while providing a shopping context and delivery location-sensitive listings of offers, forces both the buyer and seller to be concerned with the classification schemes adopted by the website. And a typical online classified ads website is concerned with offers for local interest only. Yet local people with interest in offers applicable and relevant to their location often cannot locate non-local sellers and providers of these offers (e.g., an offer of prescription contact lenses). Off-the-shelf goods available nation-wide are often not advertised on an online classified ads website.

A national or international shopping website often carries offers that incur shipping charges, especially when it does not have an offline retail store presence. They certainly do not permit buyers or end users to freely submit information on past sales and competing offers as equal for consideration as the offers chosen by the administrator of the website. And while a few shopping websites may accept a buyer's location to calculate the exact shipping and tax charges so to arrive at the total cost of ownership, they do so only after the query has been performed and result pages received. In contrast, the advertising and query system and method of the present invention makes available at the indexing time each offer with its specific applicability based on the buyer's location. As such, result pages would already be location sensitized.

A community website for shared shopping interests such as gasoline would allow a user to choose a location of interest, and then list for that location the specific outlets that sell the item of interest. For submission, the website would allow a user to enter a specific outlet location and its price of the item. Such a website would not be able to accept intelligence information about other goods and services since they are restricted to a pre-defined good or service type. And given its focus on a single item type and one location at a time, the website does not employ per-offer indexing. The search capability, if any, on the website would be simply searching the pages of a website as a whole, not treating each offer as an individual page of information on that offer for contextual integrity.

A website provided by a research and sales firm specialized in a particular market (e.g., housing, cruel oil, etc.) could provide information on past prices as reference in addition to listing the current offers. However, such a website is not designed to track and advertise offers of goods and services that could differ so much in prices for the same substitutable item available from different vendors.

### Sample Embodiment and Its Operation

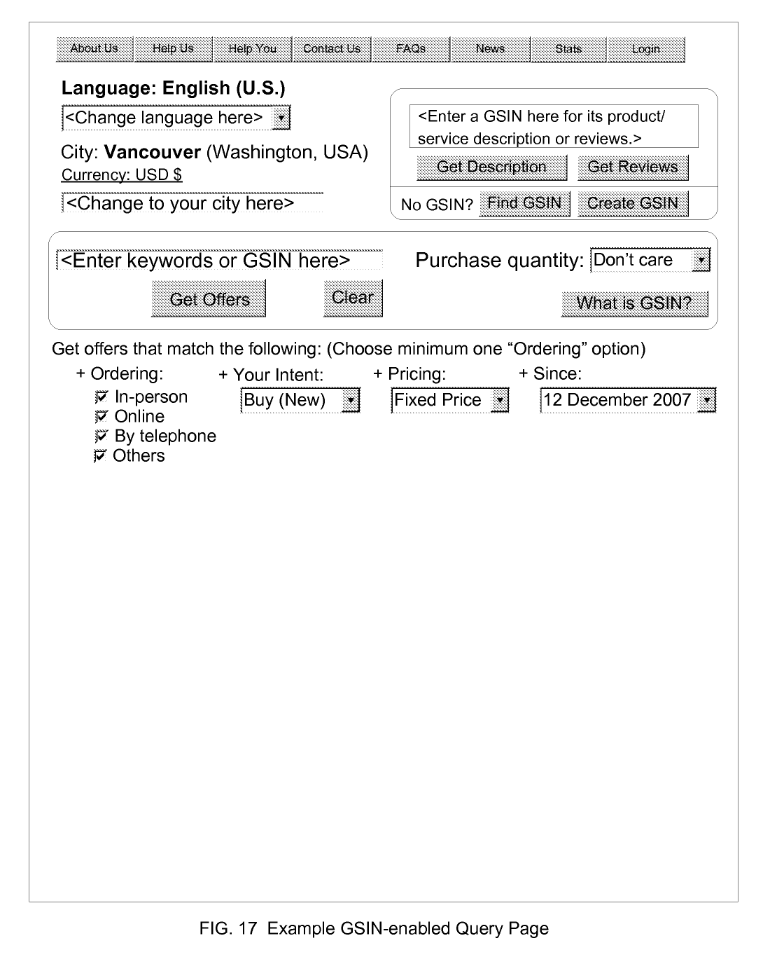

A sample embodiment would be a search engine that accepts entries of past sales and of current and future offers for heterogeneous goods and services as well as queries for these entries. FIG. 16 “Example Query Page” provides an example query page of the sample embodiment for the present invention. With such a system, consumers may share pricing and availability information on items they buy on a regular basis or for those they have researched on. Volunteers may be keen to perform regular surveys of popular consumer items from well-known sellers so to provide a price reference and price check. Vendors would like to find out the competing prices of the items they provide. They could also submit competing offers to attract consumers to their business, especially so for the lesser known vendors.

As shown in FIG. 16, the chosen language for query is U.S. English, which may be changed to other languages as desired by a user. The user also provides the location of interest (i.e., where the sales took place or the offers applicable to), which may also be changed. The chosen location also implicates the applicable currency in use. The ways to order the product or service are also explicitly enumerated. The default intent of a user is to buy (either a product that is new, or a service). He can also change it to the intent to buy used or to rent (not applicable to services). Different ways of pricing other than fixed price may also be specified and selected, such as auction. The user may specify a date before which offers are not considered for his query.

To specify the product or service of interest, the user would enter its name or the keywords about it. Optionally he may also specify the purchase quantity. The purchase quantity parameter helps the search engine to rank the results of the query. Each entry in a result page contains a per-unit price for the item in question. For bulk-quantity purchases where per-unit prices are usually lower than those of individual unit purchases, the former would be ranked higher than latter if the results are to be ranked by the per-unit price and the purchase quantity for the query is not specified. On the other hand, if the user specifically wants only one unit of the item and specifies so in the purchase quantity field, all entries for the sales of one unit of the item would be ranked higher in the results than those with different purchase quantities, while the individual entries in the former would be ranked in accordance to their per-unit prices. Larger the difference between the desired purchase quantity and the applicable purchase quantity of an offer, lower is the ranking of the offers with that applicable purchase quantity as a group. For example, if the desired quantity is three, then offers with the purchase quantity of three as a group have the highest ranking, followed by offers with the purchase quantity of either two or four, followed by offers with quantity of either one or five, followed by those with quantity of six, and so on.

Furthermore, while the search engine supports offers of different pricing schemes and consumers of different intents (e.g., for products buy new, buy old or rent), the results would be applicable only to the combination of one intent type and one pricing scheme. This is not a limitation of the sample embodiment, but rather of design intent to make the system more user friendly to end users.

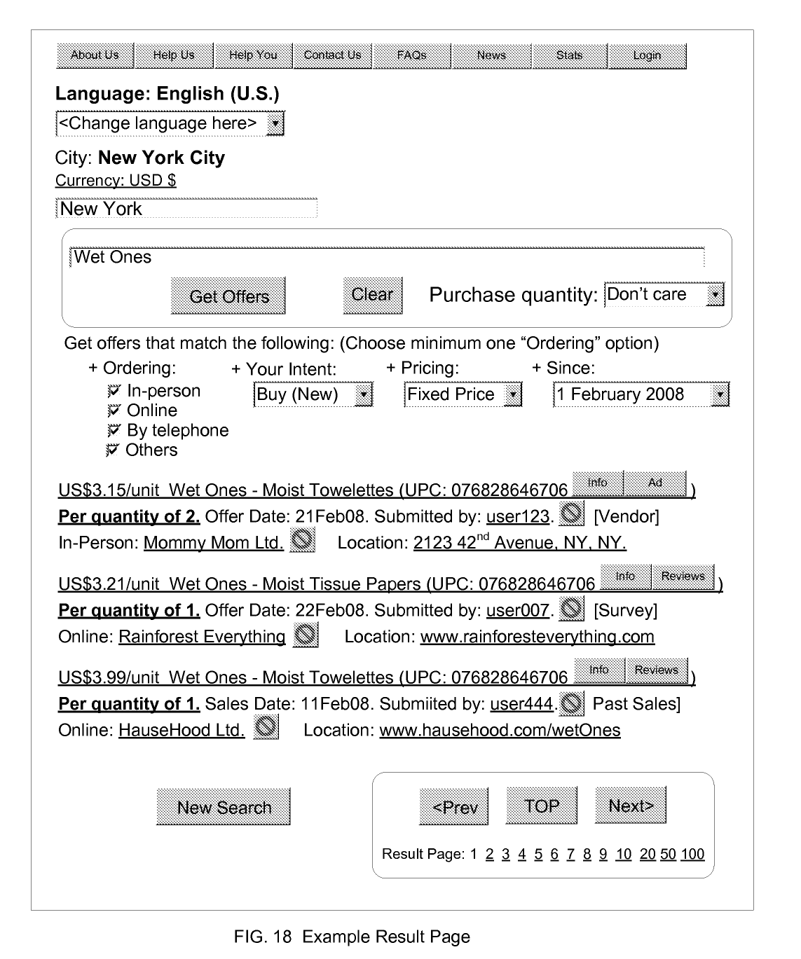

FIG. 17 “Example GSIN-enabled Query Page” introduces the use of GSIN (Goods and Services Identification Number), a scheme introduced for this present invention. A GSIN code is a string of printable characters that may be represented by any single decipherable entity (such as a string of vertical bars like those of a UPC code, a model number such as a string of characters, and a diagram like QR Code) that identifies a product or service. A single product or service may have more than one GSIN codes such as a SKU, UPC, and a manufacturer's part number. And two different products or services may potentially have the same GSIN code (that is, a secondary GSIN) where disambiguation may be easily performed. (For example, the user who enters the ambiguous GSIN code may be given the list of goods and services that have the same code and he would be asked to explicitly choose one among them.)

A primary GSIN (e.g., a UPC) is one assigned exclusively to a product or service for global recognition where ambiguity is meant to avoid. A secondary GSIN (e.g., a manufacturer's own part number) is one assigned to a product or service by an enterprise where others may use the same GSIN code for a different product or service. The “What is GSIN?” button on the query panel in FIG. 17 would explain what GSIN is, and may be in a similar way to how GSIN is explained here.

If it is desirable to identify a specific offer entry for optimal referral and retrieval, then a possible scheme to creating a unique ID for the entry would be the concatenation of the entry date and time, the user ID of the submitter, and a primary GSIN for the product or service of the offer. That means all entries by a user are serialized with respect to the time-stamping so to ensure no two entries by the user would have the same entry date and time, even though multiple entries from the user may have been submitted simultaneously in real time.

To identify the product or service, the user is encouraged to use GSIN codes, in addition to the usual names and keywords-based input. The advantage of using GSIN codes is that further automation of user input may be achieved, such as the use of a mobile offer reporter as described earlier. Such a mobile offer reporter may facilitate the entry of past sales and current and future offers into the search engine. Or a device equipped with a UPC scanner may obtain a UPC code for a product of interest and then interact on behalf of its user with the search engine to perform a query about the product identified by the UPC code.

There is also a GSIN-centric panel in FIG. 17, where a user may provide a GSIN in exchange for description for the product or service (i.e., the “Get Description” button) identified by the GSIN, and the reviews and comments (i.e., the “Get Reviews” button) on the product or service so identified. In addition, the panel provides an entry point for finding existing GSIN codes (i.e., the “Find GSIN” button) and for creating ones (i.e., the “Create GSIN” button) when the user does not know a GSIN code of an existing product or service and when he wants to create a GSIN code for an existing product or service, respectively. For example, a user may create a GSIN code for a representative “Yeung Chow Fried Rice” (a Chinese rice dish). This and other user-defined GSIN codes for this Chinese rice dish are all secondary GSINs. When enough interest warrants a primary GSIN for it, then either one of these secondary GSINs and a system administrator-generated GSIN could be chosen.

Furthermore, the use of GSIN is helpful not only for marketing the appropriate supplementary goods and services to the goods and services of interest identified concisely by GSIN codes, but also for creating a common set of references to a product or service with which comments, reviews and other relevant information (such as the product or service specification, manufacturer's recall, and common FAQs for product usage and maintenance) may be associated.

Since GSIN is linguistically independent, then an expressed interest in a certain good or service may also be specified in a linguistically independent way. Ambiguity would be minimized and standard language translations for the same product or service may readily be available to a multilingual website for display, or even for negotiation and transaction. Moreover, the use of GSIN enables the accurate collection of statistics on goods and services that are of most interest to consumers through their queries. This information allows the insight into the demand of a certain good or service where there is no matching information or supply. Hence a system administrator such as that for this embodiment would collect product or service information (such as specification, reviews, comments, etc.) for a most sought-after product or service for which there is little information. An entrepreneur may also be able to bridge the gap in the supply for a most sought-after product or service for which there are few offers.

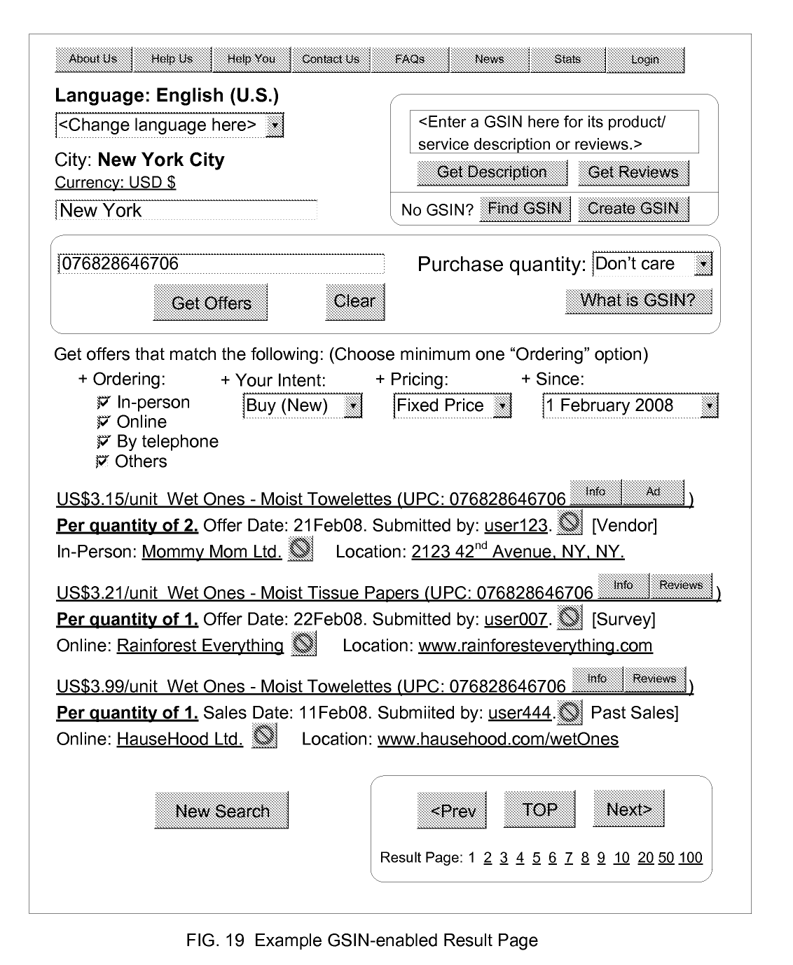

FIG. 18 “Example Result Page” shows an example result page corresponding to the example query page of FIG. 16. The query specified in FIG. 18 indicates that the user wants to locate offers for a product or service whose keywords are “Wet” and “Ones”. The location of interest for delivery is New York City (and hence the currency U.S. dollars). He does not care to specify the purchase quantity that he is interested in, and therefore the purchase quantities required by the offers would not play part in the ranking of the results, even though they may be shown in their entry excerpts on the result pages. The user is also interested in offers with any ordering option and of the “fixed price” pricing method. Furthermore, the user is looking for offers that sell the product in new condition (if the query using the keywords does result in offers to sell a product) and for offers that were valid as of Feb. 1, 2008 or later.

FIG. 18 indicates there are over 100 result pages, with the first page containing three offer excerpts. The excerpts are ranked by the per-unit price, lowest first. The whole first line of an excerpt is hyperlinked. User's selection of this hyperlink results in a new or next page showing the full description of the offer. The clicking of the “Info” button by the user would bring up an offer summary display page serving as a sub-page of the existing result page. A sub-page is one which would disappear without affecting the container page (i.e., the existing result page) and in so doing transfer the context back to the container page, when the cursor of the user's pointing device leaves the sub-page's perimeters. Clicking the “Ad” button would bring up the ad for the good or service provided by the offer. (Clicking the “Reviews” button would bring up the reviews pertaining to the good or service provided by the offer.)

The second line of the offer excerpt starts with the hyperlinked purchase quantity requirement of the offer. Selection of the hyperlink would bring up a page showing specifically the cost breakdown of the whole offer. The “Offer Date” field indicates the effective date of the offer or its equivalent. The “Submitted by” field indicates the user ID of the user who submitted the entry and the user ID is hyperlinked. Selection of this hyperlink would bring up a page showing the information about the user such as his trustworthy rating. The button with the travel sign logo of “do not enter” allows the user to filter out all entries submitted by the corresponding entry submitter within the original set of result pages. The user can continue filter out unwanted entries per submitter by clicking the “do not enter” button associated with each submitter until he clicks on the “New Search” button. A new search would clear up the results but keep the query input in place. Then the user can conduct a new search. The “[Vendor]” marker shows that the user is a vendor. (The “Survey” marker shows that the user is a volunteer who is neither a vendor nor a buyer. The “Past Sales” marker shows that the user is a buyer who purchased the product or service specified in the offer.)

The third line of the offer excerpt indicates the ordering option by which the offer is available or the sale was made. The hyperlinked vendor's name provides the name of the vendor and selection of the hyperlink would bring up a page of information on the vendor such as his ratings by its customers. The button with the travel sign logo of “do not enter” allows the user to filter out all entries of the seller or provider within the original set of result pages. The user can continue filter out unwanted entries per seller or provider by clicking the “do not enter” button associated with each seller or provider until he clicks on the “New Search” button. Then the user can conduct a new search (using the old query keywords or new ones). The hyperlinked location provides the address (whether online or offline) specifies the location or information (e.g., phone number if the ordering option is by phone) with which an order may be made. Selection of this hyperlink would further the ordering process. For example, a hyperlink of street address would provide a map showing where the store is, and with the user's input of a reference location, the direction would be provided for getting from the reference location to the store. A hyperlink of an online URL would bring the user to the website. A hyperlink of a phone number would have the user's machine to dial that phone number, if the machine supports this initiation.

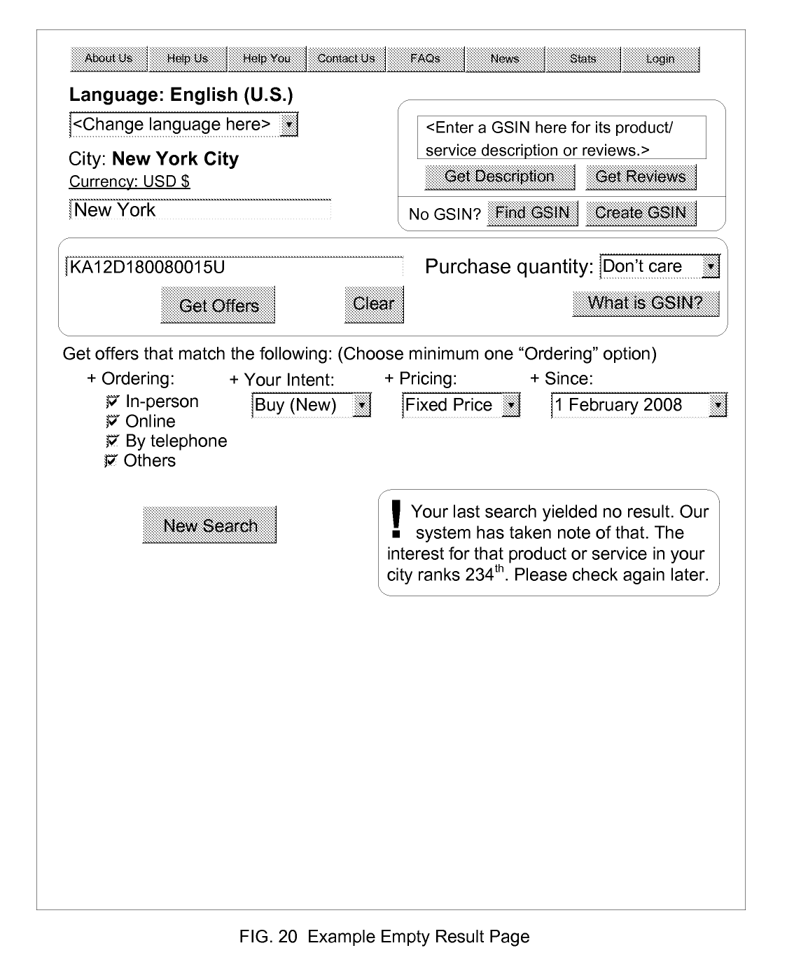

FIG. 19 “Example GSIN-enabled Result Page” shows the same result page as FIG. 18, except the GSIN-specific features as shown in FIG. 17, and the query input is a UPC code instead of typographical keywords. The GSIN code so entered, unlike keywords-based input, would solve many ambiguities that keywords-based input may incur, such as whether the item of interest is a product or a service, or whether it is an accessory of the product or service associated with the keywords.

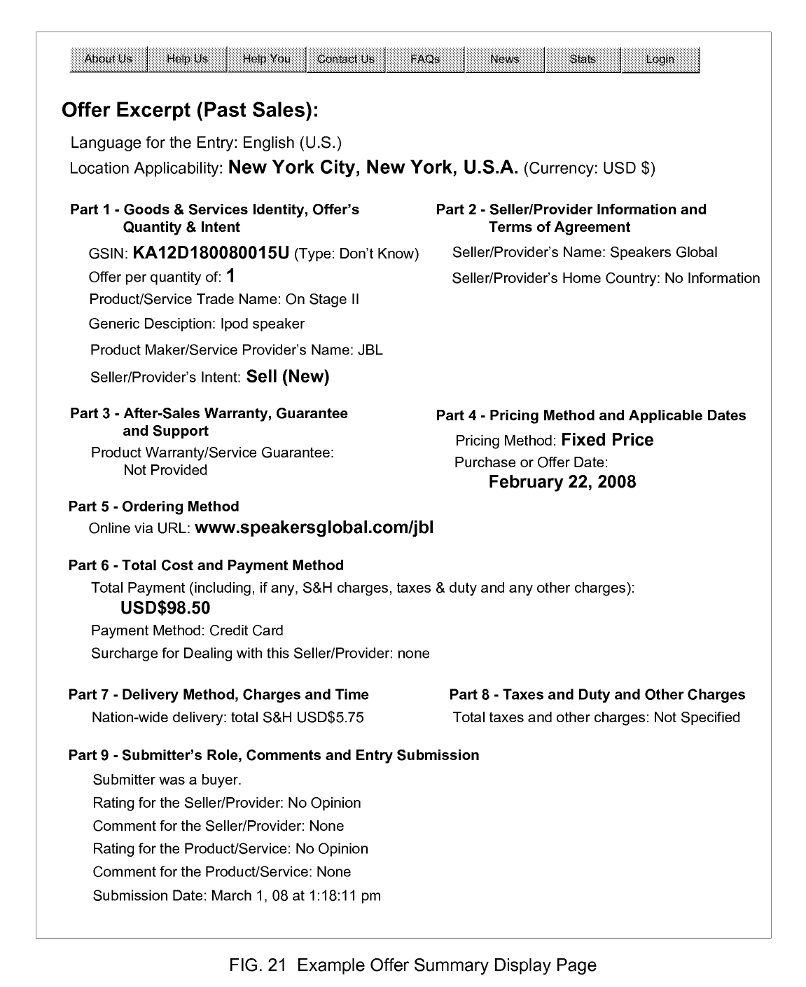

FIG. 20 “Example Empty Result Page” shows an example result page for a GSIN code (a manufacturer's model number) for which no offer is available for the query. In addition to an empty result page, the search engine also provides a remark to the user that the system has taken note of the empty result and ranked the item based on the amount of interest for the item expressed through the number of queries for it.

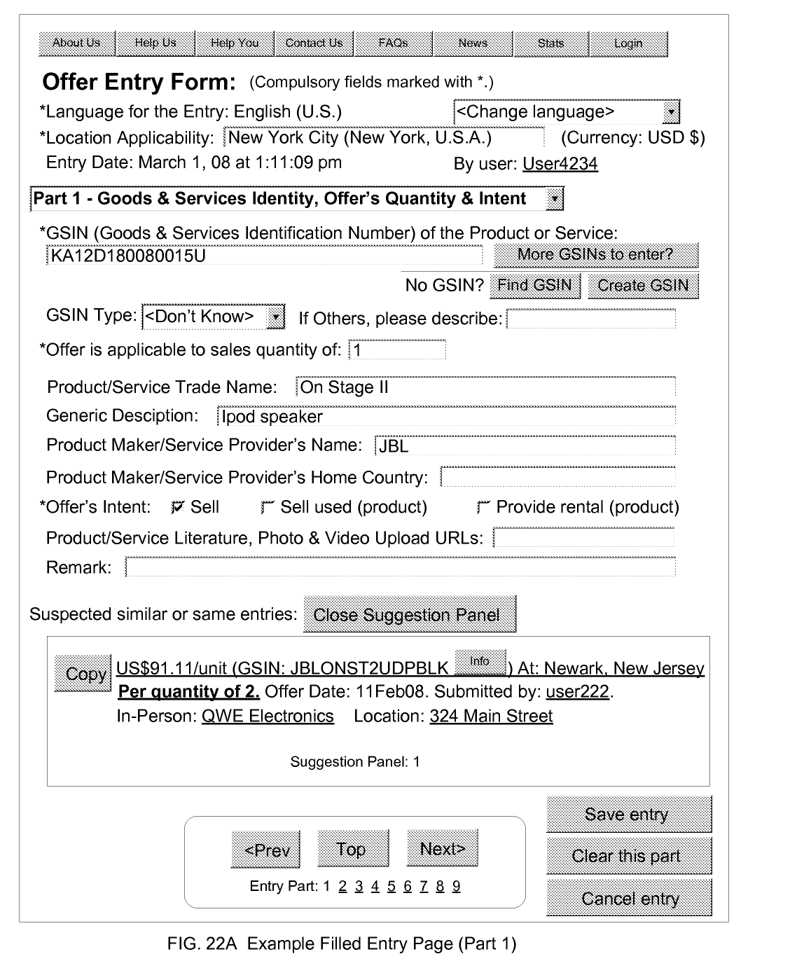

FIG. 21 “Example Offer Summary Display Page” shows an example offer summary display page that would result upon clicking on the “Info” button on an offer excerpt. There are nine parts to an offer specification, and the Offer Summary Display Page so illustrated contains a summary of each part. Although there seem to be a lot of information about an offer even for an offer summary, only eight pieces of information are required for all offers. They are highlighted by boldfacing and bigger font sizes. They are: location applicability, at least one GSIN code, purchase quantity requirement, seller or provider's intent, pricing method, purchase or offer date, ordering method and total payment. And many of them may assume either a system-wide or user-specific default values such as the user's location as the location applicability, purchase quantity (of one), seller or provider's intent (to sell new), pricing method (of fixed prices), and the purchase or offer date (assuming the date of entry). Hence in most cases a user needs only to provide a GSIN code, the ordering method and the total payment for an offer entry. On the other hand, helper software similar to those helping users to configure a system or fill out a convoluted multi-page form (e.g., software for helping taxpayers to fill out tax returns) may be constructed and employed to assist a user to complete a comprehensive entry form for an offer.

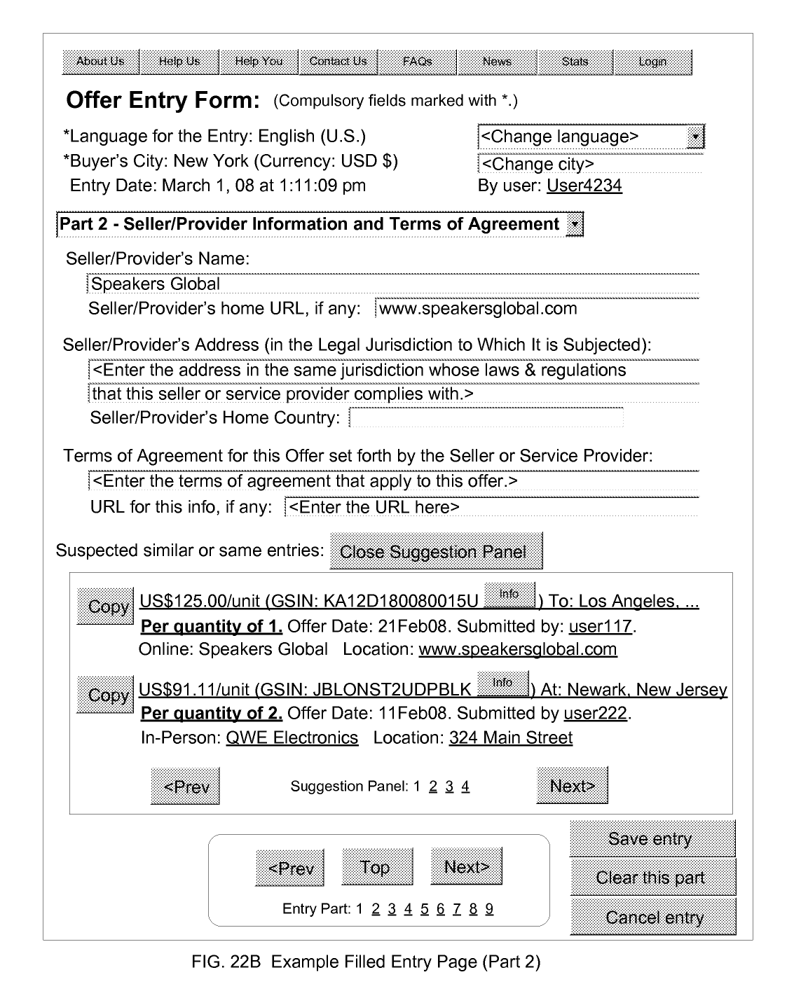

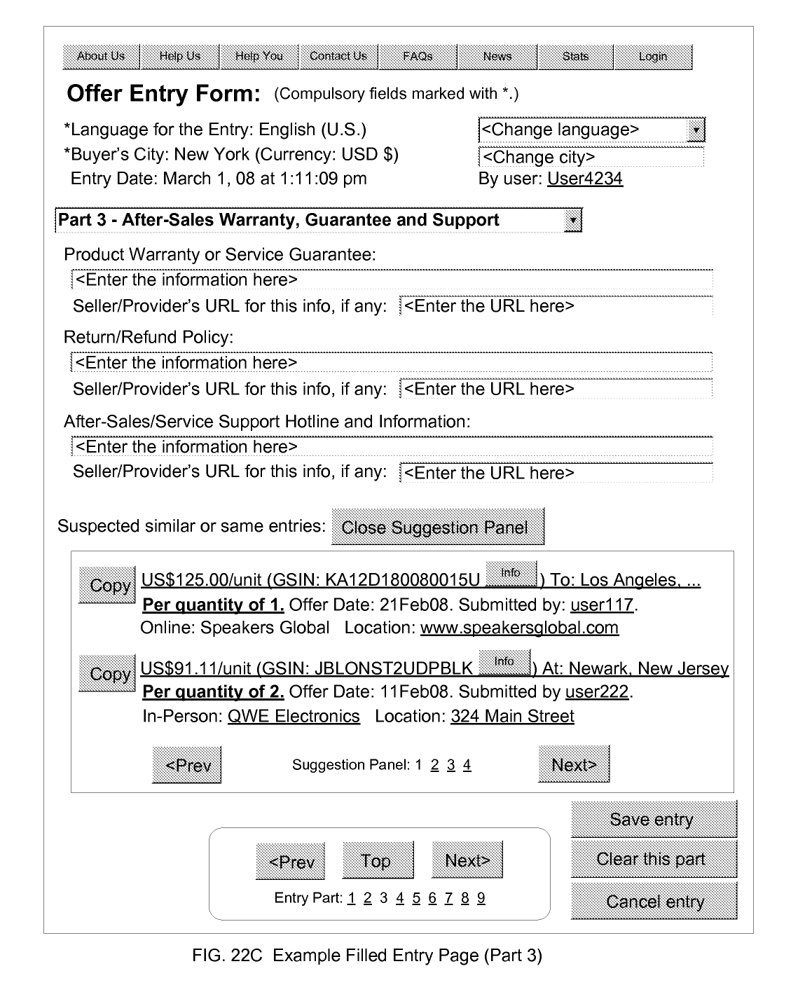

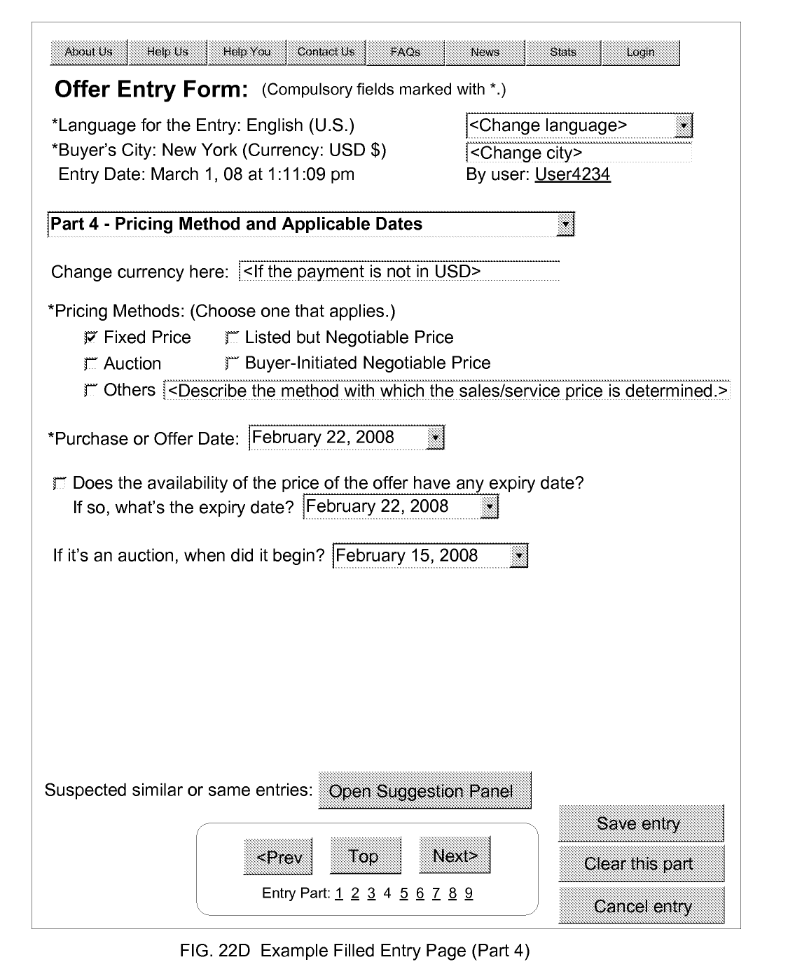

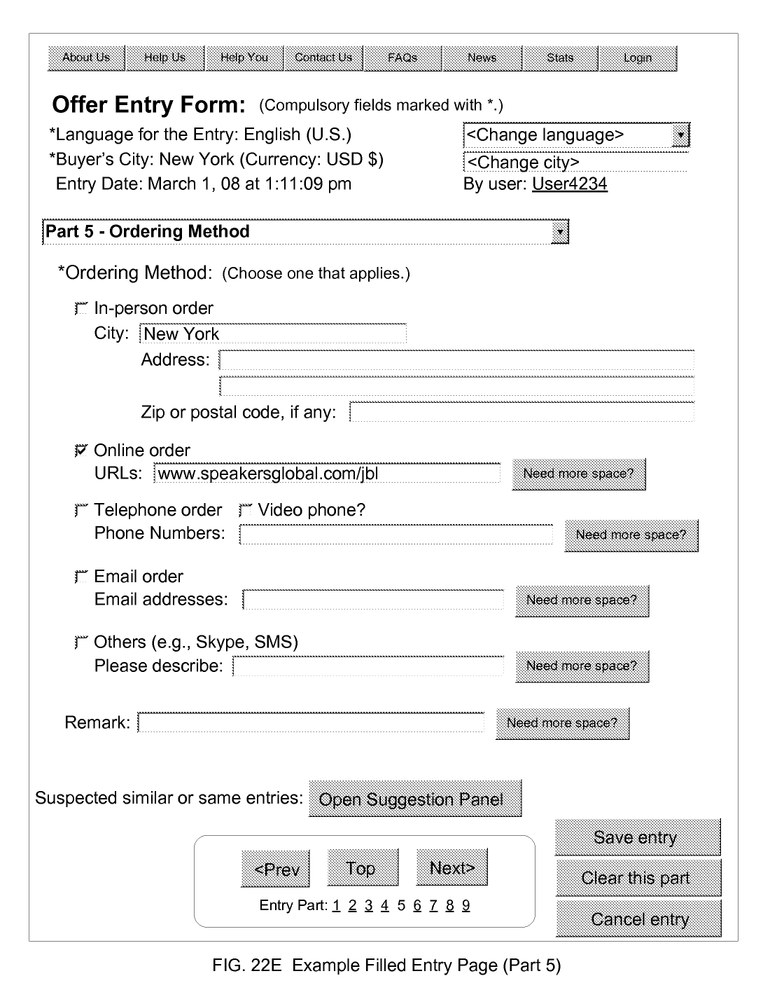

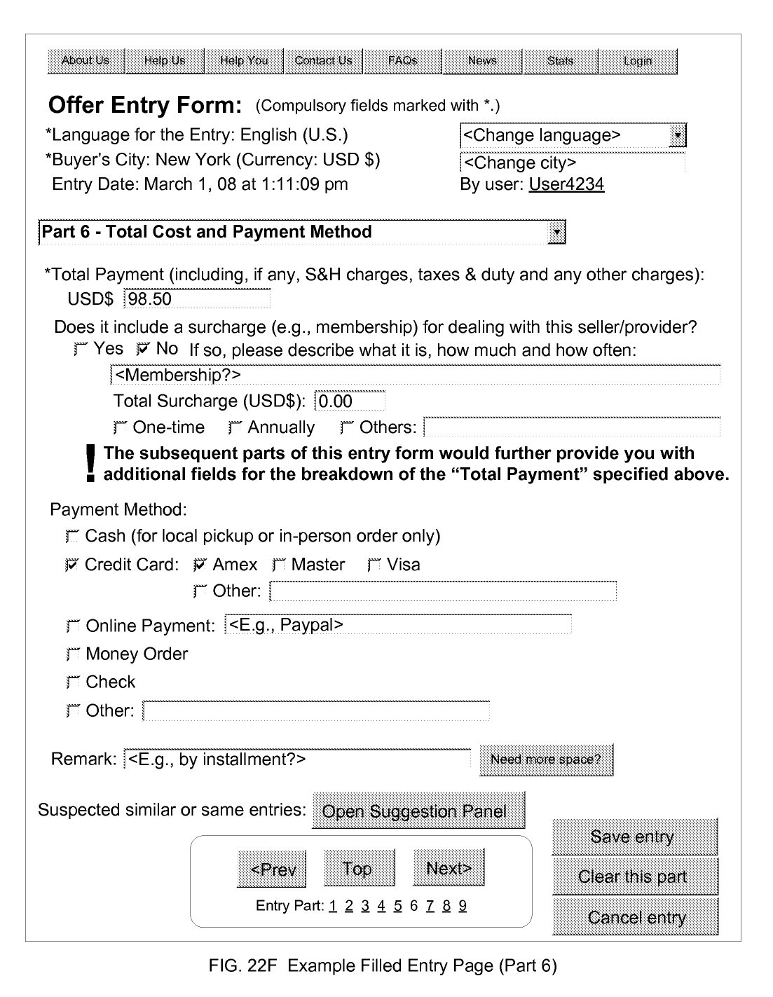

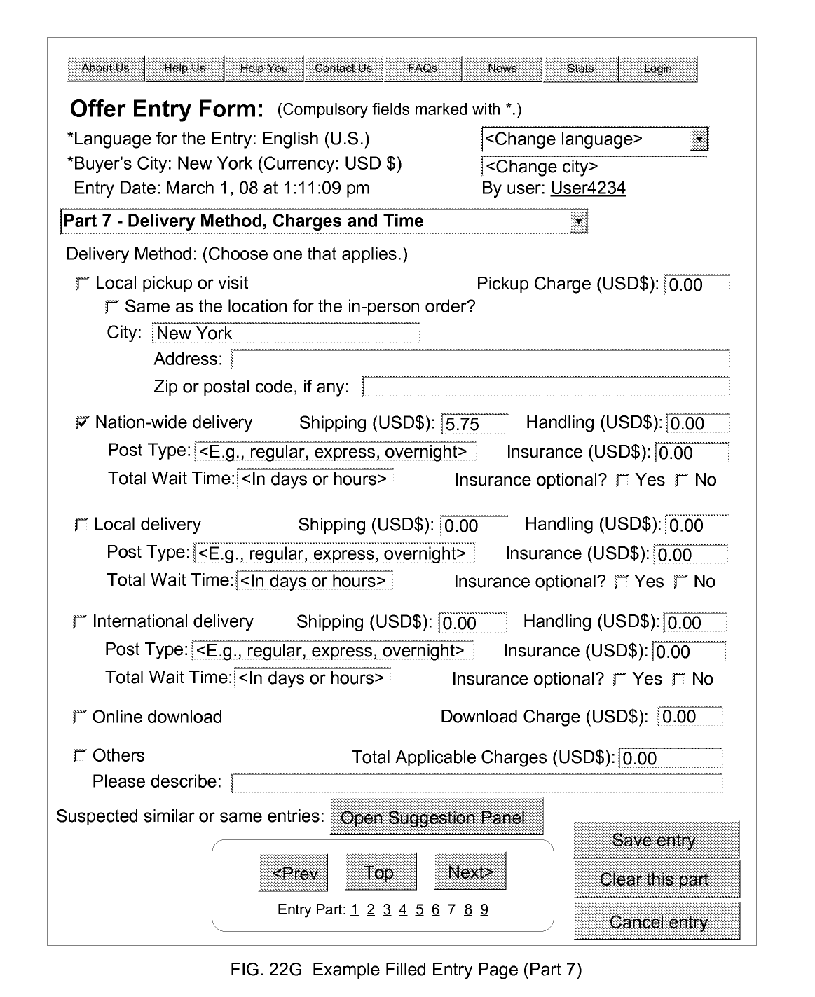

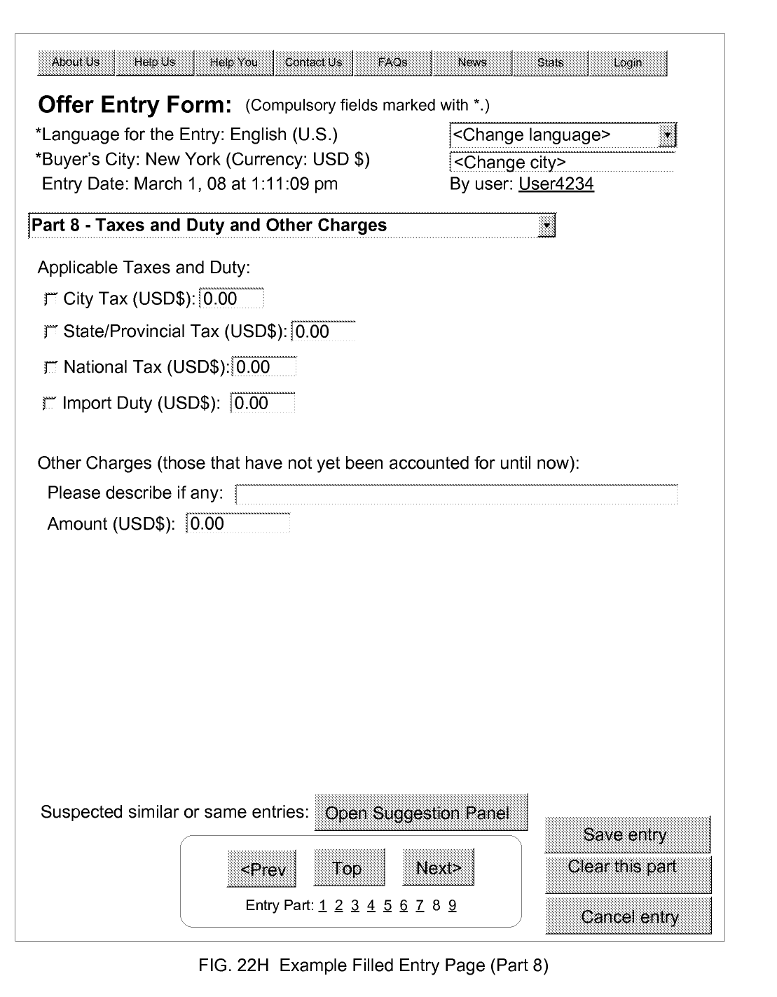

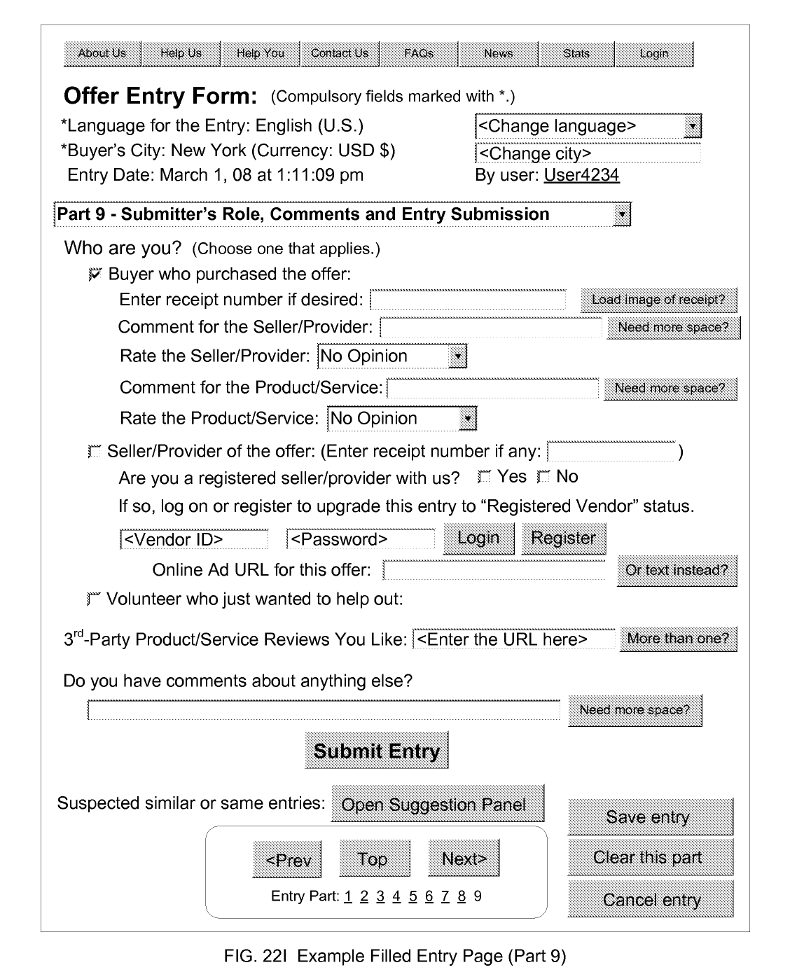

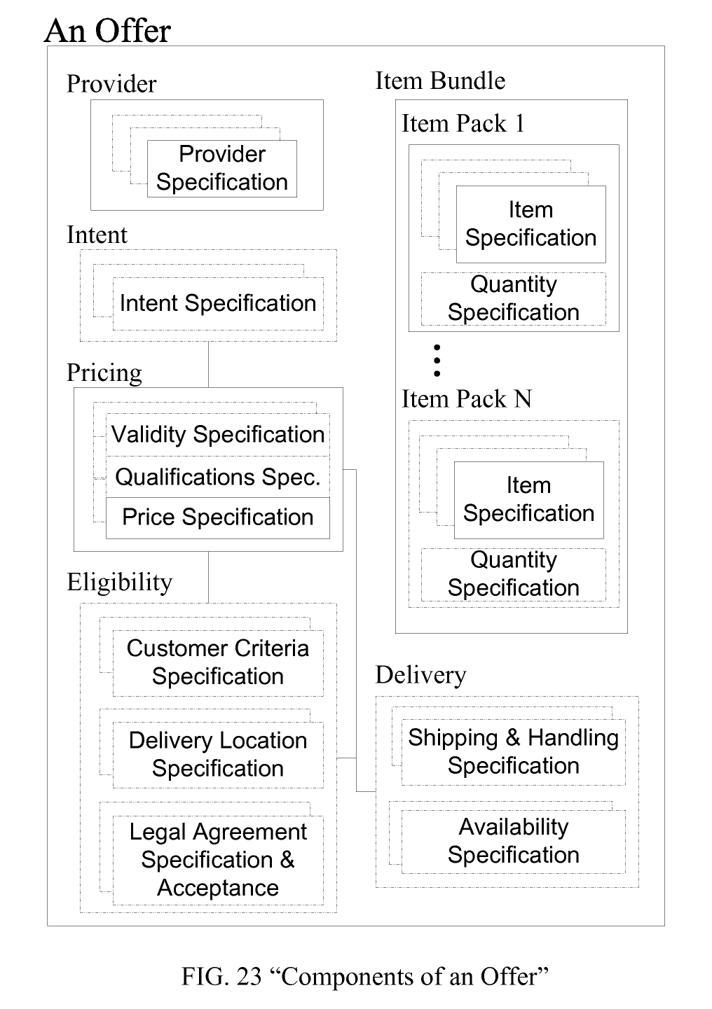

FIG. 22A “Example Filled Entry Page (Part 1)” shows Part 1 of an example entry form filled for an offer of a speaker for a MP3 player. (Like other parts of the example entry form, most of the fields are self-explanatory. Specific explanation for a field is provided for either clarity or feature explanation.)

Since an item (whether a service or product) may be associated with multiple GSIN codes, the user may click the “More GSINs to enter?” button to start entering more GSINs, and optionally specify for each GSIN the GSIN type. If there is no GSIN for the item, then the user can try locating one using the “Find GSIN” button or creating one using the “Create GSIN” button.

The optional “GSIN Type” field allows the user to tell the system the type of the GSIN code so entered, such as a UPC, ISBN, model number, part number and so on. All these types are pre-defined and are accessible through a pull-down menu. The user may also specify a GSIN type if it is not available on the list.

On the entry form there is also a suggestion panel. The panel would list existing offer entries (or their excerpts) that are suspected to be similar or the same as the one being entered by the user. The “Close Suggestion Panel” button allows the user to dismiss the suggestion.

FIG. 22B “Example Filled Entry Page (Part 2)” shows Part 2 of the example entry form filled for the same offer. As the user enters more information, such as the seller or provider's name, the Suggestion Panel retrieves more and more existing entries suspected for being similar or the same as the offer being entered. Note that for each suspected entry, there is a “Copy” button, with which the user can copy the information of the suspected entry onto the fields of the entry that he is working on.

FIG. 22C “Example Filled Entry Page (Part 3)” shows Part 3 of the example entry form filled for the same offer. Note that there are three buttons on the lower right corner: “Save entry”, “Clear this part” and “Cancel entry”. “Save entry” is for saving the existing input to the fields of the whole entry, and the user can return to the system later to continue the entry input. “Clear this part” simply clears up all the fields of the current part while leaving other parts untouched. “Cancel entry” would abort the whole entry.

FIG. 22D “Example Filled Entry Page (Part 4)” shows Part 4 of the example entry form filled for the same offer. Here the user has chosen to dismiss the Suggestion Panel. (He can re-open the panel using the “Open Suggestion Panel” button.) Part 4 is about the actual currency, the pricing method and the applicable dates of the offer. Here the user may change the currency if the currency required by the offer is not the one associated with the applicable location (e.g., paying for an offer from an overseas seller requiring a difference currency). For the offer excerpt in a result page, the foreign currency amount for the per-unit price would be converted to the currency of the applicable location for consistency. Note that a consumer using a credit card to pay for an offer requiring a foreign currency would still have the amount charged to his credit card in his local currency. Hence for the most part a consumer submitting an offer of past sales needs not be concerned with this currency situation.

The “Listed but Negotiable Price” pricing method means prices are initially set by the seller or provider but may be rejected by the buyer who may or may not then put forth a new (lower) price. The “Buyer-Initiated Negotiable Price” pricing method means prices are initially set by the buyer but may be rejected by the seller or provider who may or may not then put forth a new (higher) price. Should there be any other kind of pricing methods not yet listed, then the user may describe it on the “Others” field.

FIG. 22E “Example Filled Entry Page (Part 5)” shows Part 5 of the example entry form filled for the same offer. The “Others” field of the Ordering Method allows the specification of ordering options other than those already listed, namely the in-person, online, telephone and email options. Using IP telephony end points such as Skype or messages over wireless networks such as SMS may be specified in the “Others” field. The optional “Remark” field provides additional space to the user to give more information for or qualification to the ordering method that he selects and describes, such as the business hours for the in-person or telephone ordering.

FIG. 22F “Example Filled Entry Page (Part 6)” shows Part 6 of the example entry form filled for the same offer. Part 6 is about the total cost of the offer to a buyer and the payment method available or used for the payment of the offer. The total payment field captures the total cost paid to acquire the good or service in question. The question “Does it include a surcharge?” aims to uncover a part of the total cost, if any, that is not 100% attributable to the acquisition, yet necessary to complete the acquisition. An example of such a cost is membership fees.

FIG. 22G “Example Filled Entry Page (Part 7)” shows Part 7 of the example entry form filled for the same offer. Part 7 is about delivery charges paid for the offer, if any. They should already be included in the total cost of the offer entered in Part 6.

FIG. 22H “Example Filled Entry Page (Part 8)” shows Part 8 of the example entry form filled for the same offer. Part 8 is about tax charges of the offer as well as other charges not yet accounted for, if any. They should already be included in the total cost of the offer entered in Part 8.

Note that since the entry of the delivery, tax, and the other charges are all optional, the total cost in Part 6 may not be the same as the listed price of the offer even if all those fields are empty. For this particular embodiment, this ambiguity is acceptable since it prefers the actual total cost over just the listed price of an offer and the lesser demand on the user in providing the information of an offer than that of making those fields compulsory for entry.

FIG. 22I “Example Filled Entry Page (Part 9)” shows Part 9 of the example entry form filled for the same offer. Part 9 is about the role of the submitter, his comments and the final step in the submission of the offer entry. The receipt number field allows the user to provide a receipt number or even an image of the receipt to identify the actual purchase of the offer so to further vouch for the authenticity of the past sales. The comment and rating for the seller or provider specified here would be part of a collective list of comments, reviews and ratings for the seller or provider. A summary rating would also be derived from these individual ratings. The list and the summary rating would be presented to the user when the user clicks on the hyperlinked name of the seller or provider on the offer excerpt or the offer report. Similarly, the comment, rating and the 3rd-party reviews for the product or service specified here would be part of the list of comments, reviews and ratings as well as the summary rating for the product or service. The list and the summary would be presented to the user when the user clicks on the hyperlinked description of the offer on the excerpt or the report.

As for a vendor (i.e., seller or provider) who is the submitter, he may log on or register with the system as a registered vendor, so that all his entries would have the authenticity of having come from the vendor. He can also specify an online ad URL for the offer or a simple text message. For example, the “Ad” button on an offer excerpt would invoke such an URL or text message for the corresponding offer when clicked upon by a user.

The example embodiment as illustrated above provides a comprehensive search engine system equipped with the present invention. Of course, many variations of this embodiment are possible. For example, a vendor would wish to use a single entry form to specify a level of location applicability higher than that of city, multiple ordering methods, and payment methods all of which do not result in a different price, as well as multiple pricing methods and delivery options that would usually result in different prices. The invention “Hierarchically Constructed and Arithmetically Generated Pages for Matching and Indexing” described above would be able to provide such a single entry form. The generated pages from the single entry form would individually become a city-specific, total cost-ready offer entry for this example embodiment.

Of course, many additional features may be added to the example embodiment, such as providing a history of entries submitted by a user specifically for his re-use, and tracking a user's expenses along with periodic expenditure summaries based on his entries. These and other possible features are not enhancements to the present invention; rather they are features that make easier the use and operation of the example embodiment for its users, and use the example embodiment as a platform to launch other services.

In addition, the example embodiment specified above may also be modified so that the lowest level of location applicability is extended to the street level, where the delivery location or location reference is a mailing address or a geographical point like a point of coordinates provided by a GPS device. The search engine system with this modification could then ask a user to also specify a perimeter or distance in relation to the location reference, in addition to other query parameters. The search engine would then be able to return a list of offer entries from sellers and providers within the specified perimeter or distance. This feature has the effect of creating an advanced directory service and map for a virtual open mall where any seller or vendor can participate. For example, a user equipped with a mobile device having location determination capability (e.g., GPS) may scan or otherwise obtain the UPC code of a product of interest to him, and then sends through the mobile phone a query using, among other parameters, the UPC code and his current location (as determined by the location determination function of the mobile device) to the search engine system. Then the system would return the individual addresses or geographical coordinates to the mobile phone which shows on its display the locations of the sellers or providers with matching offers as well as their prices.

Furthermore, a matching system for complementary offers may also be realized (e.g., via the “Context-Priority Publication and Matching Scheme for Online Offers”, described later). Specifically, when a consumer also provides an offer to buy in addition to a vendor's offers to sell a product and service, the present invention may be adapted to facilitate matching and trading in efficiency comparable to that of a securities exchange for trading stocks and financial goods alike. In addition to a query to buy, there may also be an offer to buy. As such, an offer to buy may then be matched to an offer to sell for the same item of interest. In fact, the main semantic difference between a query to buy and an offer to buy is that the former is perceived transitory while the latter is steady in validity until withdrawn. As such, automated matching and trading between complementary offers using an example embodiment of the “Context-Priority Publication and Matching Scheme for Online Offers” may readily be achieved.

One who is skilled in the art would readily implement not only the sample embodiment and its variations as described above, but also other embodiments in accordance to the specification of the present invention. In fact, he or the team would not need to build everything for scratch. Existing functional components are available if they employ them together with additional development. For example, an open-source, deployment ready search engine subsystem called “Solr” along with its complementary components may be adapted to provide most of the functions of the Offer Index Server illustrated in FIG. 14.

### A2. Embodiment for Open Mall

Another embodiment of the present invention for solving the Penn effect is described below. One embodiment of the present invention provides for an open mall as described below. A typical mall is made up of a confined space (open roof or otherwise) and individual retail shops occupying the space. A shopping directory is usually provided to facilitate the identification of the name, category and location of these retail shops. The present invention provides a scheme whereby the perimeters of a mall are defined by conceptual boundaries such as geopolitical boundaries (e.g., a city, a province, and a country). Any product or service provider located within these boundaries may participate as a retailer in the mall. These local product and service providers, should they have points of presence (e.g., a retail outlet), would be able to provide their addresses along with other relevant contact information for prospective customers. They may further be classified or otherwise grouped into different categories of products and services. For product and service providers that wish to participate in the mall but do not have points of presence within the boundaries, they would provide delivery for the products and services that they offer. Of course, local product and providers with points of presence may also provide such delivery. Product and service providers located outside the boundaries who want to participate in the mall would provide information on shipping and handling charges, if any, specific to prospective customers within the boundaries.

A shopping directory for the mall is an online map where at the minimum the locations of the participating service and product providers (i.e., those with points of presence within the mall) are marked. A consumer using a mobile or portable device would be able to locate such retailers in relation to a reference location, such as his current location in the open mall. In addition, he may also perform queries using criteria such as retailer name, product and service name, product and service category and classification, prices, and so on. Local retailers with matching product and service offers would be listed and ranked in accordance to the priorities of query criteria, implied or otherwise. The map would show the location of the top-most entry in the result list. Locations of other local retailers with matching offers would also be shown on the map should they happen to be within the vicinity of the area shown in the map. Salient information (e.g., those matching query criteria) would also be displayed, either directly on the corresponding locations of the map or on an area adjacent to the map display, or indirectly, e.g., through some hyperlinks or external references. The consumer may select any location marked on the map for further query, such as its address and direction as well as information on the offer of interest. When the consumer selects another entry in the result list, the map would change to show the location of the local retailer corresponding to the chosen entry. Again, locations of other local retailers with matching offers would also be shown on the map should they happen to be within the vicinity of the area shown in the map. The result list is always available for use to the consumer until a new query is executed.

For product and service-oriented queries, matching offers from retailers that do not have points of presence within the boundaries of the open mall would be reported to the consumer as outside offers if the consumer chooses to consider them. These outside offers would be part of the overall result list (i.e., including offers from the local retailers). Each outside offer is explicitly denoted for its lack of points of presence in the open mall. When the consumer selects an entry of outside offer from a result list, Salient information (e.g., those matching query criteria) would be displayed without a map. The consumer may continue for further query, such as its delivery time and charges as well as information on the offer of interest.

To participate in the mall either as a local or an outside retailer, a product or service provider would submit their offers and item availability notices (IANs) to a server responsible for collecting and managing offers. Such an advertisements management server would in turn make the offers available to a server responsible for organizing and publishing them as an online shopping guide as described above. Such an advertisements publication server would interact with portable and mobile devices through which consumers perform queries and lookup on retailers and products and services of interest.

An offer comprises a retailer name, ordering information (such as point-of-presence addresses, online addresses and phone numbers), product or service name, quantity and price. The so-called Item Availability Notices (IANs) comprises what an offer contains but without the product or service pricing information (i.e., not as a proposal ready to be accepted by a consumer).

To provide an embodiment of the open mall as described herein, the Mobile Offer Reporter and Remote Control for Offer Advertising and Transaction (disclosed elsewhere) may be employed. The devices and appliances embodying the reporter and remote control would be adapted to support submission of IANs. An advertisements management server for an open mall would be the so-called pre-assigned server that would receive and process these submissions. The method, process and system of per-offer submission, indexing, publication and search as described in the Peer-to-Peer Per-Offer Advertising for Goods and Services (disclosed elsewhere) would support IANs in addition to offers, and be employed by advertisements management servers and advertisements publication servers. Of course, all other technologies disclosed herein may also be adopted as part of the services provided by an open mall, such as online negotiation and context-priority publication and matching scheme for online offers (and IANs).

Local product and service providers that register the addresses of their points of presence and outside ones that register the ordering information with the advertisements management server for an open mall are called registered retailers. Upon authentication of these retailers, through username and password/passphrase and/or identification of their devices and appliances, their submission of offers and IANs does not need to include addresses or ordering information. The registered addresses and ordering information may be verified administratively or through other means before the advertisements management server would accept these submissions from registered retailers. Of course, unregistered retailers would be able to submit their offers and IANs to the advertisements management server without such prior registration and potential verification. The advertisements publication server would make distinction between registered retailers and unregistered retailers when presenting information for, of and from them.

From the query and transaction side, a consumer would use a portable or mobile device to navigate the map of the open mall. The map, its constituent data and applications, may be pre-loaded onto the device, or dynamically retrieved to the device over a network connection (preferably wireless), or a combination thereof. In addition, the consumer would be able to perform query and lookup on the device for retailers matching their query and lookup criteria. The device would send these query and lookup requests over a network connection (preferably wireless) to an advertisements publication server for the open mall. The server, in addition to publishing offers and IANs, is also responsible for handling these query and lookup requests, and providing responses back to the device where a recipient application would process the responses accordingly. The technologies and know-how to implement such a device (along with the appropriate software) and advertisements publication server (along with deployment) are all available in the art. Nokia™ Map and Google™ Map are examples of applications using such technologies and know-how.

The present invention creates an open mall whose boundaries are not limited by man-made physical confinement. The space factor is not a limitation to the participation of retailers to the open mall, while their trustworthiness (e.g., those with pre-registration of verified address or ordering information vs. those without) is distinguished. Through the use of mobile offer reporter or remote control for offer advertising and transaction, or their equivalent, or through some other means (such as a website) capable of performing the same, a product or service provider would be able to create and manage offers and IANs and have them submitted to an advertisements management server for the open mall. Through its interaction with an advertisements management server, an advertisements publication server would continually keep the shopping map of the open mall up to date for navigation, query and browsing. One skilled in the art would be able to realize the open mall in accordance to the description provided herein.

A specific embodiment of the mobile offer reporter or remote control may be equipped with barcode reading capabilities so that with a simple scan or data capture, the product or service equipped or otherwise associated with the barcode so scanned or captured would be readily be identified and captured into a message comprising the information of a self-sufficient offer. In addition, a user may manually type in a message (such as SMS) via a commonly available general-purpose device (such as a mobile phone) all the required information for such a self-sufficient offer (e.g., a product or service identity or description, price per unit or package, and ordering method) and send it over a communication network (preferably wireless) to a server for processing (e.g., publication, indexing and query). The information may be specified in freeform text or in accordance to a format or a set of pre-defined markups. This represents a method for publishing an offer, comprising identifying or describing a name or identity (e.g., UPC) of a product or service associated with the offer; specifying a price for the product or service, and optionally a quantity or quality associated with the product or service; obtaining seller information or a reference to seller information (e.g., a phone number, a street address or a URL) to order, accept or otherwise inquire about the product or service; transmitting wirelessly to a server the seller information or reference, the price and the optional quantity or quality, and the name or identity, which the server would publish or otherwise process as the whole or a part of the offer. For instance, the server may parse the content of the submission and extract relevant information therein to create an offer entry. The server may handle content specified in free text form or in accordance to a specific format or a set of pre-defined markups.

### A3. Embodiment for Offer Intent and Other Offer Descriptors and Qualifications

Another embodiment of the present invention for solving the Penn effect is described below. According to one embodiment, an electronic offer comprises a means to identify an item of interest per some quantity (usually a default quantity of one), a means to identify a provider intending to supply the item(s), as well as the amount of money the provider requests in return. FIG. 23 “Components of an Offer” illustrates an offer comprising a much more comprehensive set of components in which an entry may be defined. FIG. 23 shows an offer template comprising individual means for identifying or otherwise being used to identify or carry information to identify an item bundle, provider and pricing of an offer, as well as its intent, eligibility and delivery. Each individual means or component is responsible for an area of concern in relation to an offer based on the template. Each area of concern (or concern) or component is substantiated by a plurality of sub-areas of concern (or sub-concerns) and the specifications associated with their respective concerns and the sub-concerns.

For instance, an item bundle is concerned with the items of interest involved in an offer. It identifies or otherwise characterizes these items as well as their quantities. In FIG. 23, an item bundle comprises a plurality of item packs, each of which comprises a plurality of item specifications, with each specification identifying the same specific item or representative item or its equivalent. A specific item means an actual item in existence, such as a product with a unique serial number. A representative item denotes a plurality of items that are considered interchangeable, substitutable, or otherwise equivalent with one another. Multiple item specifications can exist for a single item (whether specific or representative). For instance, an item may be associated with multiple UPCs, each of which may serve as an item specification. On the other hand, a single item specification may support the inclusion of multiple UPCs as part of its content, thereby eliminating the need of one UPC per item specification. Item name or description in different languages may also have one item specification per language. On the other hand, an item specification may be defined in terms of numerical values and alpha-numerical codes that are linguistically neutral. As such, the presentation of these values and codes among different languages does not necessarily result in multiple item specifications. The quantity specification, which is optional as indicated by the dashed perimeter instead of a solid one in FIG. 23, indicates the quantity of such an item as a pack when the item in question is of representative nature. Its default value, i.e., the value to assume when there isn't any present, is usually one. (An embodiment of the present invention may choose different default values.) Each item pack would have its own corresponding quantity specification. Since an item pack may represent an item of interest different from another item of a different item pack in the same item bundle, an offer whose items of interested specified as an item bundle would be able to provide heterogeneous items.

A provider is concerned with the provider of items in an offer. In FIG. 23, a provider comprises a plurality of provider specifications each of which identifies the same or equivalent provider of an offer. A joint provider (i.e., a provider made up of more than one individual entity) should be defined or otherwise specified in a single provider specification. Similar to an item bundle, the same provider known differently in different languages may have one provider specification for each language.

The intent area of concern is where the purpose of an offer may be specified. In addition to the purpose of giving an item bundle in exchange for some amount of money, an offer to buy or rent a certain item for a specific amount of money is equally legitimate. To match complementary offers (e.g., an offer to buy an item and an offer to sell the same item) two intent specifications should be complementary to each other, not identical or equivalent. This is in contrast to the matching of two related offers where a successful match would result when their invariant offer information, e.g., item identity, seller identity and offer intent, are considered identical or equivalent. An offer without an explicit intent specification could mean by default the intent to sell an item bundle.

Pricing is concerned with the establishment of a price of an offer, i.e., the amount as of money, goods or services to be given to the provider or its proxy in exchange for the items specified in an item bundle. Pricing comprises a plurality of sets of validity, qualifications and price specifications. Each VQP (Validity-Qualifications-Price) specification set is independent from other sets in pricing. A validity specification describes the circumstances and conditions under which its associated qualifications and price specifications would be applicable, e.g. a date range or a method of payment, and such circumstances and conditions are not part of the specifications in other areas of concern for the offer (herein referred to as extra-offer criteria). The lack of a validity specification could, for instance, mean that the validity of the price specification is on-going with no known extra-offer criteria, or that one needs to contact the provider or through other means to learn about these criteria. They are an example of a default interpretation.

A qualifications specification, among many possible qualifications, defines how the price is to be determined or interpreted, as well as the relevant criteria set forth in other areas of concern for the offer (i.e., intra-offer criteria). For instance, a price may be specified as a fixed price, or be determined through an auction, and is applicable only to certain shipping and handling methods. The lack of a qualifications specification would usually be interpreted as the use of a fixed pricing scheme as the default and there are no known intra-offer criteria.

A price specification provides a price and related parameters in accordance to its corresponding qualifications specification. For example, if a price is to be determined via an auction with a reserve price and an expiry date, then the start and expiry dates may be specified as part of the validity specification, while the price specification would include the start price, reserve price and increment amount for each bid. The qualifications specification would indicate that this is an English auction (instead of fixed pricing or Dutch auction, for example).

In addition, an offer may have multiple VQP specification sets, with any one of them being acceptable to the provider. For example, an item under auction may also provide a “buy it now” price that would cancel the auction should a participant is willing to pay that amount before the auction ends with a successful bid. As such, there are two VQP specification sets, one for the fixed pricing and the other for the auction.

While any change to an offer (i.e., to its specifications) may constitute a new offer, for the purpose of tracking an offer and providing it a history, distinction is made between the specifications that define the offer as its invariants and those that may change over time. Pricing in general belongs to the latter. For instance, a supermarket selling a case of bottled soft drink for a price may increase the price by ten percents. Since this new offer would render the old one obsolete, the obsolete offer is usually regarded as a history or predecessor to the new one. This association results from the practical effect of one offer replacing another while both offers refer to the same item bundle from the same provider. For instance, a system that maintains current prices for a list of items offered by a particular supermarket would simply update the ones that have been changed while leaving others untouched. Old prices may then be made available as a reference against their respective newly updated prices (which may or may not be current or up to date). Hence the number of available prices remains the same in relation to the list of items whose prices are being tracked. Each such available price is in effect the variable part of an offer whose invariants are the item being offered and the supermarket that offers it for sales. The prices set forth in its predecessors become the history of the offer in terms of pricing.

A validity specification in pricing is where finer evaluation may be made as to whether one offer is replacing or changing another offer. For instance, a car dealer may offer a special discount on a specific car for a limited time, after which the regular price would apply (again). An offer of this special discount would not replace the original offer (with the undiscounted price) in its entirety. Instead, the original offer is no longer valid during the promotional period, while remaining in effect outside it. As such, the offer of discount is modifying or temporarily superseding the original offer, not making it obsolete (completely). Alternatively, the offer of discount may be merged into the original offer in that the validity specification of the former co-exists with that of the latter, each referring to its own price specification, thereby resulting in a new (combo) offer. One who is considering the offer during the promotional period would be given a discount price, and a regular price if outside the period. Likewise, several offers that are otherwise identical except their different but non-overlapping validity periods are offers that neither replace nor change one another. Since they all refer to the same item from the same provider, their prices may serve as references to one another, and since they are also chronologically related, as histories. Furthermore, a validity specification needs not be time-based. For example, a certain brand of credit cards or currency to use for payment may be specified in a validity specification.

In contrast, a price specification does not contribute to the evaluation on whether two offers are related or not. A qualifications specification serves to provide a context in which its corresponding price specification is to be substantiated, interpreted and compared. That is, price specifications of incompatible qualifications specifications may not be substituted or replaced with one another even when the all other specifications in the offers under consideration are identical.

As mentioned before, specific pricing may be dependent on other areas of concern, such as intent (e.g., to buy or lease), eligibility (e.g., affiliations of a customer, his location, or a particular end-user agreement) and delivery (e.g., overnight vs. week-long delivery). It would be the qualifications specification of a VQP specification set that would reference or otherwise relate to the necessary non-pricing specification(s) to qualify the price specification in the set.

The delivery area of concern is where possible delivery means or methods available for an offer, as well as the availability of an item bundle of interest, may be specified. For instance, the item bundle may be available for pickup only (e.g., at a retail store), or postal delivery with various options as well as a local pickup. Each of these shipping and handling specifications may be dependent on specifications in eligibility, such as customer criteria specifications, delivery location specifications, and legal agreement specifications and acceptance. The availability of the bundle item, which includes but not limited to quantity and date, may likewise be dependent on eligibility. Hence specifications in delivery may reference or otherwise relate to a specification in eligibility.

The eligibility area of concern is where possible criteria or qualifications against potential customers or counterparties may be set. For instance, a customer criteria specification describes a customer must have or should be, such as a membership of a shopping club or an age 18 or above. A delivery location specification describes the locations (e.g., U.S., Hong Kong and so on) where potential customers or counterparties should be to qualify for the offer (e.g., for item bundle pickup or delivery). A legal agreement specification and acceptance is what a potential customer or counterparty must agree to in order to qualify for the offer. Similar to delivery, each type of specifications in eligibility may have more than one specification. A potential customer or counterparty needs to fulfill just one of them to qualify for the offer.

An electronic offer based on the template in FIG. 23 may be created and submitted by any consumer or vendor alike, or be authenticated using the current state-of-the-art technologies (e.g., password-protected credentials, digital signatures, and so on) to ensure only qualified or authorized entities may submit or publish it. For instance, an official offer should only come from the provider of the offer for consideration, and hence an electronic offer allegedly submitted by the provider should be authenticated as such.

In addition, for an electronic offer to be comparable with other electronic offers, not all specifications need to be capable of being parsing and interpreted by automated means. For instance, a potential customer looking for a specific product may obtain a list of offers with matching product from a search engine supporting the deposition and retrieval of such offers. He may then proceed to read up all the different individual specifications in eligibility and delivery which the search engine is not capable of or otherwise not interested in parsing and interpreting, or these specifications are simply not stated in form or format conducive to such parsing or interpretation. In fact, a single specification may comprise both machine-interpretable data and machine-ignorant information. For instance, an item specification may contain for the item of interest a numeric UPC—Universal Product Code (which is highly machine-interpretable), a freeform text describing the warranty, accessory compatibility and so on about the item (which requires text interpretation whose result might not be totally accurate), and an image of the item (which is the most difficult of the three to extract data for comparison, unless the image itself is a code in nature, such as a QR code). Hence the exact requirements for data suitability and sufficiency for a specification in an area of concern could vary from one implementation to another. For example, as part of an item specification, one implementation may support the entry of a serial number for identifying a specific item while the other the entry of a freeform description of an item without any specific named field such as UPC or model number. The identification of an item includes but not limited to a name, description, code (e.g., UPC—Universal Product Code), and URI—Uniform Resource Identifier. Such identification may progressively be refined to further qualify an item of interest. For instance, a mobile phone of grey market would usually be void of warranty. As such, item identification or specification could further indicate if the mobile phone being offered is qualified for warranty at some jurisdiction of interest. While an item identification or specification lacking such indication might result in some ambiguity which could only be resolved later by further inquiry with the item provider, it does provide enough information for interested parties to determine their interests and pursue the offer further.

Likewise, how much information is needed for the identification of an item provider depends on its ability to locate an offer in question. For instance, a national store chain would easily be located simply with its name. In addition, if all the stores in the chain are known or otherwise expected to sell the same item at the same price, then there may be no need to differentiate stores from one another within a common jurisdiction such as a city, state or country where the store chain operates. Similarly, a well-known online store would be easily located simply with its name, without a full URL (Uniform Resource Locator) being specified. On the other hand, individual stores may sell their own prices despite belonging to the same company (e.g., franchising). Hence their specific addresses would be needed in order to locate their offers of the same item but potentially at different prices.

Furthermore, a specific vendor of a certain location may be located via different address specifications. For instance, in a multi-lingual jurisdiction, the same address but in different languages would exist. Technically it results in multiple address specifications. Even for the same language, one address specification may provide the name of an addressable mall where the store resides in lieu of the actual street name and number. Addresses using either one of the former or the latter are equally valid, for instance, as a postal address. As such, even a specific store at a specific location may be associated with a plurality of address specifications.

Moreover, while a legally-binding offer would technically entail more specification or information than just the identity of an item, a price and a certain level of awareness of the seller, in practice an offer known or otherwise explicitly specified only with this information would suffice for the purpose of advertising and transaction. For example, a consumer who has interest in an item at a supermarket (i.e., the item provider) would usually find it sufficient to make a purchase decision knowing the price of the item (and having enough trust, implicit or otherwise, in dealing with the supermarket whose exact name and address the consumer might not even be aware of). He may proceed to the checkout for transaction without any additional information about the offer, which may, for example, be implicit (e.g., per some statute under a particular jurisdiction) or known only after the transaction is complete (e.g., the conditions and clauses printed on the receipt regarding the purchase). When the price of the item changes, the consumer could interpret it as a change to an offer (especially when the old prices are known), even though technically it may be considered as a new and independent offer albeit replacing another offer of the same item (and usually in the same quantity) but with a different price. However, price change across different sellers does not convey this semantics as far as their individual offers are concerned.

Likewise, while an actual cost of ownership for items available online may vary due to the differences in shipping and handling charges as well as applicable taxes, a price specification may simply provide a nominal amount, so that a consumer would need to pursue further to find out the exact amount, e.g., contact the item provider or discover it by initiating an inquiry or a tentative transaction (e.g., through a URL). Arguably offers with full price disclosure are usually more desirable than those that require further discovery beyond what is available and retrievable in various collocated specifications of an offer. Note that a specification such as the price in a price specification may also be updated dynamically when the specification contains a means or a reference to a means, e.g., URL, to perform such updates. This is feasible and available in the current art.

An electronic offer based on the template shown in FIG. 23 is self-sufficient in that any online system equipped with the means to parse and interpret the content of the offer would be able to compare it with other offers in form or format that also provides the data for evaluation. Such an offer as an entry in a repository may further be archived, updated, or associated with other offers with compatible or comparable data.

For instance, an offer database system equipped with techniques for determining if two offers match, such as the one shown in FIG. 3, may search its repository of offer entries for matching offers (e.g., based on specifications of item bundle and provider). If there is no such existing offer, then a new offer entry per offer submission would be created in the repository, and the process completes. Otherwise, each matching offer entry would be compared against the offer submission to determine if there is any matching validity (e.g., same effective and expiry dates), validity in conflict (e.g., an overlapping range of two or more pairs of effective and expiry dates), or none whatsoever. A matching validity would result in the matching existing offer entry having its data for update (e.g., the price specification) to be replaced or otherwise modified with that of the submission. A validity in conflict would result in a new offer entry being created per submission and the in-conflict offers being modified (i.e., its validity specification) or removed, depending on the nature of the conflict and the chosen confliction resolution technique(s). For example, the offer expiry date of the submission may be later than that of an in-conflict offer entry with the same effective date. Hence the newly created offer entry would render the latter obsolete and therefore result in its removal. On the other hand, an earlier expiry date with the same effective date could simply modify the effective date of an in-conflict offer entry to follow right after the expiry date of the new offer entry, thereby updating the latter offer entry which would, as a result, be no longer in conflict. Of course, such an in-conflict offer could simply have an additional validity and price specification to account for the new submission so to save a new entry creation. There are also other variations that, although not shown in FIG. 3, are viable considerations or alternatives for such evaluation. The technique illustrated in FIG. 3 provides a framework for handling electronic offers comprising data responsible for identification (e.g., UPC)—identification data, data for validity (e.g., offer's effective and expiry dates)—validity data, and data for update (e.g., the price)—update data. The technique may also be modified to ignore the validity data even when it is present, so that newer offers would simply provide existing offers of the same identification with replacements for the update data, and optionally have the validity data available as history to the newly updated offer entries. In fact, any data not used for identification (i.e., their being different from their counterparts in the newer offers of the same identification would not result in a new entry) could likewise become history to the updated offer entries.

Note that the offer template shown in FIG. 23 is independent of any computing platforms or analytical techniques. An offer, offer submission or offer entry in accordance to the template may be provided to various degrees of specificity. An offer entry with only an item and provider specification becomes just an advertisement of availability. An offer entry with only an item and price specification serves as a generic price reference of limited use. Such an offer entry with an additional delivery location specification provides a better generic price reference for people who are situated or otherwise interested in the locations so specified. An offer entry with an item, provider and price specification would provide enough specificity for any consumer equipped with this information to readily pursue or otherwise inquire further about the offer, and use it for his competitive advantage. A self-sufficient offer entry is one with enough specificity that enables it to be matched and transacted without the need for further inquiry or discovery. Two complementary self-sufficient offer entries (like those found in stock trading) may be matched and transacted automatically with no need of manual intervention.

Although data in the specifications of an offer may be in form of NVP (Name-Value Pair), many other structured forms, formats, and schemes may also be used, such as XML. The exact implementations or mechanisms to compare, evaluate and match the content among a plurality of specifications in various areas of concern may be consequential to the chosen forms, formats, and schemes.

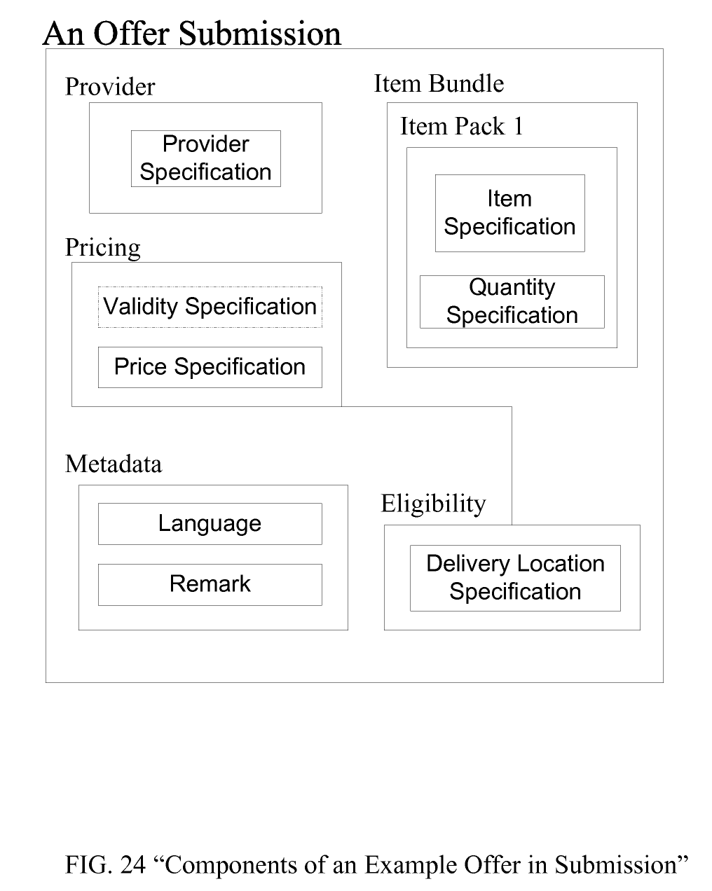

FIG. 24 “Components of an Example Offer in Submission” shows an offer template (comprising a subset of areas of concern and specifications of the one shown in FIG. 23). An offer submission based on this template would comprise an item bundle, a provider, pricing and eligibility. The item bundle would contain only one item pack which is made up of an item specification and a quantity specification. The provider, pricing and eligibility areas of concern would have one specification each, with eligibility being concerned with only the delivery location. A mobile offer reporter such as the one illustrated in FIG. 11 may create offer submissions in form identical or otherwise similar to the template shown in FIG. 24.

Various data elements in an offer submission may map or otherwise correspond to the specification parts of the template. For instance, the data fields with prefix “v” such as vUnit, vFloor and vName and those with prefix “i” such as iName, iSku and iCode along with the data field “quantity” in the UserEntry class (shown in the appendix) may be part of the provider and item specifications respectively. The data field “dest” constitutes the delivery location specification. Data fields such as currency, dollars and cents are part of the price specification. Optional data fields “avail” and “expiry” represent respectively the effective and expiry dates of the offer and may be considered as part of a validity specification. The eLang and eRemark (i.e., Language and Remark) may be regarded as metadata to the specification of an offer. (Other possible metadata include but not limited to the creator, creation time, and submitter of an offer submission or entry. And the purposes of data fields may be changed or ignored from what an offer submission may have intended, which would be illustrated later.)

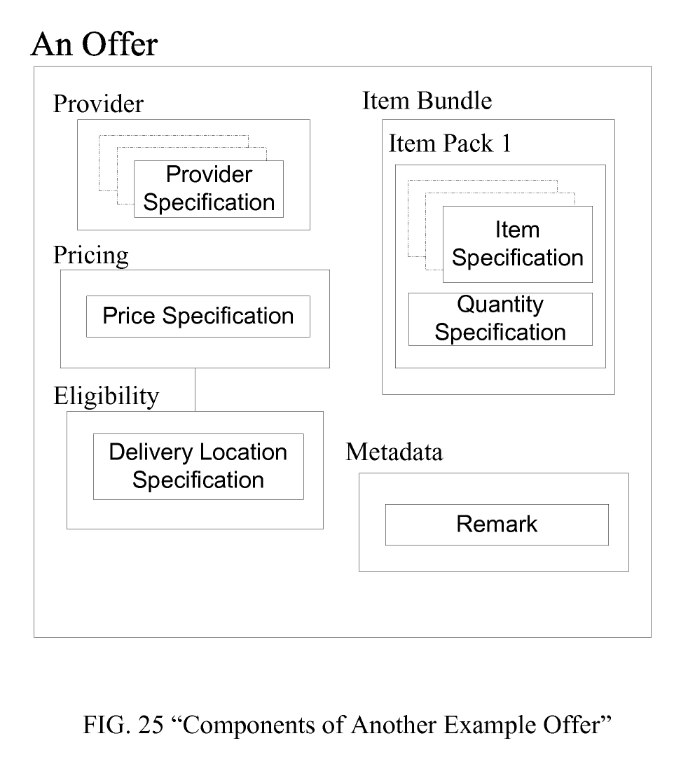

FIG. 25 “Components of Another Example Offer” shows another offer template on which an offer submission or repository may be based. Data models adopted by an offer repository used in an OQS server may organize or otherwise maintain offer entries in a similar way. For instance, in reference to the appendix, the model for offer entries (see Model “DOffer”), together with the models for product codes and names (see Models “DProductCode” and “DProductName”), may support multiple item specifications for the same item (i.e., different product code entries for the same item or the same product code entry but with different product name entries). The model for vendor/provider entries may likewise support multiple vendor/provider specifications for the same vendor/provider.

Even though the offer model contains data fields for availability and expiry dates, they are not intended to be used as a validity specification. For instance, when an offer submission as one based on the template in FIG. 24 is received by an OQS server which treats offers as those based on the template in FIG. 25, the server could simply regard the availability and expiry dates, if any, in the offer submission as part of a price specification for the offer in question. It would then rely on either the offer submission creation timestamp or its submission receipt time to decide which price specification takes precedence over the other, when all specifications for identification are identical or otherwise equivalent. Note also that the template in FIG. 25 does not contain metadata “language” shown in FIG. 24. As such, a FIG. 25 template-based offer entry may be linguistically neutral, and the language metadata would become a factor in the multiplicity of provider and item specifications. For example, two item specifications may be identical with the exception of the item name data which are in two different languages. Each such specification may then include a language data field to make explicit the language of the item name. The knowledge of the language in use may come from the language metadata available in a submission.

### A4. Embodiment for Remote Control for Offer Advertising and Transaction

One problem associated with the Penn effect is described below. Many professional and occasional sellers know about popular online auction and shopping sites but most of them never use the services. The user interface of these websites poses a challenge to these consumers despite their educational or professional background. This is similar to the challenge many have with programming the clock or setting a timer recording on a VCR. The extraneous information such as online ads on the a shopping and auction webpage makes it more difficult for people who are not Web savvy to focus on his task and locate relevant information. And the need to turn on a general-purpose computer and run a Web browser so to enter a web address poses another unnecessary barrier to a consumer.

One embodiment of the present invention provides a system, device, and method for addressing the above discussed problem. More specifically, one embodiment of the present invention provides a system, device, and method whereby a user may conduct a guided publication, negotiation and transaction of an offer without the need to using a general purpose computer and manually starting the necessary software (e.g., internet connection, Web browser) that are not in itself part of an offer publication, negotiation and transaction.

The present invention comprises a device capable of accepting information about an offer from a seller or some other input, and performing a dialog with a plurality of potential buyers. Such a device is herein referred to as an offer remote control. Through the use of an offer remote control, individual vendors would be able not only to publish and update their pricing information for specific products in a timely manner, but also to conduct negotiation with potential sellers and receive instructions by a central system on shipping and handling.

An offer remote control comprises a network communication module capable of sending to and receiving messages from a pre-assigned server, a user interface module capable of displaying or otherwise communicating information to and receiving input and instruction from a user, a control and processing module capable of interacting with a user through the user interface module and with a pre-assigned server through the network communication module, and a memory module capable of supporting the operation of the aforementioned functional modules, as well as optional modules augmenting them, such as an optical capture module capable of gathering information needed for an offer, such as the scanning of GTIN (Global Trade Item Number) codes, and a printer module capable of printing out instruction and labels, such as those of address and postage. Of course, an offer remote control is able to support a plurality of offers, not just a single offer at a time.

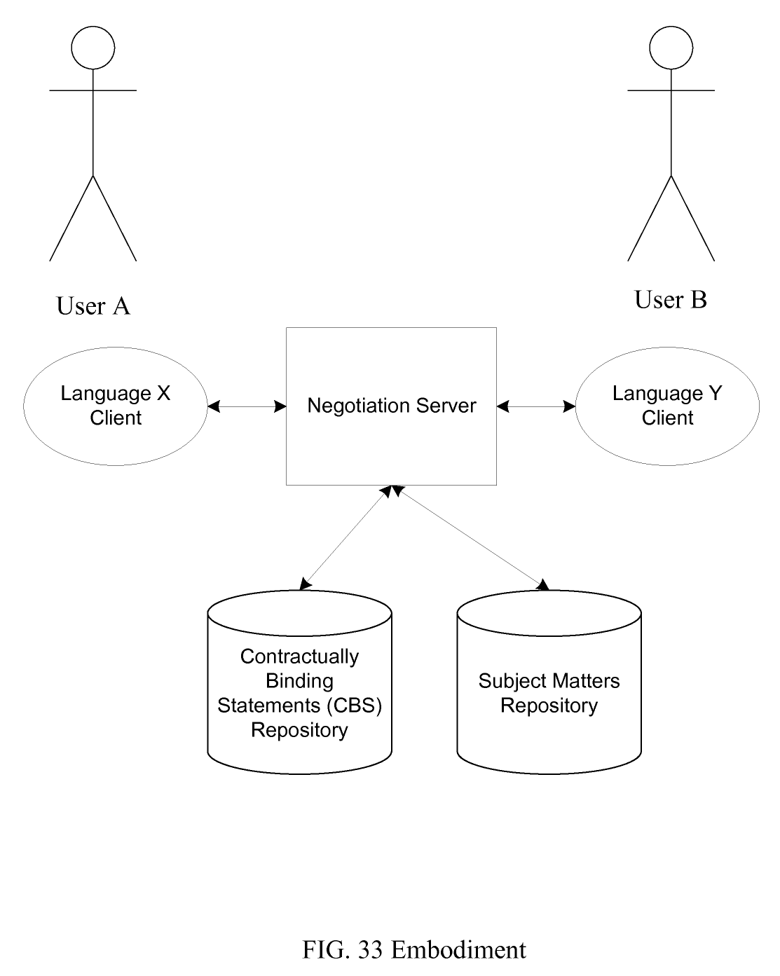

To advertise and maintain an offer, the setup and operation of an offer remote control is the same as that of a mobile offer reporter described earlier. For negotiation of an offer, if applicable, with several buyers, the pre-assigned server would serve as the automated intermediary (such as the negotiation server shown in FIG. 33). The pre-assigned server would maintain an individual negotiation session for each buyer engaging the seller. The pre-assigned server is responsible for soliciting a response from the seller through the offer remote control in order to further any negotiation session still in progress, and for maintaining these negotiation sessions within a pre-determined period of time even if the user has logged off or turned off his offer remote control. The pre-assigned server would determine and control the flow of the negotiation. It is responsible for prompting (both the buyers and the seller) in a timely manner the relevant questions and facilitating the completion of the parameters for the negotiation. The seller would simply respond to each such solicitation through the offer remote control. An online negotiation may be aborted, suspended, or completed with or with no resultant transaction.

The pre-assigned server would also provide to the seller the detailed instructions and their reminders to fulfill any pending tasks on a transaction, such as the delivery address for shipping the promised goods using the shipping option chosen by the buyer. In addition to a display, the offer remote control may provide these instructions as well as adhesive labels through a printer, so that a seller may simply affix these adhesive labels (e.g., of address and postage) onto the package for shipping. The pre-assigned server may even indicate to the seller which nearby post office to go and its business hours, or arrange a courier service to pick up from the seller the item to ship.

### Sample Embodiment and Its Operation

A sample embodiment is an offer remote control whose network communication module is of mobile communication such as the GSM Networks. The remote control also has a LCD display, a scanner capable of recognizing and capturing the information of a GTIN code, and a printer capable of printing adhesive labels.

A retailer would use the scanner on the offer remote control to identify an item for an offer, and then specify the price. The retailer's address is already pre-programmed into the remote control, much like the operation of a mobile offer reporter.

Through the publication of the offer by the pre-assigned server, a consumer sees the offer, and decides to buy the item specified in the offer at the retail price. Upon the initiative by the consumer, the server would send a message to the offer remote control about the consumer's intention, and ask the seller to check the item's availability. The seller goes to the shelf or consults with his inventory system. If no more item available, then the seller would indicate so to the pre-assigned server through the remote control. The server would notify this to the buyer and the case is closed. If the item is available and the seller indicates so to pre-assigned server through the remote control, then the remote control would print out the name of the buyer (and other relevant information) on an adhesive label with an expiry time after which the intention to buy is considered withdrawn. The server would then notify the consumer where to get the item and by when. Meanwhile, the seller would affix the label onto the item reserved for the consumer.

The server may accept payments on behalf of the seller, or the consumer would pay directly to the seller upon the latter's arrival for picking up the item. In addition, the offer remote control would also be able to handle multiple simultaneous “intention to buy” messages from the server. One who is skilled in the art would be able to provide various implementations for the requirements of different specific applications using or otherwise embodying the present invention.

### A5. Embodiment for Context-Priority Publication and Matching Scheme for Online Offers

One problem associated with the Penn effect is described below. Although it is very easy to publish information online, i.e., on the World Wide Web (or the Web) and access it, it remains very difficult to find and locate relevant information pertaining to offers of products and services, whether to acquire or furnish them. A search engine performs relevancy matching based primarily on orthography (i.e., spelling). Synonyms, meanings, and contexts are then derived from the given keywords and words adjacent to them, even though both the content provider and content searcher already know the context at the time of content creation and inquiry.

One embodiment of the present invention provides a solution to the above outlined problem. Specifically, one embodiment of the present invention provides a scheme where contexts are the primary consideration for relevancy evaluation. Other considerations then follow in a given ascertained context.

Specifically, a grammar or template (similar to that of FIG. 23) may be defined to specify or otherwise identify a context-specific components or specifications of an offer. For instance, an offer may be described as follows.
<Subject><Object><Verb>[<Adverb>][<Whom>][<When>][<Where>][<How>][<How Much>], where:
   <Subject> specifies the information pertaining to the offer provider and its contact info, if applicable.
   <Object> specifies the object of the offer, e.g., an item of service or product or an item bundle.
   <Verb> specifies the action or intention of the offer, such as to acquire or to furnish the object in the offer.
   <Adverb> qualifies the action or intention of the offer, such as whether to acquire by auction or by rental.
   <Whom> qualifies the prospective offer takers, such as whether the offer is good for people under the age of 18, or people with certain affiliations or residency (e.g., a tourist).
   <When> specifies the applicable date and time restrictions and other time-related constraints that the offer is subject to.
   <Where> specifies the location applicability of the offer for delivery or visit.
   <How> specifies how the offer may be obtained and paid for, such as a website URL and the acceptable credit cards.
   <How Much> specified the asking or initial price.
      Note that <Adverb>, <Whom>, <When>, <Where>, <How> and <How Much> are optional, as denoted by each enclosing set of left and right square brackets. In addition, such a grammar or template may be extended. For example, a contextualized specification of quantity or “How many” may be added to further qualify the quantity of the object in question. Furthermore, a context may be established within a context (e.g., as a sub-context). For instance, the “How many” context or specification may be peer to the object context or specification, or a sub-context to the “Object” context or specification.

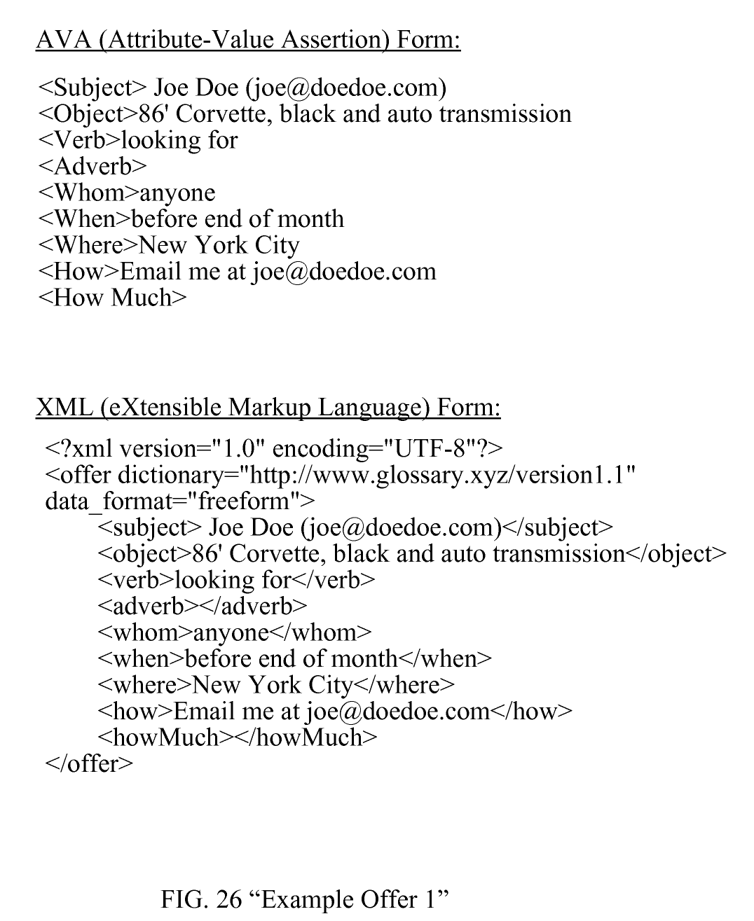

FIG. 26 illustrates an example offer using the above grammar or template. The Subject of this non-binding offer is Joe Doe, who is looking for an 86' black Corvette with automatic transmission available in New York City. His offer is good till the end of the month, and he may be contacted via joe@doedoe.com. When represented in XML (eXtensible Markup Language), the offer with its constituent parts is readily recognized and interpreted by any entity (such as a person, a machine, or a software program) that understands the grammar. For example, a search engine equipped with the present invention would be able to locate both the <Object> and <Verb> parts of an offer in accordance to a user's query, while ignoring other parts that are irrelevant to the query. Accuracy of results would have already improved substantially compared to the conventional search engines that lack this ability.

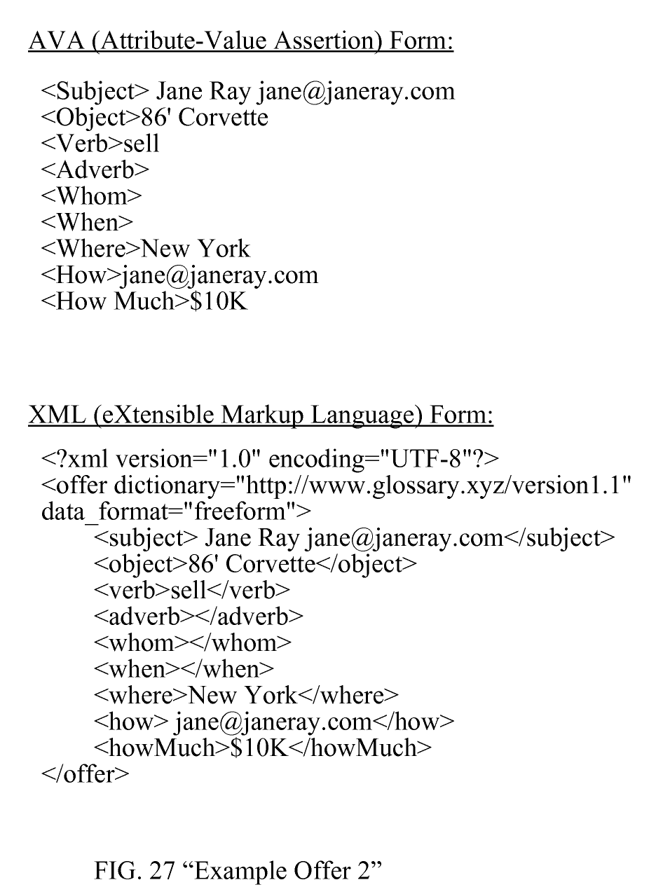

In addition, since an offer definition equipped with the present invention is self-sufficient in describing the offer, any third party, be it a system, an application or a person, can perform matching of complementary offers, such an offer to buy and an offer to sell the same item. For example, FIG. 27 illustrates an offer to sell an 86' Corvette by Jane Ray. Using the grammar or template, the Verb context would readily be identified. The content of the Verb context (or simply called the Verb context data) in this example offer #2 is “sell”. To determine the relevance of one offer to another, the Object and Verb context data of the two offers would usually be considered first. Unlike contexts of correspondence such as the Object context, evaluation of the Verb context data looks for reciprocity or complementarity. For example, the Verb context data in example offer #1 is “looking for”, which means to acquire, which is reciprocal or complementary to verb context data that means to provide, such as to sell. Hence, the verb context data in the example offers #1 and #2 match, even though they do not correspond to each other in terms of similarity in spelling nor meaning. In other words, a technique to match offers that complement each other, e.g., for potential transaction, would identify offers indicating the same or equivalent object of interest, but an opposite intent. Data in a certain context or specification of an offer may be translated (e.g., using synonyms of the same or foreign languages) or otherwise interpreted before being compared with data in the corresponding context or specification of another offer. For the context or specification of intent, a match results when the data of the offer and the date of the other offer assume the opposite or otherwise complementary meaning or indication. A system, process or method capable of matching offers (such as the ones shown in FIG. 1 and FIG. 11) may be adopted or otherwise adapted by one skilled in the art to perform such offer matching or data comparison involving contexts or specifications with reciprocity or complementarity potential (e.g., an intent or the “Verb”). For instance, to look for similar offers, the candidate offers should have intents that are identical or otherwise similar in meaning or indication in relation to one another. To look for offers for transaction, the candidate offers should have intents (e.g., to sell) that are opposite or otherwise complementary in meaning or indication in relation to the intents (e.g., to buy) of one or more target offers.

Note also that data of a certain context or specification may be deemed complementary in addition to or in lieu of having opposite meaning or indication. For example, an object of “toothpaste” may be deemed complementary to an object of “toothbrush”, despite these two objects assume no opposite meaning or indication with respect to each other. As such, data of contexts or specifications other than those of intent may be used or otherwise involved in matching of complementary offers (or of complementary offers and requests). A method, process or system (such as the ones shown in FIG. 1 and FIG. 11) may be configured to perform such matching in accordance to any definition of reciprocity and complementarity involving data of a given context or specification.

Furthermore, a context part in one offer could be a counterpart in another context part in another offer. For instance, the Subject context in one offer could be the counterpart in the Whom context in the other offer when considering the relevance of these two offers to each other.

Moreover, relevancy matching is different from database query lookup in that results from the former need not have 100% accuracy in accordance to the intent of a user query. It is simply customary to return the results of higher relevancy to the user, followed by those of lower relevancy. For example, Example Offer #2 does not specify the color nor the transmission type of the car for sales, while Example Offer #1 asks for a specific color and transmission type. Yet Example Offer #2 may still be deemed relevant to Offer #1 (and vice versa). Of course, an offer that provides more specific details that match Example Offer #1 would be deemed more relevant to Offer #1.

Note that the present invention allows flexibility and extensibility in specifying context data and performing relevancy matching. For example, FIG. 26 and FIG. 27 respectively illustrate two offers in XML form. Both specify the dictionary (e.g., dictionary=“http://www.glossary.xyz/version1.1”) to which the definitions and meanings of terms used in the offer specification are to follow. They further specify that the context data is of freeform (e.g., data_format=“freeform”). Different dictionaries may be used, and translation between dictionaries may be provided to determine the compatibility of two offer specifications. The specificities of the grammar may be re-defined or extended by referencing a dictionary that provides such redefinition or extension. Furthermore, the data format of each context part may each follow a specify format, instead of being freeform as shown in the examples. For example, the Object context data may be specified in RDF (Resource Definition Framework) and the Subject context data in AVA (Attribute-Value Assertion), while all other object context data in freeform. As such, each context part may specify its own dictionary to follow.

Every context part may be used in the consideration for relevance matching. In general, the more specific in form and meaning a piece of context data is, then the more accurate is the relevance determination involving the context data. In addition, a context part provides the context to govern how two context data from two different offers are to be compared and evaluated. For example, an offer to sell an item for $100 is relevant to an offer to buy the same item for $110, even though the amounts are numerically different. An offer to sell an item in California is relevant to an offer to buy the same item in Los Angeles, even though the locations are different in scope. Furthermore, a piece of context data may also be translated to another language for the purpose of display to an end user and matching with another offer. The resultant language may be a natural language or even a machine language or code suitable for further processing and manipulation.

One skilled in the art of markup language design, Web technologies, and software system and application development would be able to implement the present invention for a variety of applications and systems that perform better relevancy matching among offers than the status quo.

### Example Embodiment and Its Operation

One embodiment is a system with an interface (online such as a webpage or offline such as an interactive telephone system) that presents a set of questions to an end user so to capture the answers for each context part relevant to a given offer. The system then creates an offer specification in XML form upon completion and submission of the entry. The data of each context part would then be indexed, and be available as part of a search index available for query. For the newly added offer specification, the system would create a companion query which inherits all the context parts from the offer specification, and has data of specific context part modified according to context complementarity. For instance, the original semantically significant words or phrases in the “Verb” context part are replaced with their antonyms, and the data in the “Subject” and “Whom” context parts are swapped. In addition, the matching of the location applicability specified in the “Where” context part may employ the design of the “Hierarchically Constructed and Arithmetically Generated Pages for Matching and Indexing” invention specified above. The companion query would then be used to search against the offers in the index using as the minimum the “Subject” and “Verb” context parts. The query result would then be displayed to the end user. In addition, the system could periodically perform queries on behalf of an end user against newly added offer specifications without user intervention.

With this particular embodiment, an end user would logon to a webpage which presents a set of questions. Each question would guide the user to provide data for a specific context part. For example, do you want to get something or to sell something? This question would help provide data for the “Verb” context. If the answer is to get something, then the next question would be whether the user wants to buy, auction, or otherwise trade for it. If he wants to buy it, then how much he is willing to offer. The answers to these questions would help define or refine the data for the “Verb” and “Adverb” context parts. Some context parts may get data from the system, such as the “Subject” context data using the user login ID, and the When context data using system generated date and time, after successfully interpreting the user's answer to the question(s) relevant to these context parts.

When the end user completes all the relevant questions, a backend system creates an offer specification, and displays it through a webpage to the end user for confirmation or correction. Once confirmed, the offer is indexed in accordance to its context parts, and becomes available for query and matching. The backend system would perform query and matching of the newly added offer specification against their companion queries. The end user would then be presented with the result of such query and matching.

### A6. Embodiment for a Universal Vendor Code

Another problem faced by a consumer in preparing an entry of offer intelligence described above or any entry involving a vendor address is the tediousness of entering the information, especially on mobile or portable devices. This is one of the major inconveniences preventing consumers from participating in collaborative electronic commerce.

Here is provided a system, process, apparatus and method whereby a universal vendor barcode (or UVC—Universal Vendor Code) may be retrieved and generated. For instance, an example of such a method for generating and using a universal location-specific vendor barcode would comprise:
maintaining an electronic repository of a plurality of vendor entries, each comprising a location jurisdiction, a name, an address, a barcode, and optionally a set of GPS coordinates;
specifying or otherwise implying a location jurisdiction (e.g., a city or a state) in a query;
optionally specifying or otherwise implying a language for data entry if the location jurisdiction allows or otherwise supports more than one languages;
specifying a vendor name as part of the query, and optionally additional criteria therein;
looking up the query against the electronic repository for matching vendor entries;
displaying the matching vendor entries if any;
specifying an address and optionally a set of GPS coordinates against the location jurisdiction and the vendor name;
generating per a data packaging dictionary or schema a barcode as the universal location-specific vendor barcode embedding or otherwise representing the address, the optional set of GPS coordinates, the optional language for data entry, the location jurisdiction and the vendor name;
creating and storing in the electronic repository a vendor entry comprising the barcode, the address, the optional set of GPS coordinates, the optional language for data entry, the location jurisdiction and the vendor name; and
retrieving from the barcode per the data packaging dictionary or schema the address, the optional set of GPS coordinates, the optional language for data entry, the location jurisdiction and the vendor name.

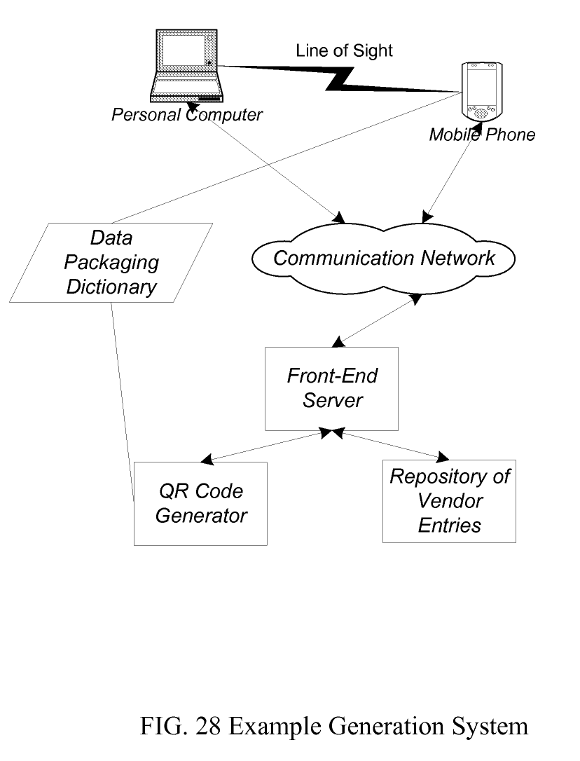

FIG. 28 “Example Generation System” shows a set of example functional components that may be implemented or otherwise arranged to support the operations described above. A front-end server interacts with user devices such as a personal computer or mobile phone over a communication network. It accepts and sends data from and to these devices which interact directly with end users in terms of data entry and information presentation, visual or otherwise. A QR code generator accepts structured data from the front-end server and returns it a QR code embedding the data. Of course, symbology technologies other than QR Code capable of embedding the structured data may also be used. The data is structured in accordance to some data packaging dictionary or schema, such as the use of a set of pre-defined key names in name-value pairs (NVP) and the use of JSON in data encoding and decoding. (See “GPS-Ready Code Image” below for an example on how data may be embedded and retrieved via a barcode such as a QR code.) A user device would use the data packaging dictionary or schema as a reference for retrieving the individual data items from the QR code so generated, when the device has captured the QR code optically, e.g., using the on-device camera taking a picture of the QR code image shown in a webpage served by the front-end server. For example, a camera-equipped mobile phone in FIG. 28 may capture a QR code image from the screen display of a personal computer and extract structured data embedded in the image in accordance to a common data packaging dictionary or schema. As such, any electronic device equipped with such data packaging dictionary or schema may be able to read and re-use the vendor information contained in the QR code. The repository of vendor entries serves to maintain a plurality of vendor entries and provides backend support to the front-end server, much like what a database or a search engine would do. A server such as the front-end server shown in FIG. 28 may also generate a unique URL (e.g., a permalink) to the QR code and/or the information contained therein.

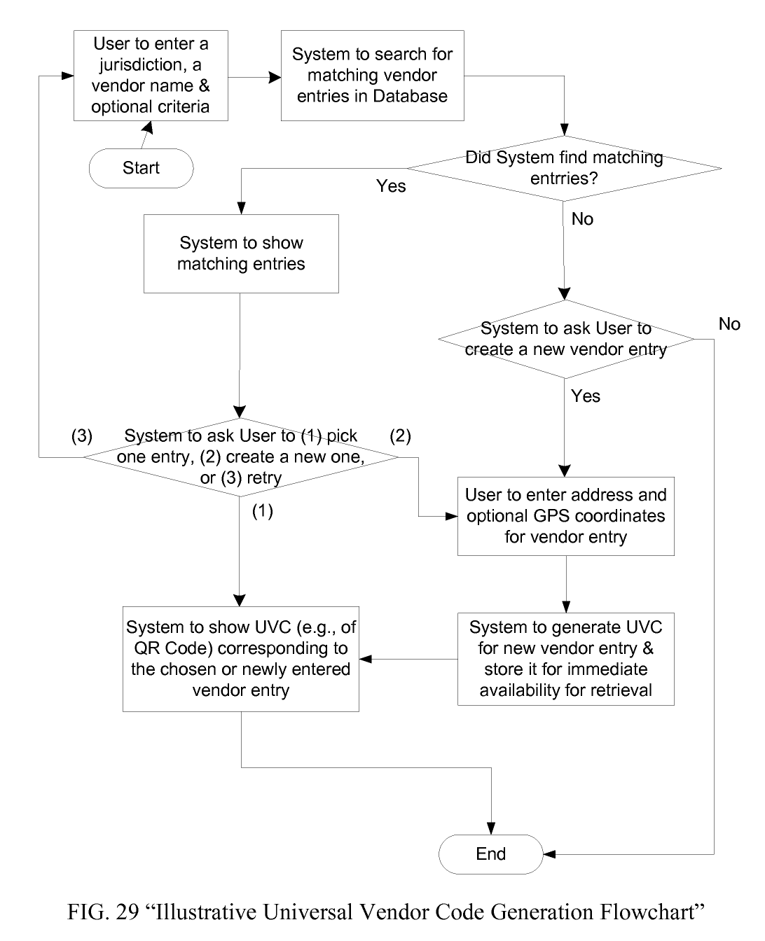

FIG. 29 “Illustrative Universal Vendor Code Generation Flowchart” shows the functionality of an example front-end server in its interaction with an end user. The front-end server along with the other functional system components works together as a system in the retrieval and generation of UVCs (Universal Vendor Codes), barcodes that embed information about a vendor location.

First, the user chooses or enters a jurisdiction, such as a city or a state. Then he enters a vendor name, and other optional criteria such as partial address information. The system searches for matching entries in the database or repository. If there is match, the system shows the matching entries and asks the user to (1) pick one entry for UVC retrieval, (2) create a new entry, or (3) retry. A selection of the third choice would bring the user back to the stage of entering jurisdiction, vendor name and other optional criteria. A selection of the second choice would enable the user to enter information for a new vendor entry. A selection of the first choice would bring up for display to the user a UVC corresponding to the vendor entry, and the system would also present it along with other specific information of the vendor entry. On the other hand, if there is no match, the system would ask the user if he wants to create a new entry.

In the case where the user has chosen to provide a new vendor entry, the system would enable to user to enter address information (including GPS coordinates) against the vendor name and the chosen or otherwise specified jurisdiction. Then the system would generate a UVC using the information of this newly created vendor entry and associate the UVC as part of the entry. It would then store the entry and make it immediately available for future retrieval. The system would also present it along with other specific information of this newly created vendor entry to the user.

UVCs generated or retrieved from such a system would enable devices and applications to efficiently retrieve vendor location information when they are equipped with the means to capture an image of UVC and the means to extract individual data items in accordance to a common data packaging dictionary or schema that is used to encode such information as a single piece of data before being embedded by the UVC. A UVC may be shown in a computer screen, transferred as an image and be used on paper medium such as advertising materials.

### A7. Embodiment for Retail Electronic Receipt

Despite the advances in telecommunications and digital content delivery, paper receipts are still in widespread use for retail goods and services. Not only this practice is environmentally unsound, but the use of paper receipts also requires that consumers manually record the information on the receipts, for example, to track their expenditure over time. In addition, consumers are often required to keep receipts as proof of purchase, and maintaining and organizing paper receipts over time may become difficult to manage, as they might get misplaced or lost, or simply very tedious to relocate.

According to one embodiment, a method, a device, and a system are provided for generating and capturing an electronic receipt for retail sales of goods or services. According to one specific embodiment, a device may be used as a means for payment. Upon successful payment, the device may receipt an electronic receipt for the transaction. An electronic receipt comprising price, item and seller information as well as quantity and date may be sent by an electronic receipt generator or an equivalent to the device (an electronic receipt receiver) as a result of a payment. The device may then communicate to the user of the device the receipt or the information on the receipt, for example, via the display of the device. Information on the receipt, once available on the device, may then be extracted, recorded, logged, indexed, searched, transferred or otherwise processed as needed by the device or an application running on the device.

An electronic receipt generator may allow a cashier person to enter a charge amount, or provide a product scanning input interface that may identify the product and retrieve the corresponding price and any applicable surcharges (e.g., sales taxes). The charge amount is then communicated (preferably wirelessly) by the generator to the payment device. Upon successful payment by the payment device, the electronic receipt generator may then send an electronic receipt to the device.

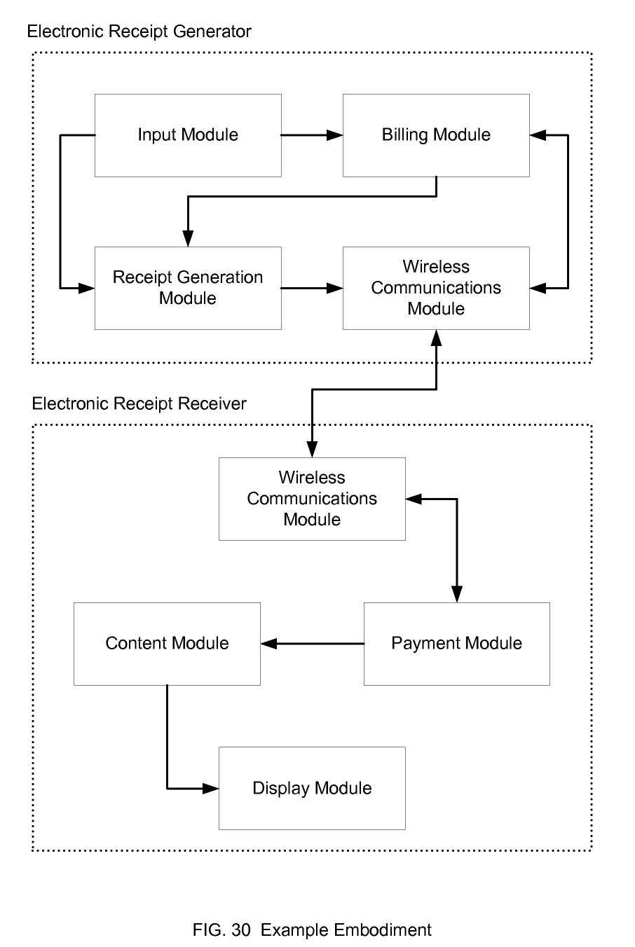

FIG. 30 is a simplified schematic of an example embodiment comprising an electronic receipt generator and an electronic receipt receiver. Both comprise four main modules. Of the electronic receipt generator, the wireless communications module provides a wireless communications interface through which the billing and receipt generation modules (described later) may request and receive payments as well as send out electronic receipts. The input module provides an interface that identifies the item to be sold and the quantity, as well as any applicable charges. Upon request by the input module, the billing module interacts with a payment device via the wireless communications module to obtain the payment for the total charge amount. Upon successful receipt of the payment, the billing module notifies the receipt generation module, which will deliver an electronic receipt via the wireless communications module. In one embodiment, the billing module may communicate with an external system to maintain the total credits it has received. In another embodiment, the receipt generation module may maintain the seller information and date, and request the item, price and quantity information from the input module when generating the electronic receipt.

Of the electronic receipt receiver, the wireless communications module provides a wireless communications interface through which a cashier machine, a vending machine, a payment receiving machine or the like may request and receive payments from (or add monetary values to) the payment module (described later). Such a cashier machine may provide feedback information, such as an electronic receipt, through this interface. The payment module maintains or otherwise is responsible for the current balance available for payment. It interacts with the cashier machine through the wireless communications module. It increases and decreases the balance as instructed by the cashier machine. Feedback information such as an electronic receipt is forwarded or otherwise transferred to the content module for processing, such as decoding or formatting. In another embodiment, the content module may receive the electronic receipt directly from the cashier machine via the wireless communications module, without the payment module as an intermediary. The content module would exhibit or otherwise communicate externally the electronic receipt through the display module. In another embodiment, the content module may forward or otherwise send the electronic receipt or the information therein to an external system via the wireless communications module for further processing.

The example embodiment of FIG. 30, for instance, may be realized in a portable consumer device such as a mobile phone or PDA, equipped with software, hardware, accessories, and so on that enable the device to receive the electronic receipt and display it as such. For example, a mobile phone may be equipped with an electronic payment component or subsystem capable of making payments wirelessly (e.g., via radio wave) and maintaining and updating the current balance. Such a component or subsystem comprises modules functionally equivalent to both the wireless communications module and payment module (for example, see http://en.wikipedia.org/wiki/Octupus_card#Technology). This component or subsystem may be embedded into the phone or added as an extension or accessory, such as a card realized in a flash memory card form factor, suitable for insertion into the phone and becoming communicably coupled with it. An application running on the phone, communicably coupled with the electronic payment component or subsystem, is configured to receive electronic receipts or information therein from the component or subsystem, and to present the receipts or their information to the user of the phone via the on-device display. The phone itself along with the application in this case is functionally equivalent to the content and display modules.

An embodiment of the Electronic Receipt Receiver shown in FIG. 30 may store and maintain electronic receipts and information therein locally at the device (e.g., via the Content Module, or the internal storage of a portable device embodying an electronic receipt receiver). It may optionally upload or otherwise transfer the receipts and information to an external system for further processing, or alternatively serve as a passive device for downloading of the receipts and information.

In yet another embodiment, the payment device or the payment application or module on the device may require authentication (e.g., via passwords) before any payment can be made. This has an advantage of preventing unauthorized payments being made from the device should the device be lost or stolen.

In one embodiment, the item information and/or seller information on an electronic receipt received by the device may initially be absent. For example, a user may then enter via the device the missing information so to qualify the transaction as needed, such as item information plus price, or seller information plus item information and price. In another embodiment, the payment involved may be made independently from the device (e.g., using cash). In this case, the user may use the device to receive the electronic receipt without initiating or otherwise facilitating payments from it. In addition, digital receipts may be digitally signed by or for the sellers so that a customer may use these receipts alone as proof of purchase, for example, for warranty services, product refund or exchange, and so on.

An electronic receipt may also be transmitted optically. For example, a two-dimensional barcode may embody or otherwise comprise an electronic receipt and/or sales information thereof. A mobile device equipped with barcode scanning or reading capability, such as the one shown in FIG. 9, may be configured to capture such a barcode, and extract and present the sales information embedded in the barcode. The sales information may be encoded and decoded in accordance to a scheme shared by both the electronic receipt barcode generator and receiver (e.g., the mobile device). As such, with a single read or scan, the mobile device obtains not only the item identity or identifier, but also other sales information pertinent to a transaction or an offer, including but not limited to price, quantity, seller information and time of purchase.

Whether or not it is capable of providing payment, an electronic receipt receiver would be able to capture sales information (partial or otherwise) useful for creating and maintaining a price, purchase and/or offer history for an item. For example, instead of manually entering the purchase item, price and seller information for submission to an offer database system, a user may simply use her electronic receipt receiver to obtain those pieces of information and submit them to the offer database system. The seller information may also comprise a universal vendor code.

### A8. Embodiment for Hierarchically Constructed and Arithmetically Generated Pages for Matching and Indexing

To prepare a given web page for textual indexing, a typical approach is to remove grammatical punctuations and articles (such as “this”, “the”, “a” and “an”) from the text, perform stemming and word isolation (i.e., change words into its basic canonical form, e.g., “loving” to “love” and “Wifi” into “wi” and “fi”), and synonyms generation (e.g., with “rat”, add “mouse”). Of course, the given web page will remain intact for presentation with optional highlighting when retrieved for a user. All the preparatory processing mentioned above simply produces intermediary content which serves as input to a search engine for the purpose of creating and maintaining an inverted index. An indexed page in an inverted index may also contain named fields, in which all text (i.e., words) in a given field may be grouped, indexed and queried independently of other named fields in the page, and compared against the same or equivalent named fields in the other pages.

When a seller advertises online a nation-wide offer to sell a product, his offer could state its nation-wide applicability by creating a named field for offer applicability and put the text “national” or “everywhere in United States”. Now when a buyer puts his city of delivery (e.g., Seattle, a city of United States) into the equivalent applicability field of his query for offers, then the seller's offer would not be considered as a match using the current state of the art, despite logically that it is a match. Such a problem makes it difficult for sellers connecting with prospective buyers and vice versa. That is, a national offer cheaper than a local offer of the same item could not find its way to the consumer who is willing to wait for the shipment.

In addition, an entry page may contain multiple sets of numerical values, one set for one particular option competing with other options, such as available shipping options for an offer. The numerical values of such an entry page often, if not always, result in a numerically incongruent indexed page for result page ranking. A query looking for a definitive answer to the question “which is the cheapest offer for me (i.e., for my location)?” would have difficulty in assessing these competing numerical values on the same indexed page.

One embodiment of the present invention is configured to address the aforementioned location applicability matching problem. Specifically the embodiment provides a search engine that is configured to distinguish between the applicability field of an offer and the applicability field of a query. The text in an offer applicability field indicates coverage, which means the text “Washington State” is to be interpreted as all locations under the Washington State. Hence, if a query applicability field contains the text indicating any known city or town in the Washington State, then logically there is a match.

One way to implement this is to inquire about or otherwise obtain from the user or some other means the state and the country of the city specified in the location applicability field of a query. This qualifying information may then be added to the same applicability field where the city is specified in the query. When searching for matches, a logical OR comparison is performed on the two applicability fields: one from a page representing an offer in the index and the other one from the input of the query. For example, a query for location applicability having “Seattle” as input would result in “Seattle Washington United States” replacing the input of the query applicability field before the matching is performed. Offers that have “Seattle”, “Washington” or “United States” or the equivalent of each would match to the query due to the logical OR comparison in relation to the matching of the applicability fields between the query and each of the indexed offers (each in the form of an indexed page).

However, this approach would generate ambiguities when two states or countries have a city of the same name. For example, Vancouver, British Columbia, Canada vs. Vancouver, Wash., U.S. A simple inquiry for disambiguation by the search engine may suffice for one application, but not so for another. For applications that cannot tolerate such ambiguities, another approach is to explicitly define and construct a named field for each location level, e.g., country, state, and city. The highest location level fields between an offer and the query are first compared, followed by subsequent lower location levels, one level at a time. A mismatch at any location level would mean a mismatch of the overall location applicability between the offer and the query. In addition, any empty location level field in an offer would mean that all locations under the specified higher level location are considered applicable, i.e., a wildcard. This also means that a successful match in relation to location applicability has already resulted, since the higher level location comparison must have already been done with the result being positive.

For example, Vancouver of Canada and Vancouver of U.S. would result in a mismatch when comparison is made between the country-level locations “Canada” and “U.S.”. An offer with “Vancouver, California, U.S.” would fail to match a query with “Vancouver, Washington, U.S.” at the comparison between “California” and “Washington”. An offer with “, Washington, US” (i.e., empty city-level field) would match successfully with a query with “Vancouver, Washington, US”. A city with no affiliation with a state or province in a country could use a special mark to denote that, such as an asterisk “*”. Multi-jurisdiction locations (e.g., a fictitious city called “ABC”) may be specified in an offer with “ABC, *, DEF GHI”, assuming there were no state or provincial level location in either fictitious countries “DEF” and “GUI” for the city. That is, ABC is under both DEF and GHI. And finally, an offer with “, ,” (i.e., meaning all their location level fields are empty) would match any query for a given city in the world.

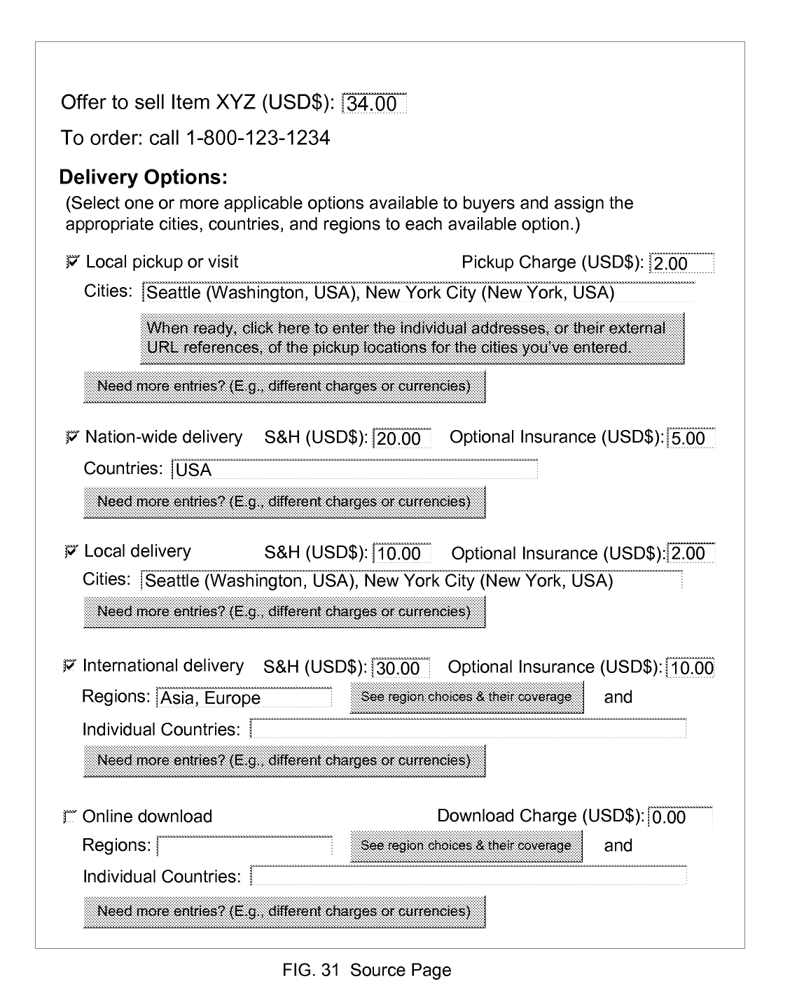

FIG. 31 “Source Page” shows an entry page where a seller can specify all relevant shipping charges for an offer. There are different delivery options with their specific shipping and handling charges as well as optional insurance charges. The seller can freely assign the locations of different levels (from a city level to a regional level, each region comprising a pre-defined list of countries) to each of these delivery options and specify the corresponding charges.

A completed entry page as such would not produce a useful indexed page when a query wants to consider the shipping and handling charges for a specific location of delivery. A method of the current state of art is to ignore these charges in the retrieval and comparison of offers. Another would try to calculate the location-specific shipping or tax charges from the retrieved pages of offers based on the user's delivery location of interest, and then re-rank the pages.

One drawback of this approach is that the search engine would need to perform calculation on every single offer in the result pages after their retrieval. And this calculation is taking place at the most costly moment in terms of operational timeliness when the user is waiting for a definitive answer to his query.

A better approach in this regard is to generate all possible pages before indexing, one for each unique charge amount (and even per applicable currency if warranted), in addition to the consideration for the appropriate location-specific matching as described earlier. (And location-specific pages could also contain location-specific information other than prices, e.g., terms of warranty for the product.)

With respect to optional charges such as those for shipping insurance, pages would be generated for each variation with and without a specific option charge. At the query time, a query may explicitly differentiate between offers with optional charges included and those excluded, or it may simply retrieve all offers with or without optional charges. The search engine would automatically arrange those without optional charges as having a higher ranking than the equivalent offers with the optional charges when ranking the result pages according to price.

For example, for the entry page in FIG. 31, seven pages are generated applicable to the delivery location “Seattle (Washington, USA)”: one for a local pickup charge of US$2, one for a local delivery charge of US$10 (i.e., no insurance), one for a local delivery charge of US$12 (i.e., insurance cost included), one for a nation-wide delivery charge of US$20 (i.e., no insurance), and one for a nation-wide delivery charge of US$25 (i.e., insurance cost included). Hence if there is a consumer living in Seattle looking for a bargain and willing to visit the store in person, then he would choose the offer with a local pickup charge of US$2. Should he have no time for a store visit, he could opt for the offer with a local delivery charge of $10 without insurance, or of $12 with insurance. The offers with nation-wide delivery options from the same seller for the same delivery or pickup location would logically be less desirable to this consumer. Consistent to this logical preference, the corresponding indexed pages of these offers would systematically be ranked in the result below those whose offers are more desirable (and therefore relevant) to the consumer submitting the query.

### Example Embodiment and Its Operation

A search engine would provide an entry page (similar to the one in FIG. 31) for a vendor to fill in product-specific information such as model number and price, as well as location-specific information such as the delivery and tax charges for each applicable location of various location levels (i.e., region level for multi-countries, country level for nation-wide, state level for state-wide, and city level for city-wide). Upon completion of the entry, the search engine would generate a page for each combination of applicable location (with its different location-level applicability fields filled in as appropriate), the delivery charge and the tax charge. A new field is also inserted into the resultant page that captures the total cost of ownership for the item for each applicable location. Afterwards, the search engine would index all these generated pages each representing a location-specific offer for an item, produce an indexed page for each, and make all of these indexed pages available for query.

The search engine would likewise provide an entry page for query on indexed offers just described. A user would specify his location of delivery and the keywords for the description of the offer as part of the query request. Then the search engine would perform matching between the query and the pages of offers maintained in the index. The multi-line summary for each of the offers that match both the location (in the manner described above) and the offer description would become an offer excerpt in a query result page, and the offers that have the lowest cost of ownership for that particular location of delivery or pickup would have their summaries ranked higher than others in the query result page. Such a query result page may be broken into multiple sub-pages for presentation to the user.

### A9. Embodiment for Online Negotiation

People have been buying and selling online with each other with great success. Transactions on online auction websites have exceeded billions of dollars and are growing. Yet the interactions between the buyers and sellers remain quite simplistic. Online negotiations that go beyond just the per-unit pricing become perilous, because both parties, without the help of professional assistance, may not use or set the terms correctly to establish a valid contractual agreement. In fact, people may be negotiating the specifics of an offer, such as the item of interest, price, delivery location or method, and other terms or conditions relevant to the offer.

Embodiments of the present invention provide an automated intermediary that assists the negotiation and agreement setting between two parties. Such a party may be a person, a piece of software, a machine, or a combination thereof, such as an application running on a computer requiring partial input from a user. The two parties first agree on the subject matter, e.g., buy and sell a house. In accordance to the chosen subject matter, the intermediary would prompt for or otherwise interpret input from these parties. It then ascertains their intention by presenting to them legally or contractually binding statements for their acknowledgement or confirmation that construe to their intention. The intermediary would track each agreed-upon statement as well as statements not yet agreed-upon. When all relevant statements pertinent to the negotiation of the chosen subject matter are agreed upon, both parties would then have a legally or contractually binding agreement for their negotiation. The collection of these binding statements shall be considered effective under a certain jurisdiction to which both parties agree.

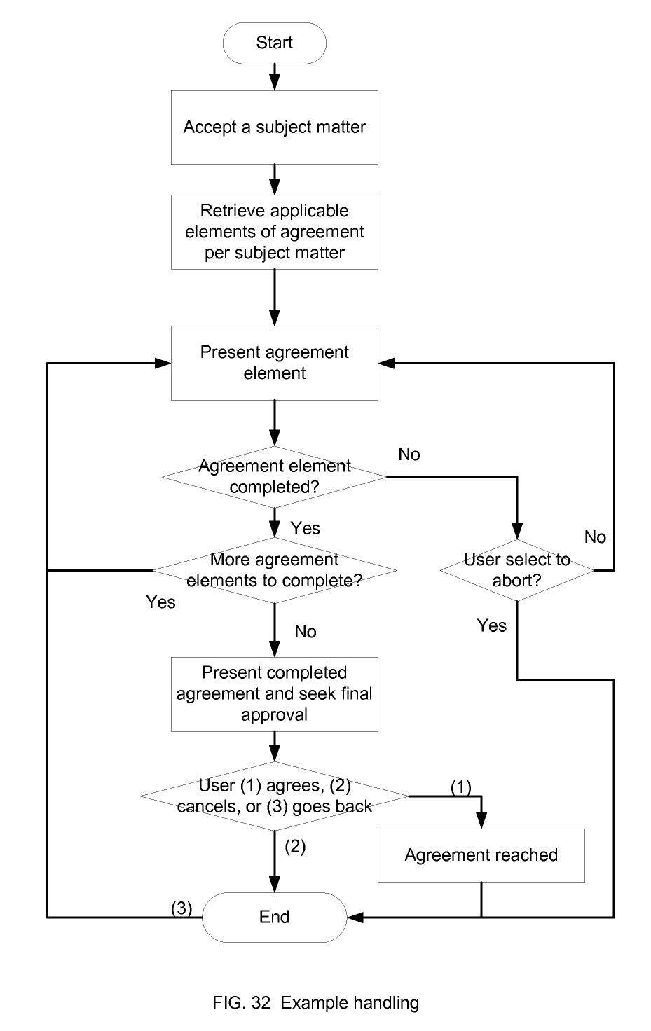

FIG. 32 “Example handling” is a flow diagram illustrating how such negotiation may be handled or otherwise executed according to one embodiment of the invention. A system, method or process executing, comprising or otherwise embodying the logic in shown in FIG. 32 would accept a subject matter (e.g., from a list or pre-defined subject matters) from both parties or users. It then retrieves the elements of agreement (i.e., agreement elements) applicable to the subject matter. It presents each applicable agreement element in turn and lets each user to input and change the details of the agreement element until both users confirm their agreement on or otherwise are satisfied with the details of the agreement element.

Agreement element may be parameterized. For example, an agreement element may be a statement such as “I will pay X amount in Y currency”, where X is a parameter for the numerical amount and Y a parameter for the currency which may be code-based. Negotiating parties or users would then provide values for these parameters. A user may disagree with the value provided by another user. An agreement element is said to be in agreement between both parties or users when these users agree on both the values for the parameters and the statement(s) making up the agreement element comprising these parameters assigned with the values. An agreement element may incorporate or otherwise refer to previously agreed, tentatively or otherwise, agreement element. And an agreement element may pertain to different aspects of an offer, including but not limited to the item of interest, price, delivery costs. In addition, two different but complementary descriptions for the same agreement element may be presented to each of the users. For example, a buyer may be prompted for entering and confirming the amount to sell an item, while a buyer for entering and confirming the amount to buy the item. According to one embodiment, a seller may be prompted to provide a selling price before a buyer for her buying price.

Either user may also choose to abort the negotiation during the negotiation of an agreement element. Should the users choose to continue, the next applicable agreement element would be presented to them for further negotiation, until all applicable agreement elements are presented and agreed upon or otherwise tentatively accepted. Then the complete agreement comprising those applicable agreement elements is presented to each user for final review and acceptance. An agreement is reached when both users confirm their acceptance, otherwise, a user may request to restart the negotiation or otherwise re-visit a specific agreement element. In addition, she may choose to cancel the negotiation.

The sequence or order of presentation of agreement elements need not be sequential. The presentation of agreement elements and their interdependencies may be controlled or otherwise specified in a computer program or computer-readable description file that may used or otherwise adopted for one or more subject matters. (For example, such a program or file may be maintained in a subject matters repository, shown below.) In addition, agreement elements may be specified in different languages while having the same or equivalent meanings, indications, or semantics for the purpose of negotiation. They may be legally binding in accordance to a jurisdiction mutually agreed upon by both parties as part of the pre-conditions for such negotiation.

### Example Embodiment and Operation

FIG. 33 shows a negotiation embodiment of the present invention. A Negotiation Server interacts with two Language Clients of different languages, e.g., French and English. The negotiation server may conduct negotiation in accordance to the logic shown in FIG. 32, or some other logics embodying the present invention. Language Client X represents User A in interacting with the Negotiation Server, and interacts with User A. Likewise, Language Client Y represents User B, and interacts with User B. For example, User A wants to buy a car, so he selects the subject matter “Buy a car” through Language X Client. User B, on the other hand, wants to sell a car, so he selects the subject matter “Sell a car”. User A finds that User B's car for sales is what he is looking for, so User A initiates a negotiation with User B with respect to User B's car for sales. Since “car buying and selling” is one of the subject matters that the Negotiation Server supports (e.g., via a Subject Matters repository), the Negotiation Server could provide the automated legally or contractually binding negotiation assistance between User A and User B. First, Users A and B would agree, either beforehand or at the time of negotiation, that they would both agree to the same or compatible jurisdiction on which the collection of binding statements or agreement elements for the subject matter of interest is based. This collection of binding statements or agreement elements is maintained at the Contractually Binding Statements (CBS) Repository with which the Negotiation Server consults. (The language in which these binding statements are written may yet be another language other than Languages X and Y.)

The Negotiation Server would provide a list of pertinent binding statements or agreement elements that are relevant to User A in Language X (e.g., as a buyer in English), and ones that are relevant to User B in Language Y (e.g., as a seller in French). These statements or elements are translations of the pertinent binding statements or agreement elements in the CBS Repository, and these translations are approved for use for the purpose of legally or contractually binding negotiation.

Instead of or in addition to selecting from a list of binding statements through Language X Client and Language Y Client, User A and User B may also enter freeform text of their intention, and the Negotiation Server would paraphrase their entries with statements from the CBS Repository. Further iteration of the same entry would then result in one or more specific binding statements that describe the user's intention.

In a car selling and buying example, User A would want to get the car's ownership transfer complete within one week and the price less than US$7000. His intention may then be summarized in the following two binding statements for User B to accept:
1. A car with registration #1224232, make Toyota, model Celica, year 2000, be transferred to User A on or before May 17, 2007.
2. The price User A would pay for said car would be US$7000.
   User B would see these statements in his own language (i.e., Language Y). He can choose to accept or counteroffer these statements. Then User A would see User B's responses as binding statements in User A's language (i.e., Language X). If those two statements are the only pertinent binding statements in their car selling and buying negotiation, and both User A and User B have reached agreement on all of them, then the negotiation is complete, and is deemed legally or contractually binding under the jurisdiction to which both users have agreed to.

According to an embodiment, a party to the negotiation may have pre-selected a subject matter and a set of agreement elements as well as ranges of values for the corresponding parameters. Such a party, whether a machine, an application or a human, provides a standing negotiable offer for another party to consider and participate in its negotiation.

### A10. Embodiment for a Software Entity Naming Scheme

An computer resource or software entity such as a file is usually associated with a name or handle. An offer such as one described in form or format similar to those shown in FIG. 23, FIG. 24, FIG. 25, FIG. 26, and FIG. 27 may be stored or maintained in a file. As the details or specifications of an offer may change over time, an offer file may also be modified over time. To allow a user to quickly know the version of an offer file when there could be multiple versions available, one may specify some metadata (e.g., version number, date) as part of the filename, so that the user does not need to open the file or study the attributes of the file to obtain that information, if available. However, when a new version of file for the same offer (e.g. with a later version number or date) arrives, it will not replace the current version (e.g., an outdated one) because the filename would assume a different name, e.g., having a different version number or date, unless the user manually replaces the current version with the new one.

According to one embodiment of the present, a computer resource or software entity handle or identity (e.g., a filename) comprises a plurality of metadata such as creation date, modification date, author name, reviewer name, and so on. In addition, such a handle or identity would change automatically when the constituent metadata have changed. For instance, the present invention provides a method for providing a handle or identity for a software entity such as a computer file or program, comprising identifying metadata such as a last saved date or a publisher or author's surname associated with said software entity; generating said handle or identity comprising said metadata, whereby said handle or identity would be modified or updated so to comprise new metadata should said metadata be changed either by a system or user to arrive at said new metadata.

Furthermore, a metadata-independent part (i.e., an invariant name part) of a software entity handle or identity so generated and maintained may be used to group or otherwise identify the specific software entities or instances that share the same metadata-independent part. For instance, two files “read me_{—}1Sep08-143034n04PST” and “read_me_{—}2Sep08-121130n01PST” would be related if “read_me” is the metadata-independent part, and “_{—}1Sep08-143034n04PST” and “_{—}2Sep08-121130n01PST” are the metadata-dependent parts (i.e., variant name parts) under a software entity naming scheme embodying the present invention. Optionally, the paths to these files (e.g., C:\abc\ and C:\def\) may or may not be regarded as a metadata-independent part of a software entity in relation to determining whether two files are related.

In addition, a file may usually be associated with one or more attributes, such as author, creation time, modification time, that a filesystem embodying the present invention may allow a user to select as an invariant name part of the file. Furthermore, an application embodying the present invention may allow a user to define or specify metadata not available as file attributes native to the filesystem, such as a version number, and use them as invariant name parts.

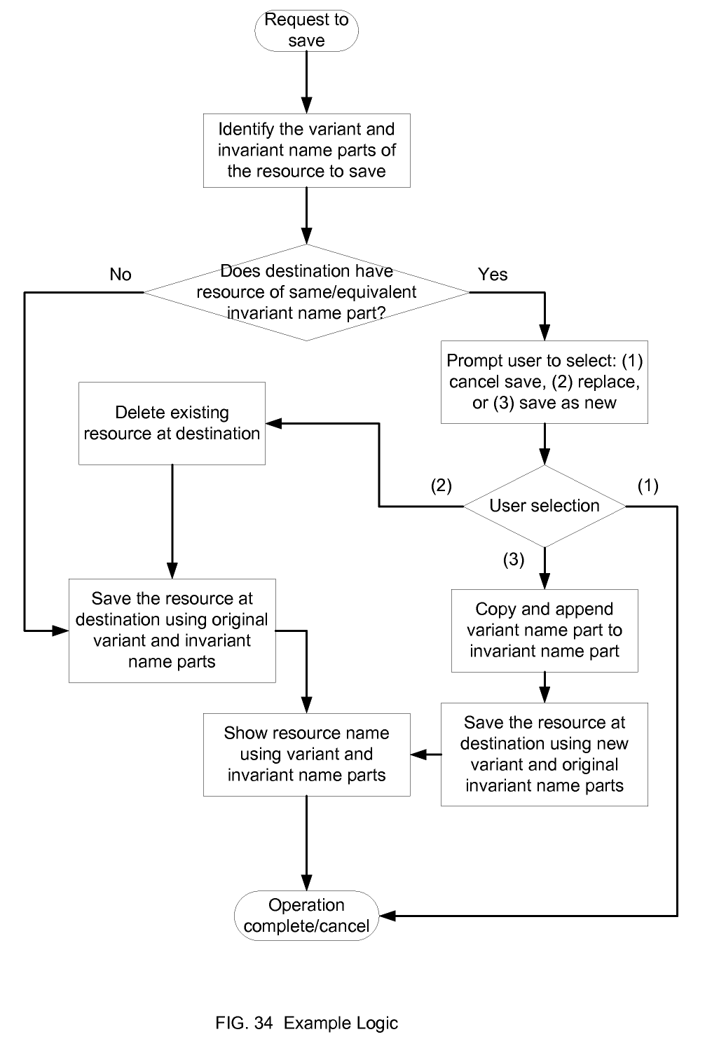

FIG. 34 “Example Logic” is a flow diagram showing how a system or application equipped with the present invention may handle a request to save a file comprising a variant and invariant part to a destination (e.g., a folder on a computer filesystem). The system or application would identify the variant and invariant name parts of the file (i.e., the resource to save). It checks whether the destination already has an existing file having the same or equivalent variant name part. If there isn't, then the file will be saved to the destination, and both its variant (e.g., its file type-indicating file extension such as “.doc” and invariant name parts (e.g., last modified time) will be shown as its filename. Otherwise, the user is prompted to select whether he wishes to cancel the save request, replace the existing file with the new one, or save the new one without replacing the existing file. Selecting cancellation would abort the save operation, leaving the existing file intact and the destination unchanged. Selecting the replacing of the existing file would delete the existing file and saving the new file using its original variant and invariant parts as the filename for display. Selecting the saving of the new file as new would copy the variant name part of the new file and append it to its invariant name part, and save the new file at the destination using the new invariant name part and original variant name part, which are also used for display name. The existing file remains intact and the destination now has one additional file.

According to one embodiment, a user's prior approval may result in the new file replacing the existing one of matching invariant parts without any prompt or confirmation. In another embodiment, selecting the saving of the new file as new would move the variant name part of the new file and append it to its invariant name part, thereby leaving the variant part empty.

An embodiment of the present invention is a file system or operating system on a computer, where a user may activate an automatic file naming scheme embodying the present invention. Under such a scheme, the user would pick a piece of metadata of interest (e.g., last modified date), and whenever he creates or changes a data file (e.g., as identified by the filename extension), the current metadata of interest would be appended or inserted by the system to the user-changeable or invariant part(s) of the name of the data file (i.e., “<user changeable_filename_part>̂<system_maintained_metadata_part>.<filename extension>”, where the “̂” character denotes a special or reserved delimiter which cannot appear anywhere else in the filename). The file system or operating system would be configured to perform operation logic similar to that shown in FIG. 34 to handle requests to save files comprising variant and invariant parts.

One skilled in the art shall find the description of the present invention sufficient to realize the example embodiment specified herein, its variations, as well as other embodiments and related developments under different considerations, whether technical, commercial, administrative, functional, operational, esthetic, or otherwise, in accordance to the present invention disclosed herein.

### A11. Embodiment for GPS-Ready Code Image

A personal navigation assistant device, such as one equipped with a GPS (Global Positioning System) module and other facilitating components (e.g., an antenna, a visual display, and a keyboard or touch screen), enables a person carrying the device to not only know his current geographical location, but also plan itineraries and obtain directions to destinations based on names, addresses, latitudes and longitudes, and so on. While names and address may change over time or be incomplete for a given locale, GPS-ready location entries such as those using latitudes and longitudes are reliable and universal. A most basic GPS device would be able to work with or produce this type of information. Planning his itinerary online, a user may first obtain GPS-compatible positioning coordinates and convert them into a plurality of GPS-ready location entries, and then manually enter these entries into his personal navigation assistant device for use during his travel. However, this manual entry process is tedious and at times error-prone.

The present invention disclosed herein would solve this problem, and provide other advantages, such as the automatic creation of a GPS-capable or GPS-ready contact entry from an exhibit, whether a printed material, an online webpage, or some other visual display. For instance, the present invention provides a method of providing content with the use of a code pattern in a user terminal, the method comprising: photographing, capturing or otherwise reading an image of said code pattern (e.g., a barcode) which contains code information corresponding to geographical coordinates, latitude/longitude positioning and the like (i.e., GPS-ready location entries), as well as optional data such as textual or multi-media description or advertisements; extracting from said image said code pattern and analyzing said code pattern to arrive at said code information; sending said code information to said user terminal, wherein said user terminal interprets said code information and presents a map, visual or otherwise, indicating a plurality of locations in accordance to said GPS-ready location entries contained in said code information. Said user terminal may present said optional data as part of said map or as individual audio and/or visual pieces independent of said map. Said user terminal may also remember said code information so interpreted for recall or for other operations, such as calculating routes from or to said plurality of locations.

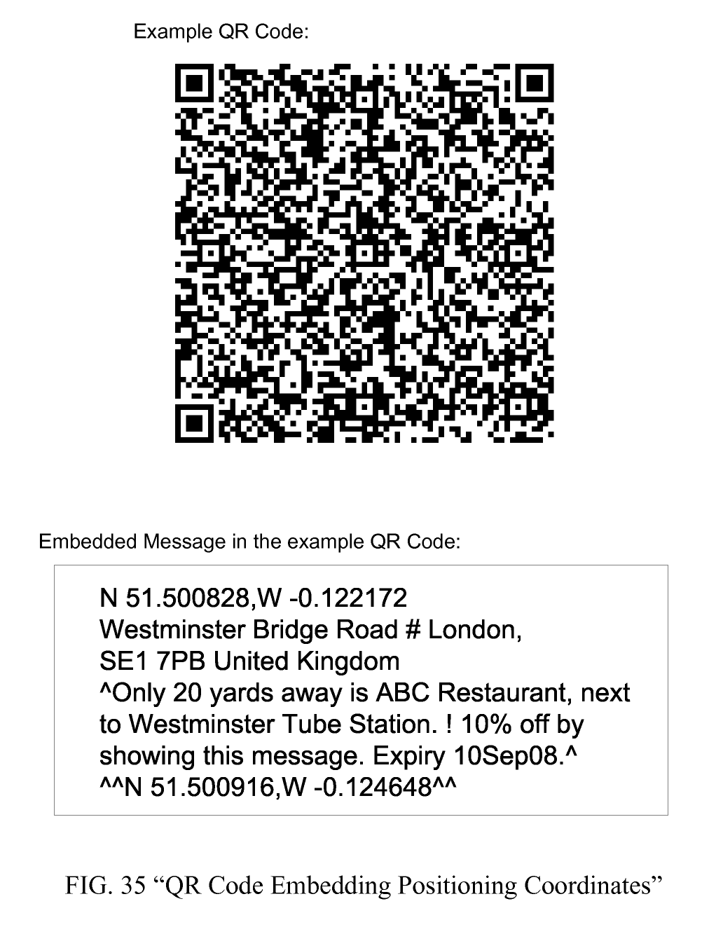

FIG. 35 “QR Code Embedding Positioning Coordinates” shows an example QR code and its corresponding message embedded in the code. The first line of the message (i.e., “N 51.500828,W −0.122172”) is a GPS-ready location entry that a compatible GPS device would be able to identify without ambiguity a specific location or geographical point on a map. Some minimal decoding may be required of the GPS device or its proxy, such as extracting the specific pieces of the data using space, comma, and end-of-line character as delimiters. The second and third lines of the message (i.e., “Westminster Bridge Road # London,” and “SE1 7PB United Kingdom”) are textual information such as an address that corresponds to the GPS-ready location entry. The subsequent lines of the message show an advertisement delimited, or prefixed and post-fixed, by a respective “̂” character, as well as another GPS-ready location entry delimited, or prefixed and post-fixed by respective double “̂̂” characters. This second GPS-ready location entry would correspond to the advertisement. An example use of the message embedded in the example QR code in FIG. 35 would be for a compatible or otherwise capable GPS device to show the advertisement momentarily before presenting a map marked in the center the location of the first or primary GPS-ready location entry, along with the location of the second or secondary GPS-ready location entry in relation to the location of the first. The device would allow its user to recall later the primary GPS-ready location entry along with its description, the advertisement along with its GPS-ready location entry, or both of them at the same time.

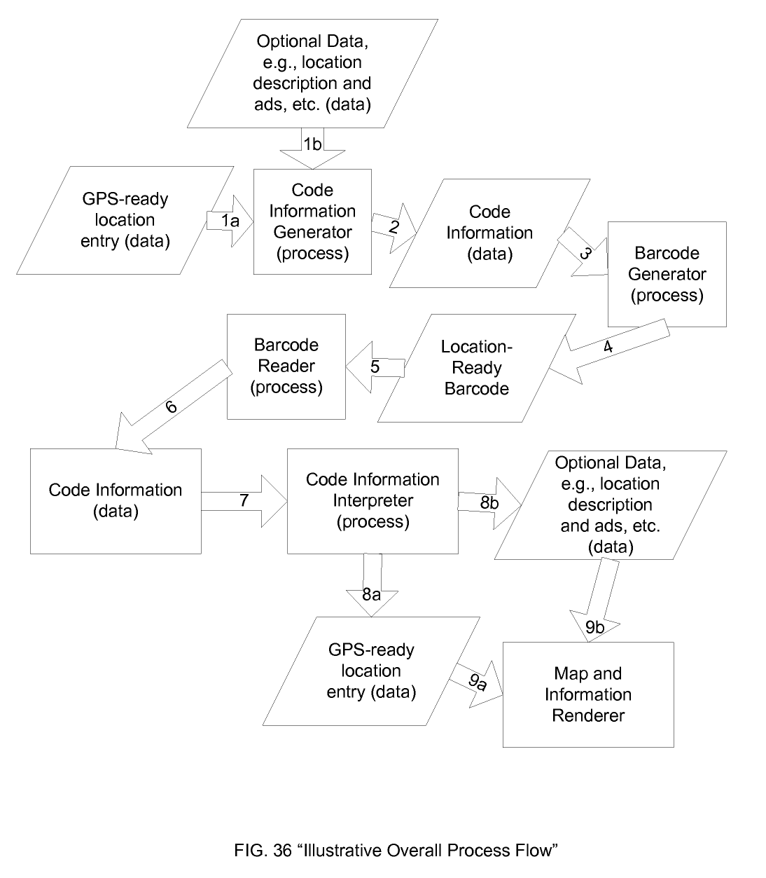

FIG. 36 “Illustrative Overall Process Flow” shows how a location-ready barcode such as the QR code shown in FIG. 35 may be generated and consumed. Given a GPS-ready location entry and its associated data (such as location description, an advertisement text, and another GPS-ready location entry corresponding to the ad text), a code information generator would produce the corresponding textual data, an example of which is shown in FIG. 35. The resultant code information (i.e., the textual data) would be processed by a barcode generator (such as a QR Code generator) to produce a code-embedding image, or the so-called location-ready barcode. Up to this point the process for the location-ready barcode generation alone is complete. To consume such a barcode, a compatible device capable of processing the barcode would read the barcode, extract the code information from it, and interpret the extracted code information so to isolate the individual pieces of data, such as the primary GPS-ready location entry, the location description, the ad, and its corresponding GPS-ready location entry. The device would then render and present these pieces of data accordingly, such as locations marked on a map and textual information on separate pages or screens. While for a typical mode of operation, the location-ready barcode generation is accomplished through a single system and the consumption is through another individual device, a single system may encompass the entire process of both location-ready barcode generation and consumption (e.g., for testing), or multiple devices (e.g., a separate barcode reader and a separate GPS device) would work together to facilitate the consumption.

An example embodiment of the present invention for the location-ready barcode consumption process is a GPS-capable mobile phone equipped with a camera. A piece or a collection of software implementing the process so described on the mobile phone would prompt a user to aim at a GPS-ready location barcode. With or without explicit user acknowledgement, the software would process the barcode image captured or otherwise made available through the on-phone camera. It extracts the code information from the image, interprets the individual data pieces contained in the code information, and renders or otherwise presents such data on the device's visual display and/or audio output, such as maps showing locations corresponding to the GPS-ready location entries in the code information, as well as location descriptions and advertisements also contained therein. In addition, the software or some other ones on the mobile phone may provide other operations such as itinerary planning as well as travel distance and time calculations using the GPS-ready location entries so imported.

For the location-ready barcode generation, a person may manually create the code information (such as the one shown in FIG. 35), and then submit it to a barcode generator. Or through an online webpage, he may simply enter a street address or a name of a location of interest, and a backend system supporting the webpage would generate onscreen a GPS-ready location entry corresponding to the user entry, and create directly a location-ready barcode that embeds the code information containing the GPS-ready location entry, along with other data, such as the location description and advertisements. The user would now be able to use a compatible device to read or otherwise capture the resultant location-ready barcode. In addition, location-ready barcodes may appear on any exhibit, such as newspapers, magazines, webpages, and so on. The webpage at http://itouchmap.com/latlong.html, for instance, would provide geographical coordinates in response to user queries of street addresses. As an embodiment of the present invention, the resultant geographical coordinates may be made into a GPS-ready location entry, which would then be transformed into a location-ready barcode using a barcode generator available in the art. The resultant location-ready barcode would be presented onscreen to the user as a result to his query.

Various software and hardware modules and APIs (Application Programming Interfaces) for GPS-ready location entry generation, submission and map rendering, barcode (e.g., QR codes) generation and decoding, and so on are available in the art for building the software and hardware such as the ones described above for location-ready barcode generation and consumption. One skilled in the art shall find the description of the present invention quite sufficient to realize the example embodiments specified herein, their variations, as well as other embodiments and related developments under different considerations, whether technical, commercial, administrative, functional, operational, esthetic, or otherwise, in accordance to the present invention disclosed herein. For instance, many possible types and various formats exist for a GPS-ready location entry, such as the British National Grid Reference System and the formats “h ddd mm ss.s”, “h ddd mm.mmm”, and “h ddd.ddddd”. Barcode technologies other than QR code may be used. The advertisements accompanying a location-ready barcode may be presented only once before the map showing the locations corresponding to the GPS-ready location entries is displayed. Subsequent recalls of the corresponding code information may suppress the advertisement presentation. A phone book, appointment, or contact application may be equipped with the present invention so that its records comprise GPS-ready location entries. A device equipped with the present invention may receive a location-ready barcode as messages or data through a communication network, rather than optically capturing or reading it, although the latter may have advantages over the former in privacy, accessibility, and cost.

### A12. Embodiment for Providing Efficiency in Commerce and Association Via Item Identity and Attributes

Many ways of grouping and classifying individuals and demographics have been devised for various purposes, from consumer research to political campaigns and dating services. For instance, a market researcher might design or brand a particular product or service based on some target demographic. Products and services that consumers may buy or use are often treated as a result of some analysis, or as a consequence, to some marketing campaign.

According to one embodiment of the present invention, a system, an apparatus, and a method are provided whereby the items that individuals buy, use, or otherwise like to be associated with define or characterize the individuals. That is, “We Shop What We Are.” These individuals are grouped, associated or otherwise related in accordance to such definition or characterization for the purpose of, for instance, communication or information sharing among them.

For example, a method is provided for creating or forming an association or group of individuals through a plurality of products and services, comprising:
identifying each said product or service with a unique item identity code, such as UPC;
accepting or receiving from or for each said individual a plurality of item identity codes;
associating a unique member identity code with each said individual;
storing or maintaining said member identity code in association with said plurality of item identity codes;
identifying member identity codes whose associated item identity codes match to a certain degree, e.g., 100% or 8 out of 10;
associating explicitly a group identity code to each said member identity code or otherwise forming said member identity codes without an explicit group identity code into a group; and
enabling electronic communication, information sharing or data manipulation exclusive to or otherwise in relation to said group, whereby said association or group of said individuals would in effect be created or formed.

To facilitate the matching of common products and services, according to one embodiment, an electronically identifiable item identity code such as UPC (Universal Product Code) or RFID may be assigned or otherwise associated with a product or service in such a way that two different products or services would not share the same code. A single product or service, on the other hand, may have multiple codes. An individual such as a consumer would pick a plurality of item identity codes that he considers adequate or suitable to define, characterize or describe him or otherwise provide a representation of him (or those whose products and service he has really bought or consumed, which could be proven with invoices or credit card slips that bear his name). Such an individual would be assigned or otherwise given a member identity code that is different from the member identity codes of other individuals. His chosen list of item identity codes would be associated with his member identity code so that comparison may be made among a plurality of item identity code lists and the member identity codes of the corresponding individuals be identified or otherwise discovered. Member identity codes whose associated item identity code lists being deemed matched through certain criteria (e.g., with eight matching item identity codes) would be treated, regarded or otherwise associated as a group. Through their member identity codes, the individuals would be able to communicate or share information with other individuals in the same group (e.g., through an electronic bulletin board as in a discussion forum, or through a private communication channel between two individuals in the same group as in dating services). In addition, an individual via his member identity code may qualify for more than one group, depending on the criteria used for matching item identity code lists, and he may also have more than one item identity code list. , According to another embodiment, two otherwise different items may be considered equivalent per some criteria or specifications. For example, they may share the same brand and/or product category, such as men's jeans considered being equivalent to women's jeans of the same brand and/or style, even of different sizes and colors. An identity code or identifier may be assigned to a brand or style, or any attribute relevant to an item of interest for the purpose of matching, similar to an item code. Furthermore, a description, whether textual or visual, may be used in addition to or in lieu of an identity code to identify an item or an attribute of an item for the purpose of matching and connecting like users.

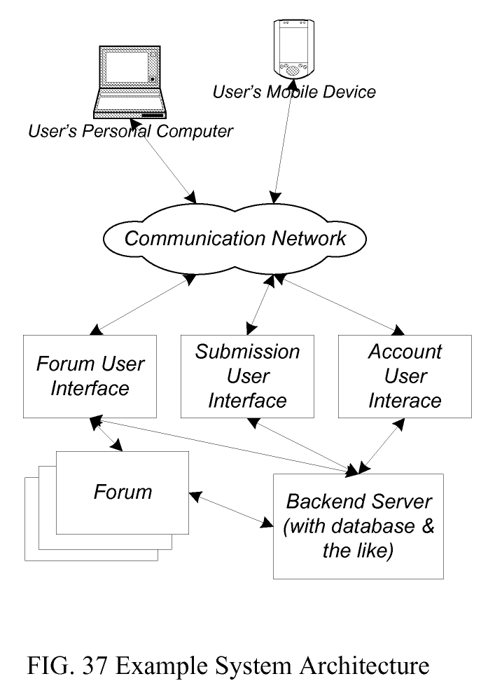

FIG. 37 “Example System Architecture” shows an example implementation comprising:
An electronic account user interface, such as a webpage, is set up with which an electronic user account may be created and maintained for each individual or participant. The user account number or ID would serve as a member identity code. Each user account contains an item identity code list capable of storing up to, e.g., ten, identity codes and a group identity code list capable of storing a plurality of group identity codes each of which, for example, may be made up with a concatenation of a plurality of item identity codes or represented by a set of the individual item identity codes. A user account may also be associated with other information such as a password and email address.
An electronic submission user interface, such as a website or a text message-receiving phone number, is set up for participants to submit UPCs as item identity codes against their own account ID after proper user authentication (e.g., password logon or verification of the phone number of the text message-sending phone).
A backend server is set up to update the item identity code list of each electronic user account for which the electronic user interface has received UPCs, and compare the item identity code lists of all the user accounts for matching UPCs (e.g., any five matching UPCs).
An electronic forum would be set up when there are two or more item identity code lists having a specific number (e.g., five) of UPCs in common, if there is not such a forum already available. The forum ID would be created using, for example, a concatenation of the matching UPCs first sorted in ascending or descending order, or an identifier comprising the matching UPCs as a set, making their order irrelevant. (A forum ID would also double as a group identity code. Subsequently, the server would update using such a forum ID the group identity code lists of the user accounts involved.)
An electronic forum user interface, such as a website or an electronic text message center, is set up for participants to access an electronic forum whose forum ID is contained in the group identity code list of their user account, after proper user authentication. When a group identity code list has more than one forum ID, then the participant of the corresponding user account may select at any given time which forum to access.

Additional features such as changing the list of UPCs associated with a user account are possible. One skilled in the art would be able to provide additional functionality as well as various embodiments including the example embodiment presented above in accordance to the disclosure presented herein.

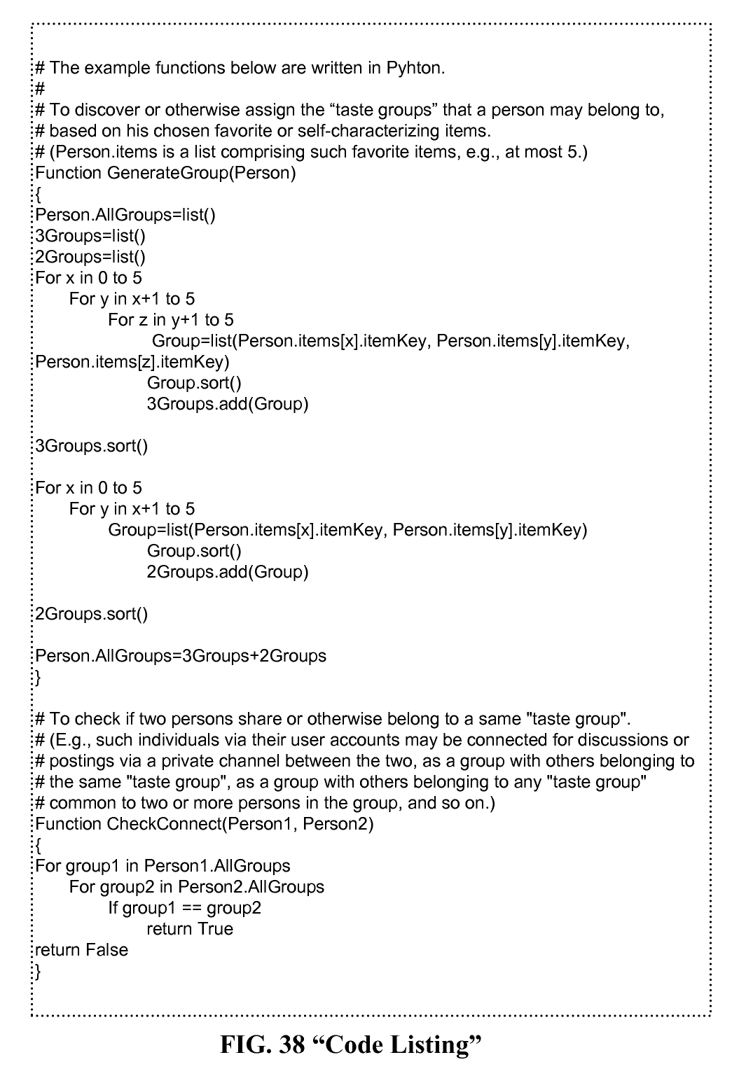

FIG. 38 “Code Listing” shows two functions, namely GenerateGroup and CheckConnect, including example code for discovering or generating “taste groups” (i.e., entities with group identities) that a person or user may share or belong to based on his chosen favorite or self-characterizing items, and checking if two persons or users share or belong to a same “taste group”, respectively. Function GenerateGroup assumes a maximum of five favorite items (uniquely identified by an item key, e.g., itemkey). A “taste group” is represented by any two or three unique items or item keys. A person is deemed to belonging to a “taste group” if the favorite items chosen by the person match the two or three items representing or otherwise identifying that “taste group”. Given these constraints and definitions, a person may at most belong to 5C2+5C3=20 “taste groups”. A person may connect to another person if both share or belong to at least one “taste group”.

For example, Person X selects item A, B, C, D as his favorite items to represent his own taste. Person X would therefore belong to “taste groups” AB, AC, AD, BC, BD, CD, ABC, ABD, BCD, ABCD. Person Y selects item A,D, E, F, G as her favorite items to represent her own taste. Person Y would therefore belong to 20 “taste groups”, with one of which being AD. Since John and Mary both belong to the “taste group” AD, they may be connected.

In addition, such individuals via their user accounts may be connected for discussions or postings via a private channel between the two, as a group with others belonging to the same “taste group”, as a group with others belonging to any “taste group” common to two or more persons in the group, and so on.

Any component or subsystem in an embodiment having access to user IDs and the item IDs of the items chosen as favorite by users with the user IDs may perform “taste groups” discovery and grouping of users per their chosen tastes, as illustrated above. For example, the Backend Server shown in FIG. 37 may implement and execute these functions.

To use the example embodiment shown in FIG. 37, a participant would visit the electronic account user interface (e.g., through a URL) to provide a unique username, a password and email address so to create a user account. Then he may use the electronic submission user interface (e.g., through a URL) to submit up to ten UPCs. He will receive a notification via email when five of the UPCs registered at his account match five UPCs registered at another user account. The notification would list the matching UPCs and the URL to access the forum corresponding to the five UPCs. In addition, he would be presented the available forums to access when he visits the electronic account user interface.

Instead of or in addition to an electronic forum (e.g., for socializing or product information sharing), a one-on-one communication channel may be set up between two consenting participants within the same group (e.g., for technical support or dating services). Other forms and setups for the outcome of the grouping or association are also possible, such as one where members in the group do not need to be aware of or know the identity of other members in the group.

For instance, a consumer may submit an entry of offer intelligence or information (e.g., from his previous purchases or shopping trips) to a central server. An entry of offer intelligence would contain an item identity code such as UPC, a vendor name and address or its equivalent (e.g., a URL), a quantity (with default of one) and a price. The server would then make available to the consumer all its available entries of offer intelligence or information related to the item in question or its equivalent through the matching or comparison of item identity codes. The consumer would subsequently have access to entries that the server has received and will be receiving from other consumers. An example method or process for sharing pricing information among users having interest in a common item comprises:
accepting from said users a submission comprising a price against said common item from a provider and associating said submission with a user identity;
sending electronically said submission over a communication network or channel;
providing a means for receiving said submission over said communication network or channel;
retrieving said user identity from said submission;
storing said submission along with other submissions of said common item herein as a collection of submissions against said common item;
associating said user identity into a group with user identities of other users who have sent submissions of said common item if such association is not already in existence;
making available for electronic or online distribution or retrieval said collection of submissions or information contained therein (including but not limited to said pricing information) to said users or their proxies via their user identities which belong to or are otherwise associated with said group.

One of the advantages of the pricing information-sharing method described above is the ease with which to connect consumers having interest in the same or similar items to share information such as availability and prices. For example, a consumer who have bought or otherwise discovered a price for an item of interest would be encouraged to submit such information to a system which would in turn make available the information it keeps or otherwise maintains for the item or other items in the same category or group by some classification or evaluation scheme. An example arrangement may be such that a consumer would have access to the past, current and on-going availability and pricing information of items (or other items of the same category) in the locations of his interest for which he has provided an electronic offer submission to the system where other consumers would also send their electronic offer submissions to. This arrangement would create a community of willing consumers who would help one another to become informed about available offers for items of common interest. Every offer submission would become a historical reference for an item of interest, every new consumer submitter to the community is a potential contributor to and beneficiary of such an offer collection system, and every new item made known to the system is a seed to pricing transparency and efficiency for the item. As the community grows in size in terms of items, members, locations and submissions, an informed market would emerge. That is, each submission in effective would become a history in the life of an offer. And each offer could serve as a comparison with other offers for the same or similar items of interest if their providers serve the same locations of interest. This would enable a consumer to make informed decisions for his acquisition of the items specified in these offers. A vendor would also need to become more competitive in an environment where the current and past offers of heterogeneous items could readily be made available. This results in a much more efficient marketplace as a whole since sellers could no longer rely on the lack of price transparency in pricing their offers, unless their customers agree or otherwise decide not to disclose what they paid.

With the ubiquity of camera-equipped mobile phones and advances in microprocessors and image processing, many consumers and users alike would often carry a mobile phone capable of taking a photo and performing processing on the image of the photo. As such a mobile phone is a good candidate platform for making an offer reporting device through the installation of a software application embodying the offer reporting functionality.

As such, this innovative scheme of association and grouping by means of a plurality of product and service codes would be useful in many other applications where what one buys or uses is considered as a defining characteristic and where there is an interest to connect, organize or otherwise associate people in terms of such characteristics.

It is to be understood that the examples and embodiments described above are for illustrative purposes only and that various modifications or changes in light thereof will be suggested to persons skilled in the art, and are to be included within the spirit and purview of this application and scope of the appended claims. Therefore, the above description should not be understood as limiting the scope of the invention as defined by the claims.

What is claimed is:

1. A computerized method for storing an offer for a product in an offer database system, the computerized method comprising:
receiving in an offer database system offer information for a first offer of a product, wherein:
the offer information includes a set of invariant offer information and a set of variant offer information,
the set of invariant offer information includes a seller identifier and a product identifier, and
the set of variant offer information includes a price for the product;
determining by the offer database system if a second offer for the product is stored in the offer database system;
if a second offer is stored in the offer database system, determining by the offer database system if another set of invariant offer information and another set of variant offer information in the second offer respectively matches the set of invariant offer information and the set of variant offer information, wherein the other set of invariant offer information includes another seller identifier and another product identifier, and the other set of variant offer information includes another price for the product;
if the set of invariant offer information and the set of variant offer information respectively matches the other set of invariant offer information and the other set of variant offer information, maintaining in the offer database system the second offer unchanged;
if the set of invariant offer information and the other set of invariant offer information match, and if the set of variant offer information and the other set of variant offer information do not match, modifying in the offer database system the second offer to include the set of variant offer information;
if the set of invariant offer information and the other set of invariant offer information do not match, storing the first offer in the offer database system; wherein the first offer is a new entry in the offer database system and includes the offer information; and
if a second offer for the product is not stored in the offer database system, storing the first offer in the offer database system; wherein the first offer is a new entry in the offer database system and includes the offer information.

2. The method of claim 1, wherein the modifying of the second offer in the offer database system includes associating the other set of variant offer information with the set of variant offer information.

3. The method of claim 2, wherein the modifying of the second offer in the offer database system includes associating a first time with the other set of variant offer information and a second time with the set of variant offer information, wherein the first time is chronologically earlier than the second time.

4. The method of claim 3, wherein the first time and the second time are associated with a times at with the second offer was entered into the offer database system or modified in the offer database system.

5. The method of claim 4, wherein the first time and the second time are a price history.

6. The method of claim 1, wherein the receiving of the offer information in the offer database system includes receiving the offer information from a seller portable device.

7. The method of claim 6, wherein the seller portable device is a cellular telephone or a dedicated offer generator device.

8. The method of claim 1, wherein the offer database system includes a database server.

9. The method of claim 1, wherein the product is a physical product or a service product.

10. A computerized system including a processor configured to execute the method of claim 1.

11. A computerized method for storing purchase information for a product in a price database to generate a purchase history, the computerized method comprising:
receiving in a price database a set of sales information for a product, wherein the set of sales information includes a product identifier for a product and a price for the product; and
storing in the price database a price entry, which include the set of sales information, wherein the price entry is editable to generate a purchase history.

12. The method of claim 11, wherein the set of sales information includes a name or description of the product.

13. The method of claim 11, wherein the set of sales information includes a seller identity.

14. The method of claim 13, wherein the seller identity includes a business name.

15. The method of claim 13, wherein the seller identity includes location information of a seller.

16. The method of claim 15, wherein the location information includes a set of location coordinates for a seller.

17. The method of claim 16, wherein the set of location coordinates is determined from a GPS locator in a user portable device.

18. The method of claim 15, wherein the location information includes a physical address.

19. The method of claim 13, further comprising receiving in the price database a second set of sales information for the product, wherein the second set of sales information for the product includes a second price for the product, and a second seller identity for the seller or another seller.

20. The method of claim 19, wherein:
if the second seller identity is for the seller, then storing the second price in the price entry to update the first mentioned price, the first price being a price history, and
if the second seller identity is for another seller, then maintaining the first price as a most recent price.

21. The method of claim 19, wherein the set of sales information for the product is received from a user account and the second set of sale information is received from a second user account.

22. The method of claim 11, wherein the set of sales information includes a date on which the price database received the set of sales information.

23. The method of claim 11, wherein the product identifier is an electronic identity code including a universal product code (UPC).

24. The method of claim 23, wherein the electronic identity code is obtained from an RF identification tag.

25. A computerized system including a processor configured to execute the method of claim 11.

26. A computerized method for storing an offer for a product in an offer database system, the computerized method comprising:
receiving in a user portable device a product identifier for a product and a price for the product; wherein the user portable device is associated with a unique seller identifier, which identifies a seller of the product; and
combining to generate an offer the product identifier, the price, and the seller identifier for storage of the offer in an offer database system.

27. The computerized method of claim 26, further comprising, storing the offer in an offer database system.

28. The computerized method of claim 27, wherein the combining to generate the offer includes combining a quantity of the product for the price, with the product identifier, the price, and the seller identifier.

29. The computerized method of claim 28, wherein if the quantity for the product is not received by the offer database system, a default for the quantity of one.

30. The computerized method of claim 28, further comprising receiving in the offer database system the quantity for the product.

31. The computerized method of claim 26, wherein the combining to generate the offer is performed at the offer database system.

32. The computerized method of claim 31, wherein the offer database system includes an offer database system server.

33. The computerized method of claim 26, wherein the seller identifier is a seller location.

34. The computerized method of claim 26, wherein the seller identifier includes data configured for use by a contact database for locating contact information or address information for the seller and for extracting the contact information or the address information.

35. The computerized method of claim 26, wherein the seller identifier is an international mobile equipment identity (IMEI).

36. The computerized method of claim 33, wherein the seller location includes a street address.

37. The computerized method of claim 33, wherein the seller location includes a set of coordinates.

38. The computerized method of claim 26, wherein the seller identifier is a name of a business and a business address.

39. The computerized method of claim 26, wherein the product is a physical product or a service product.

40. The computerized method of claim 26, wherein the offer database system is configured to store offers for a plurality of sellers.

41. The computerized method of claim 26, further comprising:
determining by the offer database system if a second offer for the product is stored in the offer database system;
if a second offer is stored in the offer database system, determining by the offer database system:
if a second product identifier for the second offer matches the first mentioned product identifier for the first mentioned offer,
if a second quantity for a second price for the second offer matches the first mentioned quantity for the first mentioned offer,
if a second unique seller identifier of the second offer matches the unique seller identifier of the first mentioned offer, and
if a second price for the second offer matches the first mentioned price for the first offer,
then maintaining in the offer database system the second offer unchanged;
if a second offer is stored in the offer database system, determining by the offer database system:
if the second unique seller identifier matches the first unique seller identifier,
if the second product identifier for the second offer matches the first mentioned product identifier for the first mentioned offer, and
if the second quantity matches the first mentioned quantity, and
if the second price does not match the first price,
then modifying in the offer database system the second offer to include the first price;
if a second offer is stored in the offer database system, determining by the offer database system:
if the second quantity does not match the first mentioned quantity,
then storing the first offer in the offer database system; wherein the first
offer is a new entry in the offer database system; and
if a second offer is stored in the offer database system, determining by the offer database system:
if the second unique seller identifier does not match the first unique seller identifier,
then storing the first offer in the offer database system; wherein the first offer is a new entry in the offer database system; and
if a second offer for the product is not stored in the offer database system,
storing the first offer in the offer database system; wherein the first offer is a new entry in the offer database system.

42. A computerized system including a processor configured to execute the method of claim 26.

43. A computer readable storage medium containing program instructions that, when executed by a controller within a computer, cause the controller to execute a method for storing an offer for a product in an offer database system, the method comprising:
receiving in an offer database system offer information for a first offer of a product, wherein:
the offer information includes a set of invariant offer information and a set of variant offer information,
the set of invariant offer information includes a seller identifier and a product identifier, and
the set of variant offer information includes a price for the product;
determining by the offer database system if a second offer for the product is stored in the offer database system;
if a second offer is stored in the offer database system, determining by the offer database system if another set of invariant offer information and another set of variant offer information in the second offer respectively matches the set of invariant offer information and the set of variant offer information, wherein the other set of invariant offer information includes another seller identifier and another product identifier, and the other set of variant offer information includes another price for the product;
if the set of invariant offer information and the set of variant offer information respectively matches the other set of invariant offer information and the other set of variant offer information, maintaining in the offer database system the second offer unchanged;
if the set of invariant offer information and the other set of invariant offer information match, and if the set of variant offer information and the other set of variant offer information do not match, modifying in the offer database system the second offer to include the set of variant offer information;
if the set of invariant offer information and the other set of invariant offer information do not match, storing the first offer in the offer database system; wherein the first offer is a new entry in the offer database system and includes the offer information; and
if a second offer for the product is not stored in the offer database system, storing the first offer in the offer database system; wherein the first offer is a new entry in the offer database system and includes the offer information.

44. The computer readable storage medium of claim 43, wherein the modifying of the second offer in the offer database system includes associating the other set of variant offer information with the set of variant offer information.

45. The computer readable storage medium of claim 44, wherein the modifying of the second offer in the offer database system includes associating a first time with the other set of variant offer information and a second time with the set of variant offer information, wherein the first time is chronologically earlier than the second time.

46. The computer readable storage medium of claim 45, wherein the first time and the second time are associated with a times at with the second offer was entered into the offer database system or modified in the offer database system.

47. The computer readable storage medium of claim 46, wherein the first time and the second time are a price history.

48. The computer readable storage medium of claim 43, wherein the receiving of the offer information in the offer database system includes receiving the offer information from a seller portable device.

49. The computer readable storage medium of claim 48, wherein the seller portable device is a cellular telephone or a dedicated offer generator device.

50. The computer readable storage medium of claim 43, wherein the offer database system includes a database server.

51. The computer readable storage medium of claim 43, wherein the product is a physical product or a service product.

52. A computer readable storage medium containing program instructions that, when executed by a controller within a computer, cause the controller to execute a method for storing purchase information for a product in a price database to generate a purchase history, the method comprising:
receiving in a price database a set of sales information for a product, wherein the set of sales information includes a product identifier for a product and a price for the product; and
storing in the price database a price entry, which include the set of sales information, wherein the price entry is editable to generate a purchase history.

53. The computer readable storage medium of claim 52, wherein the set of sales information includes a name or description of the product.

54. The computer readable storage medium of claim 52, wherein the set of sales information includes a seller identity.

55. The computer readable storage medium of claim 54, wherein the seller identity includes a business name.

56. The computer readable storage medium of claim 54, wherein the seller identity includes location information of a seller.

57. The computer readable storage medium of claim 56, wherein the location information includes a set of location coordinates for a seller.

58. The computer readable storage medium of claim 57, wherein the set of location coordinates is determined from a GPS locator in a user portable device.

59. The computer readable storage medium of claim 56, wherein the location information includes a physical address.

60. The computer readable storage medium of claim 54, further comprising receiving in the price database a second set of sales information for the product, wherein the second set of sales information for the product includes a second price for the product, and a second seller identity for the seller or another seller.

61. The computer readable storage medium of claim 60, wherein:
if the second seller identity is for the seller, then storing the second price in the price entry to update the first mentioned price, the first price being a price history, and
if the second seller identity is for another seller, then maintaining the first price as a most recent price.

62. The computer readable storage medium of claim 60, wherein the set of sales information for the product is received from a user account and the second set of sale information is received from a second user account.

63. The computer readable storage medium of claim 52, wherein the set of sales information includes a date on which the price database received the set of sales information.

64. The computer readable storage medium of claim 52, wherein the product identifier is an electronic identity code including a universal product code (UPC).

65. The computer readable storage medium of claim 64, wherein the electronic identity code is obtained from an RF identification tag.

66. A computer readable storage medium containing program instructions that, when executed by a controller within a computer, cause the controller to execute a method for storing an offer for a product in an offer database system, the method comprising:
receiving in a user portable device a product identifier for a product and a price for the product; wherein the user portable device is associated with a unique seller identifier, which identifies a seller of the product; and
combining to generate an offer the product identifier, the price, and the seller identifier for storage of the offer in an offer database system.

67. The computer readable storage medium of claim 66, further comprising, storing the offer in an offer database system.

68. The computer readable storage medium of claim 67, wherein the combining to generate the offer includes combining a quantity of the product for the price, with the product identifier, the price, and the seller identifier.

69. The computer readable storage medium of claim 68, wherein if the quantity for the product is not received by the offer database system, a default for the quantity of one.

70. The computer readable storage medium of claim 68, further comprising receiving in the offer database system the quantity for the product.

71. The computer readable storage medium of claim 66, wherein the combining to generate the offer is performed at the offer database system.

72. The computer readable storage medium of claim 71, wherein the offer database system includes an offer database system server.

73. The computer readable storage medium of claim 66, wherein the seller identifier is a seller location.

74. The computer readable storage medium of claim 66, wherein the seller identifier includes data configured for use by a contact database for locating contact information or address information for the seller and for extracting the contact information or the address information.

75. The computer readable storage medium of claim 66, wherein the seller identifier is an international mobile equipment identity (IMEI).

76. The computer readable storage medium of claim 73, wherein the seller location includes a street address.

77. The computer readable storage medium of claim 73, wherein the seller location includes a set of coordinates.

78. The computer readable storage medium of claim 66, wherein the seller identifier is a name of a business and a business address.

79. The computer readable storage medium of claim 66, wherein the product is a physical product or a service product.

80. The computer readable storage medium of claim 66, wherein the offer database system is configured to store offers for a plurality of sellers.

81. The computer readable storage medium of claim 66, further comprising:
determining by the offer database system if a second offer for the product is stored in the offer database system;
if a second offer is stored in the offer database system, determining by the offer database system:
if a second product identifier for the second offer matches the first mentioned product identifier for the first mentioned offer,
if a second quantity for a second price for the second offer matches the first mentioned quantity for the first mentioned offer,
if a second unique seller identifier of the second offer matches the unique seller identifier of the first mentioned offer, and
if a second price for the second offer matches the first mentioned price for the first offer,
then maintaining in the offer database system the second offer unchanged;
if a second offer is stored in the offer database system, determining by the offer database system:
if the second unique seller identifier matches the first unique seller identifier,
if the second product identifier for the second offer matches the first mentioned product identifier for the first mentioned offer, and
if the second quantity matches the first mentioned quantity, and
if the second price does not match the first price,
then modifying in the offer database system the second offer to include the first price;
if a second offer is stored in the offer database system, determining by the offer database system:
if the second quantity does not match the first mentioned quantity,
then storing the first offer in the offer database system; wherein the first offer is a new entry in the offer database system; and
if a second offer is stored in the offer database system, determining by the offer database system:
if the second unique seller identifier does not match the first unique seller identifier,
then storing the first offer in the offer database system; wherein the first offer is a new entry in the offer database system; and
if a second offer for the product is not stored in the offer database system,
storing the first offer in the offer database system; wherein the first offer is a new entry in the offer database system.

82. A computer program product for storing an offer for a product in an offer database system on a computer readable medium comprises:
code for receiving in an offer database system offer information for a first offer of a product, wherein:
the offer information includes a set of invariant offer information and a set of variant offer information,
the set of invariant offer information includes a seller identifier and a product identifier, and
the set of variant offer information includes a price for the product;
determining by the offer database system if a second offer for the product is stored in the offer database system;
if a second offer is stored in the offer database system, code for determining by the offer database system if another set of invariant offer information and another set of variant offer information in the second offer respectively matches the set of invariant offer information and the set of variant offer information, wherein the other set of invariant offer information includes another seller identifier and another product identifier, and the other set of variant offer information includes another price for the product;
if the set of invariant offer information and the set of variant offer information respectively matches the other set of invariant offer information and the other set of variant offer information, code for maintaining in the offer database system the second offer unchanged;
if the set of invariant offer information and the other set of invariant offer information match, and if the set of variant offer information and the other set of variant offer information do not match, code for modifying in the offer database system the second offer to include the set of variant offer information;
if the set of invariant offer information and the other set of invariant offer information do not match, code for storing the first offer in the offer database system; wherein the first offer is a new entry in the offer database system and includes the offer information; and
if a second offer for the product is not stored in the offer database system, code for storing the first offer in the offer database system; wherein the first offer is a new entry in the offer database system and includes the offer information.

83. The computer program product of claim 82, wherein the code for modifying of the second offer in the offer database system includes code for associating the other set of variant offer information with the set of variant offer information.

84. The computer program product of claim 83, wherein the code for modifying of the second offer in the offer database system includes code for associating a first time with the other set of variant offer information and a second time with the set of variant offer information, wherein the first time is chronologically earlier than the second time.

85. The computer program product of claim 84, wherein the first time and the second time are associated with a times at with the second offer was entered into the offer database system or modified in the offer database system.

86. The computer program product of claim 85, wherein the first time and the second time are a price history.

87. The computer program product of claim 82, wherein the code for receiving of the offer information in the offer database system includes code for receiving the offer information from a seller portable device.

88. The computer program product of claim 87, wherein the seller portable device is a cellular telephone or a dedicated offer generator device.

89. The computer program product of claim 82, wherein the offer database system includes a database server.

90. The computer program product of claim 82, wherein the product is a physical product or a service product.

91. A computer program product for storing purchase information for a product in a price database to generate a purchase history on a computer readable medium comprises:
code for receiving in a price database a set of sales information for a product, wherein the set of sales information includes a product identifier for a product and a price for the product; and
code for storing in the price database a price entry, which include the set of sales information, wherein the price entry is editable to generate a purchase history.

92. The computer program product of claim 91, wherein the set of sales information includes a name or description of the product.

93. The computer program product of claim 91, wherein the set of sales information includes a seller identity.

94. The computer program product of claim 93, wherein the seller identity includes a business name.

95. The computer program product of claim 93, wherein the seller identity includes location information of a seller.

96. The computer program product of claim 95, wherein the location information includes a set of location coordinates for a seller.

97. The computer program product of claim 96, wherein the set of location coordinates is determined from a GPS locator in a user portable device.

98. The computer program product of claim 95, wherein the location information includes a physical address.

99. The computer program product of claim 93, further comprising code for receiving in the price database a second set of sales information for the product, wherein the second set of sales information for the product includes a second price for the product, and a second seller identity for the seller or another seller.

100. The computer program product of claim 99, wherein:
if the second seller identity is for the seller, code for storing the second price in the price entry to update the first mentioned price, the first price being a price history, and
if the second seller identity is for another seller, code for maintaining the first price as a most recent price.

101. The computer program product of claim 99, wherein the set of sales information for the product is received from a user account and the second set of sale information is received from a second user account.

102. The computer program product of claim 91, wherein the set of sales information includes a date on which the price database received the set of sales information.

103. The computer program product of claim 91, wherein the product identifier is an electronic identity code including a universal product code (UPC).

104. The computer program product of claim 103, wherein the electronic identity code is obtained from an RF identification tag.

105. A computer program product for storing an offer for a product in an offer database system on a computer readable medium comprises:
code for receiving in a user portable device a product identifier for a product and a price for the product; wherein the user portable device is associated with a unique seller identifier, which identifies a seller of the product; and
code for combining to generate an offer the product identifier, the price, and the seller identifier for storage of the offer in an offer database system.

106. The computer program product of claim 105, further comprising, code for storing the offer in an offer database system.

107. The computer program product of claim 106, wherein the code for combining to generate the offer includes code for combining a quantity of the product for the price, with the product identifier, the price, and the seller identifier.

108. The computer program product of claim 107, wherein if the quantity for the product is not received by the offer database system, a default for the quantity of one.

109. The computer program product of claim 108, further comprising code for receiving in the offer database system the quantity for the product.

110. The computer program product of claim 105, wherein the code for combining to generate the offer is performed at the offer database system.

111. The computer program product of claim 110, wherein the offer database system includes an offer database system server.

112. The computer program product of claim 105, wherein the seller identifier is a seller location.

113. The computer program product of claim 105, wherein the seller identifier includes data configured for use by a contact database for locating contact information or address information for the seller and for extracting the contact information or the address information.

114. The computer program product of claim 105, wherein the seller identifier is an international mobile equipment identity (IMEI).

115. The computer program product of claim 114, wherein the seller location includes a street address.

116. The computer program product of claim 114, wherein the seller location includes a set of coordinates.

117. The computer program product of claim 105, wherein the seller identifier is a name of a business and a business address.

118. The computer program product of claim 105, wherein the product is a physical product or a service product.

119. The computer program product of claim 105, wherein the offer database system is configured to store offers for a plurality of sellers.

120. The computer program product of claim 105, further comprising:
code for determining by the offer database system if a second offer for the product is stored in the offer database system;
if a second offer is stored in the offer database system, code for determining by the offer database system:
if a second product identifier for the second offer matches the first mentioned product identifier for the first mentioned offer,
if a second quantity for a second price for the second offer matches the first mentioned quantity for the first mentioned offer,
if a second unique seller identifier of the second offer matches the unique seller identifier of the first mentioned offer, and
if a second price for the second offer matches the first mentioned price for the first offer,
then code for maintaining in the offer database system the second offer unchanged;
if a second offer is stored in the offer database system, code for determining by the offer database system:
if the second unique seller identifier matches the first unique seller identifier,
if the second product identifier for the second offer matches the first mentioned product identifier for the first mentioned offer, and
if the second quantity matches the first mentioned quantity, and
if the second price does not match the first price,
then code for modifying in the offer database system the second offer to include the first price;
if a second offer is stored in the offer database system, code for determining by the offer database system:
if the second quantity does not match the first mentioned quantity,
then code for storing the first offer in the offer database system; wherein the first offer is a new entry in the offer database system; and
if a second offer is stored in the offer database system, code for determining by the offer database system:
if the second unique seller identifier does not match the first unique seller identifier,
then code for storing the first offer in the offer database system; wherein the first offer is a new entry in the offer database system; and
if a second offer for the product is not stored in the offer database system, code for storing the first offer in the offer database system; wherein the first offer is a new entry in the offer database system.
